(19) United States
(12) Patent Application Publication
(10) Pub. No.: US 2011/0039164 A1
(43) Pub. Date: Feb. 17, 2011

(54) BIOANODE AND BIOCATHODE STACK ASSEMBLIES

(75) Inventors: Niki L. Akers, St. Louis, MO (US); Scott A. Nelson, St. Louis, MO (US); Wayne L. Gellett, Ballwin, MO (US); David Trentmann, Eureka, MO (US); Jacob Whited, St. Louis, MO (US); Yimin Zhu, Chesterfield, MO (US); David Bao Le, St. Louis, MO (US); Mehmet Kesmez, Creve Coeur, MO (US); Joshua Schumacher, St. Charles, MO (US)

Correspondence Address: SENNIGER POWERS LLP, 100 NORTH BROADWAY, 17TH FLOOR, ST LOUIS, MO, 63102, US

(73) Assignee: AKERMIN, INC., St. Louis, MO (US)

(21) Appl. No.: 12/513,718

(22) PCT Filed: Nov. 7, 2007
(86) PCT No.: PCT/US2007/083847

§ 371 Date: Jan. 13, 2010

Related U.S. Application Data
(60) Provisional application No. 60/864,442, filed on Nov. 6, 2006.
(60) Provisional application No. 60/883,651, filed on Jan. 5, 2007.
(60) Provisional application No. 60/916,274, filed on May 4, 2007.
(60) Provisional application No. 60/952,900, filed on Jul. 31, 2007.

(51) Int. Cl. H01M 8/16; H01M 4/90; H01M 4/88; H01M 4/64

(52) U.S. Cl. 429/401; 429/531; 429/535; 429/523

(57) ABSTRACT

A biofuel cell device for generating electrical current. The device includes a fuel manifold having a face, and at least one cavity in the face defining a fuel reservoir, an inlet in fluid communication with the reservoir for flow of fuel fluid into the manifold to fill the reservoir and an outlet in fluid communication with the reservoir for flow of fuel fluid out of the manifold. The device has an anode assembly including at least one bioanode positioned for contact with fuel fluid in the fuel reservoir, and a cathode assembly including at least one cathode positioned for flow of fuel fluid through the bioanode to the cathode. The device includes a controller operatively connected to the anode assembly and the cathode assembly for controlling the output of electrical current from the biofuel cell device.

### BACKGROUND

The present invention is directed in general to biological enzyme-based fuel cells (a.k.a. biofuel cells) and their methods of manufacture and use. More specifically, the invention is directed to bioanodes, bioanode stacks, biocathodes, and their method of manufacture and use.

A biofuel cell is an electrochemical device in which energy derived from chemical reactions is converted to electrical energy by catalytic activity of living cells and/or their enzymes. Biofuel cells generally use complex molecules to generate at the anode the hydrogen ions required to reduce oxygen to water, while generating free electrons for use in electrical applications. A bioanode is the electrode of the biofuel cell where electrons are released upon the oxidation of a fuel and a biocathode is the electrode where electrons and protons from the anode are used by the catalyst to reduce peroxide or oxygen to water. Biofuel cells differ from the traditional fuel cells by the material used to catalyze the electrochemical reaction. Rather than using precious metals as catalysts, biofuel cells rely on biological molecules such as enzymes to carry out the reaction.

### SUMMARY OF THE INVENTION

Among the various aspects of the invention is a biofuel cell device for generating electrical current, comprising a fuel manifold, an anode assembly, a cathode assembly, a housing, and a controller. The fuel manifold has a face, and at least one cavity in the face defining a fuel reservoir, an inlet for flow of fuel fluid into the manifold to fill the reservoir and an outlet for flow of fuel fluid out of the manifold. The anode assembly comprises at least one bioanode positioned for contact with fuel fluid in said fuel reservoir. The cathode assembly comprises at least one cathode positioned for flow of fuel fluid through the bioanode to the cathode. The housing houses the manifold, anode assembly and cathode assembly. The controller controls the output of electrical current from the biofuel cell device.

Another aspect is a biofuel cell device for supplying electrical power to a load, said device comprising at least one fuel cell; a controller for controlling an output of the fuel cell according to a defined operating mode; and a switch circuit situated between the fuel cell and the load, said switch circuit being responsive to the controller for alternately connecting the fuel cell to the load and disconnecting the fuel cell from the load according to the operating mode.

A further aspect is a biofuel cell device for supplying electrical power to a load, said device comprising at least one fuel cell; a controller for controlling an output of the fuel cell according to a defined operating mode; and a supplemental power circuit responsive to the controller for selectively connecting a supplemental power source to the output of the fuel cell thereby supplementing the electrical power supplied to the load by the biofuel cell device.

Yet another aspect is a biofuel cell device for supplying electrical power to a load, said device comprising a plurality of fuel cells electrically connected in series; a controller for controlling an output of each of the fuel cells according to at least one of a plurality of defined operating modes; and a switch circuit situated between the fuel cells and the load, said switch circuit being responsive to the controller for selectively connecting one or more of the fuel cells to the load according to the operating mode.

Yet a further aspect is a method of electrically conditioning an output of one or more fuel cells of a biofuel cell device, said biofuel cell device being adapted for supplying electrical power to a load, said method comprising electrically connecting a switch circuit between the fuel cells and the load; and operating the switch circuit to selectively connect one or more of the fuel cells to the load according to at least one of a plurality of defined operating modes.

Another aspect of the invention is an electrode comprising a first region of electrically conductive material being permeable to air and impermeable to a fuel fluid; a second region of conductive material being permeable to the fuel fluid and to air; and a non-precious metal catalyst being able to contact both the fuel fluid and air. An air-breathing half-cell comprising the electrode would generate a current density of at least about 16, 20, 25, 30, 35, 40, 45, 50, 55, 60, 65, 70, 75, 80, or more mA/cm² when operating at room temperature, an electrode potential of 0.4 V, and a catalyst loading of 10 mg/cm².

A further aspect of the invention is a heated-treated electrode comprising an electron conductor; and at least one non-precious metal catalyst being capable of selectively reducing oxygen to water. An air-breathing half-cell comprising the electrode would generate a current density of at least about 16, 20, 25, 30, 35, 40, 45, 50, 55, 60, 65, 70, 75, 80, or more mA/cm² when operating at room temperature, an electrode potential of 0.4 V, and a catalyst loading of 10 mg/cm².

Yet another aspect of the invention is a biocathode comprising an electron conductor, at least one cathode enzyme capable of reacting with an oxidant to produce water, and an enzyme immobilization material capable of immobilizing and stabilizing the enzyme, the material being permeable to the oxidant. Further the electron conductor comprises functionalized multi-walled carbon nanotubes, an activated carbon-based material, or a combination thereof.

A further aspect of the invention is a catalyst comprising cobalt(II)1,2,3,4,8,9,10,11,15,16,17,18,22,23,24,25-hexadecafluoro-29H,31H-phthalocyanine (CoPcF); and polypyrrole. The CoPcF and polypyrrole have been heat treated to increase the interaction between the cobalt metal atom and the polypyrrole nitrogen atoms.

Further aspects of the invention are particles comprising a core coated with an immobilized enzyme, the enzyme being immobilized in an immobilization material and having an activity of at least about 0.65, 0.7, 0.75, 0.8, 0.85, 0.9, 0.95, or more relative to its initial activity before immobilization and coating.

Another aspect is particles comprising a core coated with an immobilized enzyme, the enzyme being immobilized in an immobilization material and retaining at least about 75% of its initial catalytic activity for at least 7 days when the enzyme is continuously catalyzing a chemical transformation. In various preferred embodiments, the enzyme retains at least about 75% of its initial catalytic activity for at least 30 days when the enzyme is continuously catalyzing a chemical transformation.

Yet another aspect is particles comprising a core coated with an immobilized organelle. The organelle is immobilized in an immobilization material.

A further aspect is a process for preparing particles coated with an immobilized enzyme or organelle comprising: mixing a solution comprising an enzyme or organelle and a suspension comprising at least one core particle, an immobilization material, and a liquid medium to form a mixture. Then, the mixture is spray-dried.

Another aspect of the invention is an enzyme immobilized in an enzyme immobilization material wherein either: the enzyme comprises starch-consuming amylase and the enzyme immobilization material comprises butyl chitosan suspended in t-amyl alcohol or the enzyme comprises maltose-consuming amylase and the enzyme immobilization material comprises medium molecular weight decyl-modified chitosan.

Yet another aspect is a self-supporting electron conductor comprising a monolayer comprised of a first electrically conductive material having high surface area for transferring electrons, a second electrically conductive material for supporting the electron conductor, and a binder. The weight ratio of the second electrically conductive material to the first electrically conductive material in the electron conductor is at least 0.5:1 to provide sufficient rigidity to the electron conductor for it to be self-supporting. In various preferred embodiments, the weight ratio of the second electrically conductive material to the first electrically conductive material in the electron conductor is at least 1:1.

### DESCRIPTION OF THE DRAWINGS

FIG. 1 is a schematic of a fuel cell device of the present invention.

FIG. 2 is a perspective of a fuel cell device of the present invention.

FIG. 3 is a separated perspective of the device of FIG. 2.

FIG. 4 is a fragmentary perspective of a fuel manifold of the device of FIG. 2.

FIG. 5 is a front elevation of the fuel manifold.

FIG. 6 is a cross section of the fuel manifold taken along line 6-6 of FIG. 5.

FIG. 7 is a front elevation of an anode assembly of the device of FIG. 2.

FIG. 8 is a separated perspective of the anode assembly of FIG. 7.

FIG. 9 is a cross section of the anode assembly taken along line 9-9 of FIG. 7.

FIG. 10 is a front elevation of a cathode assembly of the device of FIG. 2.

FIG. 11 is a separated perspective of the cathode assembly of FIG. 10.

FIG. 12 is a cross section of the cathode assembly taken along line 12-12 of FIG. 10.

FIG. 13 is a perspective of a housing part of a fuel cell device of the present invention.

FIG. 14 is a schematic of a fuel cell device.

FIG. 15 is a schematic of a controller of the fuel cell device.

FIGS. 16 and 17 depict an exemplary user interface for receiving user input to design and simulate the modes for an eight cell device.

FIG. 18 is a perspective of an electronics assembly of the fuel cell device.

FIG. 19 is a separated perspective of fuel cell device of a second embodiment of the present invention.

FIG. 20 is a perspective of a fuel manifold of the device of FIG. 19.

FIG. 21 is a separated perspective of the anode assembly of FIG. 19.

FIG. 22 is schematic of an electrode comprising a first region of electrically conductive material that is permeable to air and impermeable to a fuel fluid, a second region of conductive material that is permeable to the fuel fluid and to air, and a catalyst that is able to contact both the fuel fluid and air. This electrode is the working electrode (WE) of an air-breathing half-cell. The working electrode (WE) contains the regions or layers labeled 1st region, 2nd region, and catalyst. The half cell also includes a reference electrode (RE) placed near the working electrode and a counter electrode (CE) of preferably a precious metal mesh or carbon sheet.

FIG. 23 is an electron conductor having an asymmetrical pore distribution.

FIG. 24 is polarization and power curves representing the current progress with NAD dependent GDH biofuel cell stack.

FIG. 25 is a curve comparing two carbon gas diffusion layer materials (Single sided Elat and gas diffusion layer (GDL) prepared as described herein) and two current collector materials (Au plated SS and Ni) for their impact on the performance of a NAD dependent ADH anodes.

FIG. 26 is curves comparing carbon support (gas diffusion layer) material properties of the various materials and their impact on the performance of a NAD dependent ADH anode.

FIG. 27 is a curve comparing six types of ADH enzyme and a commercially available ADH (NAD dependent).

FIG. 28 is a power curve of a single half cell anode (1 cm²) demonstrating power densities of 15 mW/cm².

FIGS. 29A and 29B are polarization and power curves representing the current progress and state of the art in PQQ dependent ADH biofuel cell stack performance.

FIGS. 30A and 30B are polarization and power curves representing the current progress and state of the art in PQQ dependent ADH biofuel cell stack performance.

FIG. 31 represents polarization of air-breathing cathodes in 1 M sulfuric acid solution. Platinum black (Johnson Matthey) was coated on Teflon treated carbon cloth (E-Tek) in a loading of 5 mg/cm² with 10% Nafion in the catalyst layer. CoPcFCPPy was coated on Teflon treated carbon cloth (E-Tek) in a loading of 10 mg/cm² with 30% Nafion in the catalyst layer with or without phosphotungstic acid (PTA) at a ratio of 1:10 (PTA:CoPcFCPPy). Scan rate: 2 mV/s

FIG. 32 is a polarization curve of cathode electrodes in 1 M sulfuric acid solution with 15 or 30% ethanol. CoPcFCPPy as prepared above was coated on Torey carbon paper in a loading of 10 mg/cm² with 30% Nafion in the catalyst layer. Scan rate: 2 mV/s

FIG. 33 is a polarization curve of air-breathing cathodes in 1 M sulfuric acid solution containing 15% ethanol. CoPcFCPPy as prepared in example 7 was coated on Teflon treated carbon cloth (E-Tek) in a loading of 10 mg/cm² with 30% Nafion in the catalyst layer. Scan rate: 2 mV/s

FIG. 34 is a time dependent oxygen reduction current at 0.4 V in 1 M sulfuric acid solution containing 5% ethanol. CoPcFCPPy as prepared in 7 was coated on Teflon treated carbon cloth (E-Tek) in a loading of 10 mg/cm² with 30% Nafion in the catalyst layer and with or without phosphotungstic acid (PTA) at a weight ratio of 1:10 (PTA:CoPcFCPPy). Platinum black (Johnson Matthey) was coated on Teflon treated carbon cloth (E-Tek) in a loading of 5 mg/cm² with 10% Nafion in the catalyst layer. For comparison, a platinum cathode was also tested in 1 M sulfuric acid solution. Scan rate: 2 mV/s

FIG. 35 is a polarization curve of air-breathing cathodes in 1 M sulfuric acid solution containing 15% ethanol. Platinum black (Johnson Matthey) was coated on Teflon treated carbon cloth (E-Tek) in a loading of 5 mg/cm² with 10% Nafion in the catalyst layer. CoPcFCPPy was coated on Teflon treated carbon cloth (E-Tek) in a loading of 10 mg/cm² with 30% Nafion in the catalyst layer. Scan rate: 2 mV/s

FIG. 36 is a polarization curve of air-breathing cathodes in 1 M sulfuric acid solution. CoPcFPPy catalysts were coated on Teflon treated carbon cloth (E-Tek) in a loading of 10 mg/cm² with 30% Nafion in the catalyst layer. Scan rate: 2 mV/s. Before fabricating the air breathing cathodes the CoPcFCPPy catalysts were leached in 1 M sulfuric acid for 0, 1, 20 or 120 hours.

FIG. 37 is a polarization curve of air-breathing cathodes in 1 M sulfuric acid solution. CoPcFCPPy pyrolyzed or unpyrolyzed was coated on Teflon treated carbon cloth (E-Tek) in a loading of 10 mg/cm² with 30% nafion in the catalyst layer. Scan rate: 2 mV/s.

FIG. 38 is a polarization curve of air-breathing cathodes in 1 M sulfuric acid solution in the presence or absence of 15% ethanol. Pyrolyzed CoPcF/C catalysts were coated on Teflon treated carbon cloth (E-Tek) in a loading of 10 mg/cm² with 30% Nafion in the catalyst layer. Scan rate: 2 mV/s.

FIG. 39 is a polarization curve of air-breathing cathodes in 1 M sulfuric acid solution. CoPcFPPy and CoPcCPPy catalysts were coated on Teflon treated carbon cloth (E-Tek) in a loading of 10 mg/cm² with 30% nafion in the catalyst layer. Scan rate: 2 mV/s.

FIG. 40 is a cyclic voltammogram of bilirubin oxidase (Myrothecium verrucaria)-multiwall carbon nanotube immobilized on Torey carbon paper in acetate buffer solution (pH 5). Scan rate: 100 mV/s.

FIG. 41 is a cyclic voltammogram of laccase (Agaricus bisporus)-multiwall carbon nanotube immobilized on Torey carbon paper in acetate buffer solution (pH 5). Scan rate: 50 mV/s.

FIG. 42 is a polarization curve of air-breathing biocathode in acetate buffer solution (pH 5). Laccase (Trametes spec)/carboxyl functionalized-multiwall carbon nanotubes were immobilized on water-proofing carbon cloth. Scan rate: 2 mV/s.

FIG. 43 is a polarization curve of air-breathing biocathode in acetate buffer solution (pH 5). Bilirubin oxidase (Myrothecium verrucaria)/carbon nanotubes were immobilized on water-proofing carbon cloth. Scan rate: 2 mV/s.

FIG. 44 is a polarization curve of air-breathing biocathode in acetate buffer solution (pH 5). Bilirubin oxidase (Myrothecium verrucaria)/carbon blacks or carbon nanotubes were immobilized on water-proofing carbon cloth. Scan rate: 2 mV/s.

FIG. 45 is a polarization curve of air-breathing biocathode in acetate buffer solution (pH 5). Bilirubin oxidase (Myrothecium verrucaria)/hydroxyl functionalized multiwall carbon nanotubes were immobilized on water-proofing carbon cloths (double sided coatings—DS from E-Tek; in house coatings—Carbon cloth D/XE2). Scan rate: 2 mV/s.

FIG. 46 is a polarization curve of biocathode in acetate buffer solution saturated by oxygen (pH 5). Bilirubin oxidase (Myrothecium verrucaria) was adsorbed on plain carbon cloth (triangle) or on activated cloth (circle). Scan rate: 2 mV/s

FIG. 47 is a schematic representation of a particle coated with an electron mediator, an enzyme (with two subunits), and an enzyme immobilization material.

FIG. 48 is a schematic of an airbrush spray drying a mixture onto a polycarbonate shield.

FIG. 49 is a linear sweep voltammogram demonstrating the retention of activity of encapsulated alcohol dehydrogenase as described in Example 17 and made into a carbon composite electrode.

FIG. 50 is a graph of the relative enzyme activity for starch-consuming amylase immobilized in various enzyme immobilization materials.

FIG. 51 is a graph of the relative enzyme activity for maltose-consuming amylase immobilized in various enzyme immobilization materials.

FIG. 52 is a schematic of an air breathing biocathode electrode. The electrode comprises a conductive monolayer 527.

FIG. 53 is a schematic of a bioanode electrode. The electrode comprises a conductive monolayer 537.

FIG. 54 is a polarization and power curves comparison of a GDL of the invention to a GDL (Elat) for a biocathode electrode based fuel cell. The anode for both cells was a platinum black catalyst on Elat with hydrogen as a fuel. The cathode catalyst for both cells was an immobilized laccase enzyme with oxygen as the oxidant.

FIG. 55 is a polarization and power curves comparison of an anode GDL prepared as described herein to a commercial Anode GDL (Elat) direct methanol fuel cell. The anode for both cells was a platinum ruthenium black catalyst on respective GDL materials with 5.0% methanol as a fuel. The cathode catalyst for both cells was a platinum black catalyst on Elat GDL with oxygen as the oxidant.

FIG. 56 is a schematic for the enzyme/nanowires and carbon particle interaction.

FIG. 57 is a schematic of the pre-defined electron pathways (neural-network-like structure) formed due to interaction of nanowires with each other.

FIG. 58 is a half cell test of a non-mediated Bio Carbon Paste electrode in 1 M phosphate buffer.

FIG. 59 is a mediated anode half cell in 1 M phosphate buffer at pH 7.2.

FIG. 60 is a Laccase cathode comparison at room temperature versus a Pt black anode H₂/O₂ Fuel Cell with and without carbon filler.

FIG. 61 depicts the performance when the carbon content is varied in a Laccase/Pt black at room temperature in a H₂/O₂ PEM fuel cell.

FIG. 62 depicts the performance of various different carbon species in a Laccase/Pt black H₂O₂ PEM fuel cell at room temperature.

FIG. 63 depicts the performance of various enzyme/TBAB loadings in a Laccase/Pt black H₂O₂ PEM fuel cell at room temperature.

FIG. 64 depicts the performance of various electrode supports in a Laccase/Pt black H₂/O₂ PEM fuel cell at room temperature.

FIG. 65 depicts the performance of a chitosan immobilized Laccase/Pt black H₂/O₂ biocathode PEM fuel cell at room temperature.

FIG. 66 is a schematic of the TBAB modified Nafion based electrode press package.

FIGS. 67A and 67B are Steps 1 and 2 of a chitosan immobilized enzyme electrode press package.

Corresponding reference characters indicate corresponding parts throughout the drawings.

### DETAILED DESCRIPTION

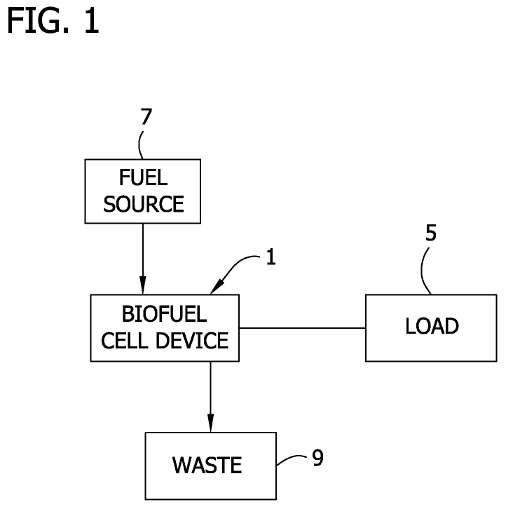

Referring now to the drawings, FIG. 1 illustrates one embodiment of a fuel cell device of the present invention, designated in its entirety by the reference numeral 1. The device 1 is capable of generating electrical current which may be used to meet the power consumption demands of a load indicated at 5. By way of example, the fuel cell device 1 may be used to power small handheld electronics. Fuel for operating the device 1 is provided from a suitable source 7 and is either consumed during use or discharged from the device 1 after use to a suitable waste destination (e.g., receptacle) 9.

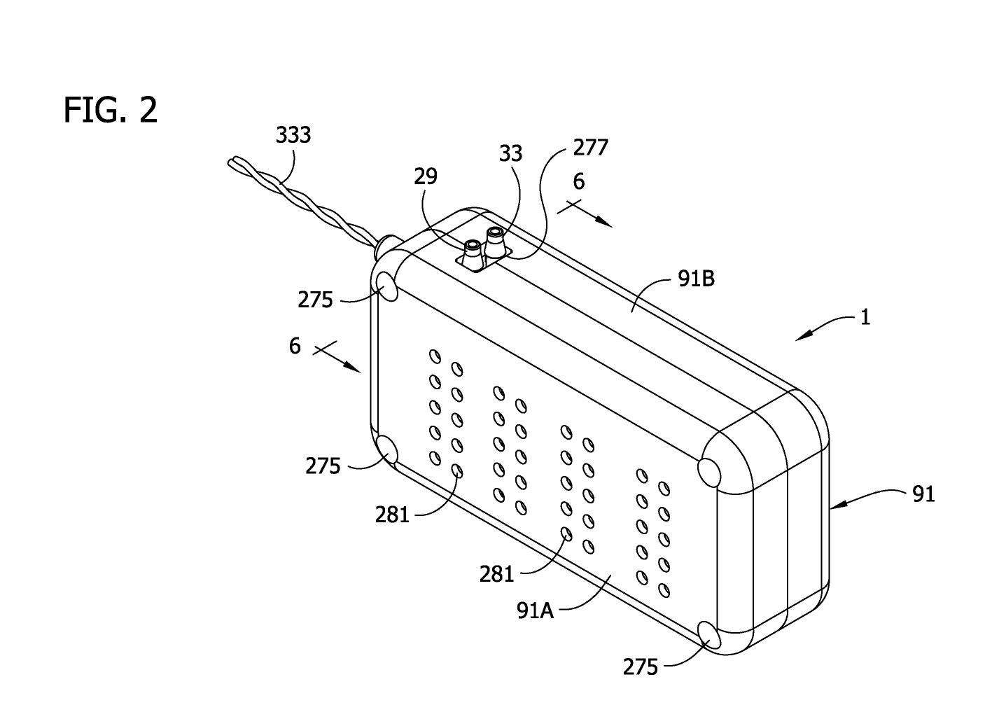

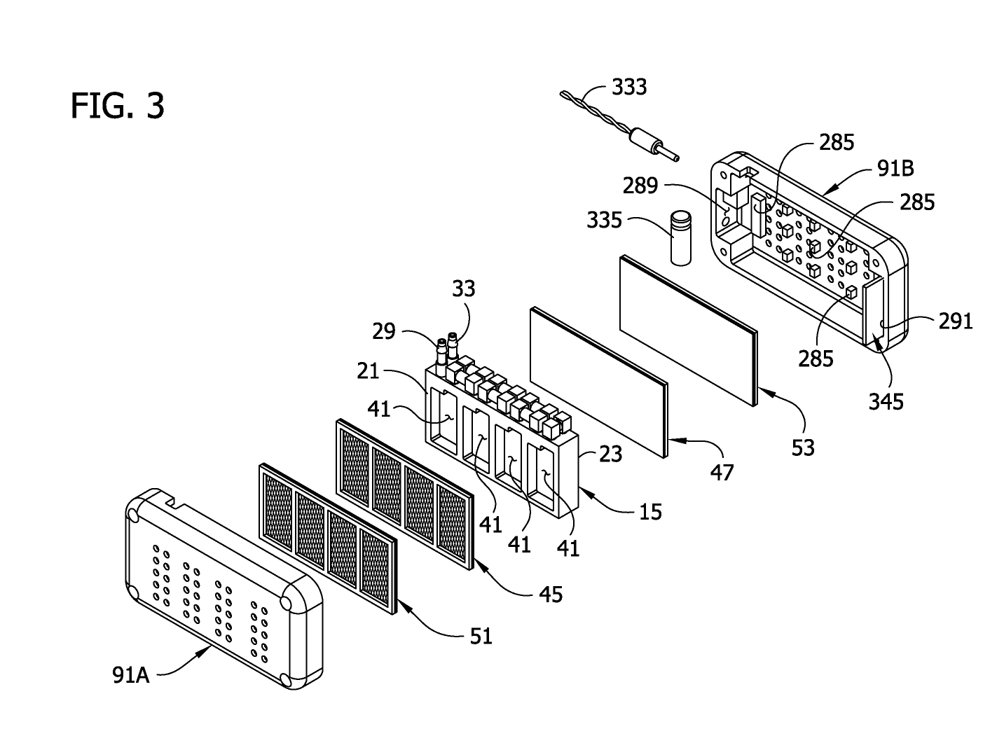

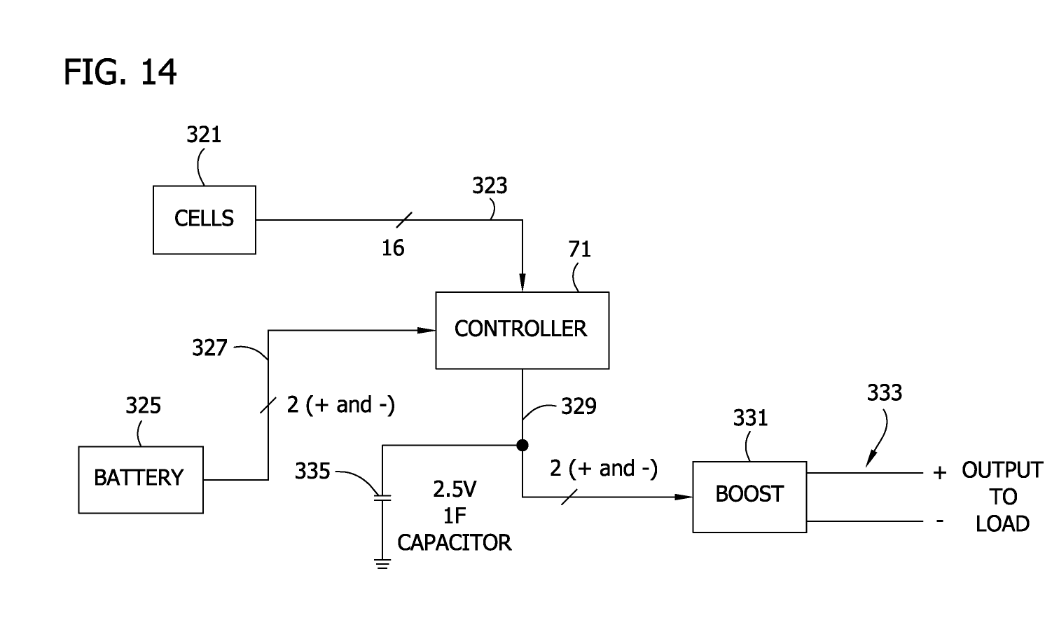

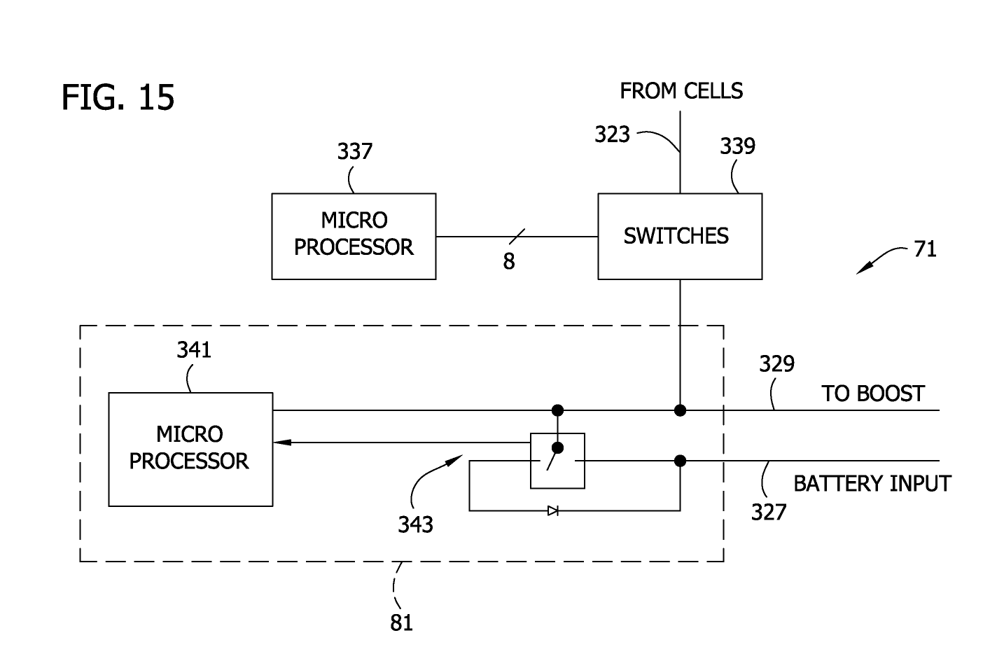

FIG. 2 illustrates the fuel cell device 1 of FIG. 1, and FIG. 3 is a separated view showing the various components of the device 1. In general, the device comprises a fuel manifold 15 having a front side 21, a back side 23, an inlet 29 for flow of fuel fluid from the fuel source 7 into the manifold and an outlet 33 for flow of fuel fluid from the manifold to the waste destination 9. The manifold 15 comprises one or more fuel reservoirs, each designated 41. The fuel cell device also includes front and back anode assemblies generally designated 45 and 47, respectively, on opposite front and back sides 21, 23 of the manifold 15 for reacting with fuel in the fuel reservoir(s) 41, and front and back cathode assemblies generally indicated at 51 and 53, respectively, adjacent the front and back anode assemblies 45, 47. An electronic controller, generally designated 71 (FIG. 14), is provided for controlling operation of the device, as will be described later. A supplemental power circuit, generally indicated at 81 (FIG. 15), is also included for providing power to supplement the normal output of the fuel cells, as needed. The components described above are contained in a housing, generally designated 91, so that the fuel cell device is self-contained as a relatively small, compact unit. Each of the above components is described in detail below.

### Fuel Manifold

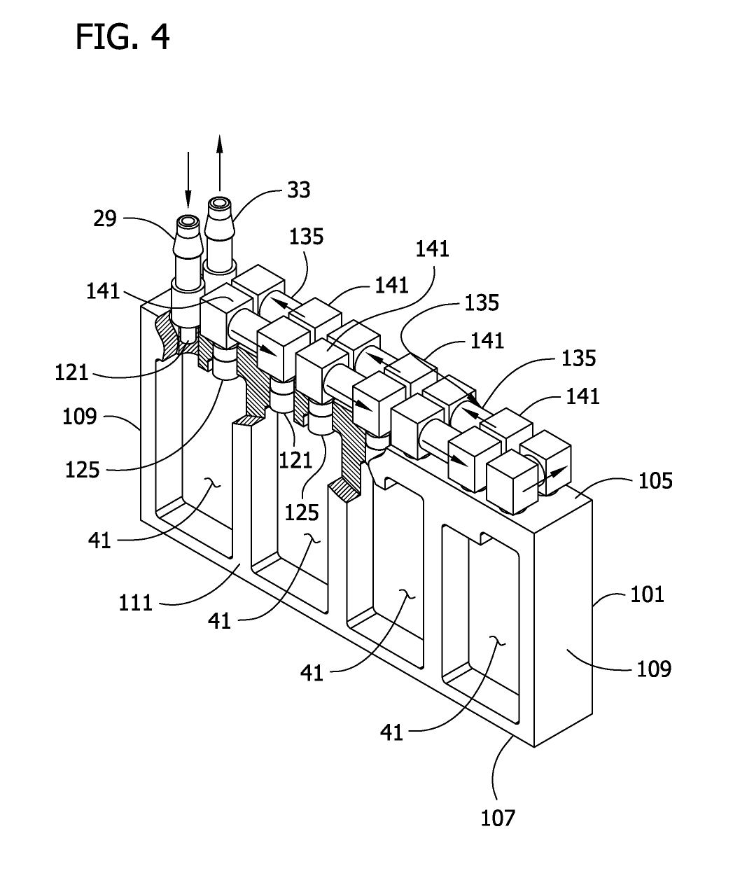

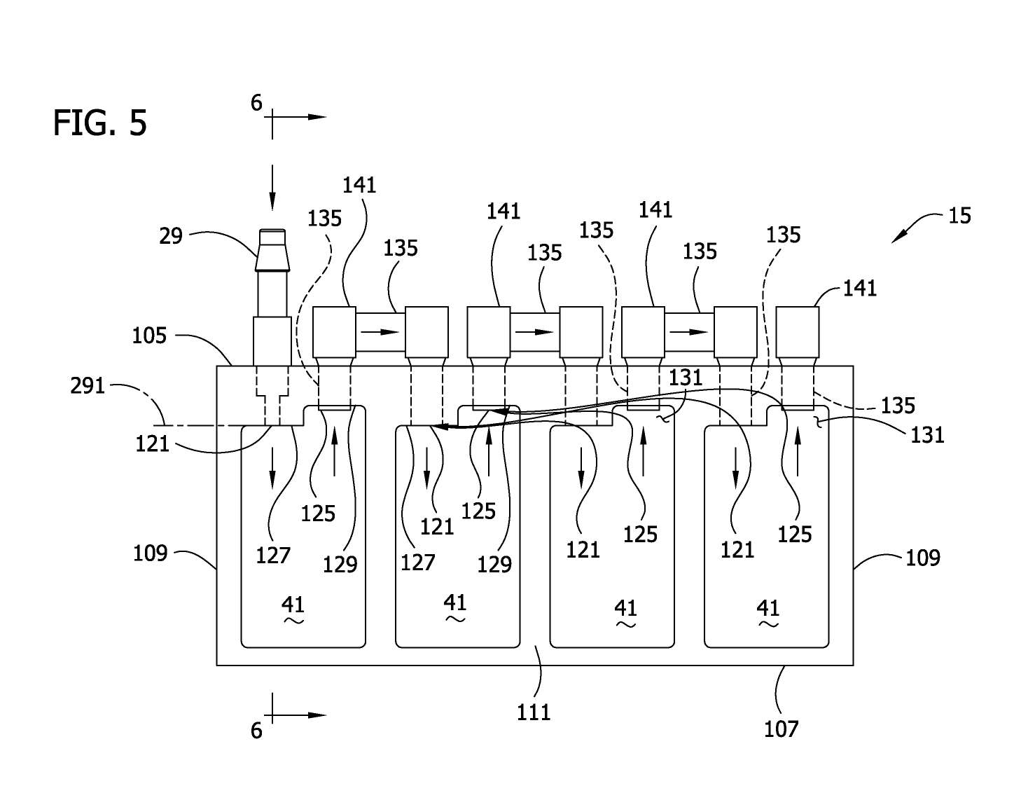

More specifically, as shown in FIGS. 4-6, the fuel manifold 15 of the illustrated embodiment comprises a body or block 101 of suitable dielectric material (e.g., acrylic) having a top 105, a bottom 107, opposite ends 109, a front face 111 and a back face 115. The block 101 is formed (e.g., molded, machined, etc.) to have any suitable shape (e.g., rectangular or otherwise) and is preferably constructed from a single one-piece member. Alternatively, it may be constructed from a number of separate members affixed to one another to form a unitary structure. The fuel reservoirs 41 are defined by cavities (also designated 41) in the front and back faces 111, 115 of the block. In the illustrated embodiment, four such cavities 41 are provided in the front face and four such cavities are provided in the back face, for a total of eight cavities forming eight fuel reservoirs. In other embodiments, the manifold 15 can contain from one cavity to up to 40 or more cavities depending on the design and the number of biofuel cells needed in the assembly. Fuel enters each fuel reservoir 41 through an inlet port 121 at the top of the reservoir and exits the same reservoir through an outlet port 125 at the top of the reservoir. As shown best in FIG. 5, the top of each fuel reservoir 41 is stepped such that the inlet port 121 is in an inlet port surface 127 and the outlet port 125 is in an outlet port surface 129 spaced above the surface 127. As a result, the elevation of the outlet port 125 of each reservoir is higher than the elevation of the inlet port 121 of each reservoir. The vertical spacing between these two surfaces 127, 129 creates a chamber or space 131 having a height (e.g., 0.10 in.) suitable for holding any air bubbles which may become trapped in the fuel chamber. This arrangement allows for the complete filling of the fuel reservoirs 41 without the risk of trapped air bubbles coming into contact with the anode assemblies 45, 47 and cathode assemblies 51, 53, as will be described later.

The fuel reservoirs 41 of the manifold 15 are connected by flow passages or conduits 135 which may, for example, comprise ⅛″×⅛″ polypropylene barbed elbows fitted into bores in the manifold. In one desired arrangement, the fuel fluid flows sequentially (in series) from one fuel reservoir 41 of the series to the next fuel reservoir 41 of the series. For example, as shown in FIGS. 4 and 5, fuel fluid flows from the inlet 29 of the manifold 15 into a first fuel reservoir 41 at the front side 21 of the manifold adjacent one end 109 of the manifold, then in sequence to the second, third and fourth reservoirs 41 at the front side (from left to right as viewed in FIGS. 4 and 5), and then in series to the four reservoirs 41 at the side 23 of the manifold before exiting the manifold 15 through the outlet 33. Other fuel flow paths between the various fuel reservoirs 41 are possible. A valve (e.g., a check valve 141) is provided between the outlet port 125 of one reservoir 41 and the inlet port 121 of the next reservoir 41 of the series to prevent the back-flow of fuel from one reservoir 41 to another as fuel flows from the inlet 29 of the manifold 15, through the various fluid reservoirs 41 in sequence, to the outlet 33 of the manifold. The use of the check valves (e.g., Poweraire valves) breaks any ionic communication between the cells, thus preventing shorts. And with the check valves 141 arranged in series there is one fuel input and output to fill all of the reservoirs 41.

In the illustrated embodiment, the fuel reservoirs 41 in the manifold 15 are arranged such that the fuel reservoirs on the back side 23 of the manifold are directly opposite the reservoirs at the front side 21 of the manifold. However, other arrangements are possible. Also, the manifold may have more than one inlet 29 and more than one outlet 33. For example, in an alternative design, one inlet and one outlet are provided to service the fuel reservoirs 41 at the front side 21 of the manifold, and a separate inlet and outlet are provided to service the fuel reservoirs 41 at the back side 23 of the manifold.

### Anode Assemblies

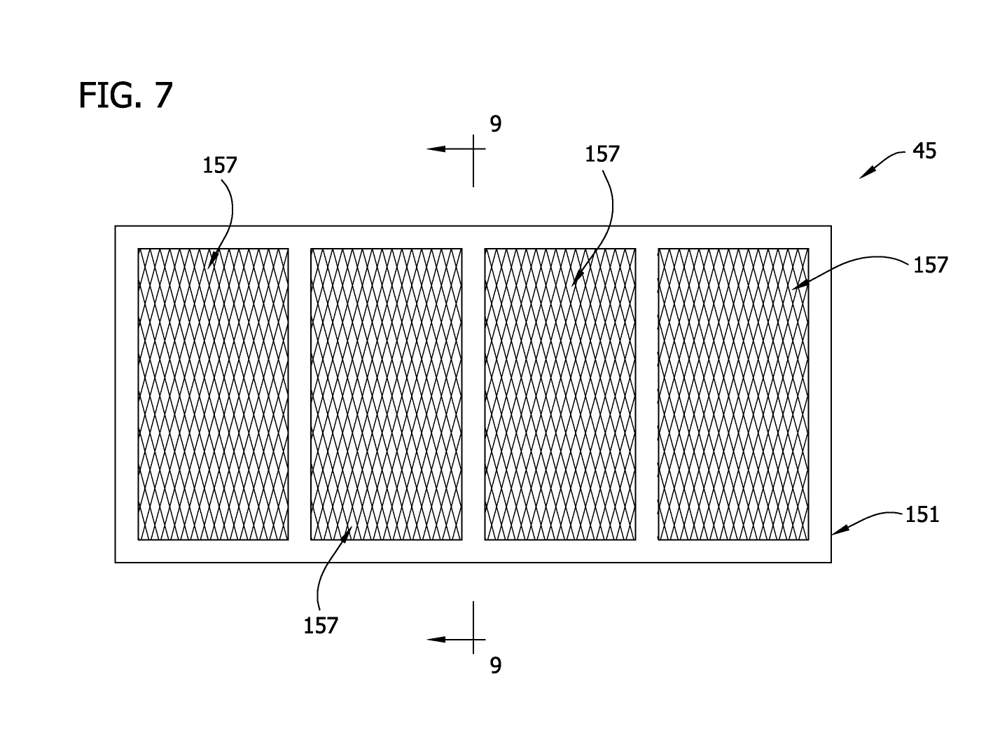

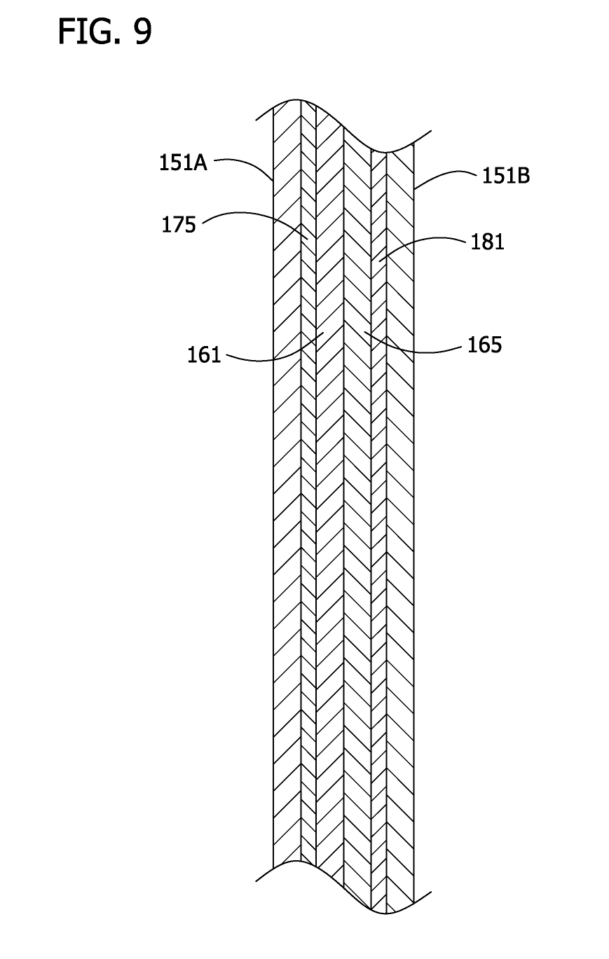

Referring to FIGS. 7-9, the front anode assembly 45 includes a frame 151 comprising, in one embodiment, a pair of mating front and back frame members 151A, 151B. Each frame member 151A, 151B, has a plurality of openings 155 in it configured and arranged to match the configuration and arrangement of fuel reservoirs 41 in the front face 111 of the manifold 15. The frame members may be of vinyl sheet material having a thickness of about 0.018 in. Other materials may also be used. Also, the frame 151 may have configurations different from that shown.

The front anode assembly 45 also includes a number of anodes, each generally designated 157, held by the frame 151 in the frame openings 155, one anode per frame opening.

In some embodiments, each anode 157 comprises a current collector 161 secured in a respective frame opening 155. In one embodiment, the current collector 161 comprises a wire mesh panel of nickel having a thickness of about 0.018 in. A suitable electrical lead 169 (e.g., a 28-gauge conductor) is affixed to the collector 161. Each anode 157 also includes a gas diffusion layer 165 on the back face of the current collector 161 between the current collector and the back frame member 151B. For example, this diffusion layer 165 may be a carbon paste structure as described in the Gas Diffusion Layer section below. A catalyst layer (not shown) is then added to the gas diffusion layer 165 by applying a cast mixture of enzyme in buffer solution and tetrabutylammonium-modified Nafion® ionomer. The catalyst layer is allowed to dry before joining it to the anode assembly. In preferred embodiments, the enzyme used in the catalyst layer is pyrroloquinoline quinone-dependent alcohol dehydrogenase (PQQ-ADH).

Each anode 157 is sized slightly larger than a corresponding frame opening 155 so that the side edge margins of the anode extend beyond respective sides of the frame opening for overlapping portions of the frame members 151A, 151B. The anodes 157 are secured to the frame members by a front layer 175 of adhesive disposed between the front frame member 151A and the current collectors 161 of the anodes 157, and a back layer 181 of adhesive between the back frame member 151B and the diffusion layers 165 of the anodes 157. The front and back adhesive layers 175, 181 comprise a urethane hot melt adhesive film having a thickness of about 0.005 in., for example. The front and back adhesive layers 175, 181 are configured to have a size and shape corresponding to the size and shape of the front and back frame members 151A, 151B, respectively. When heat is applied to the assembly (as by a hot press procedure), the adhesive melts to secure the two frame members 151A, 151B, collectors 161 and diffusion layers 165 in fixed position relative to one another to form a unitary front anode structure.

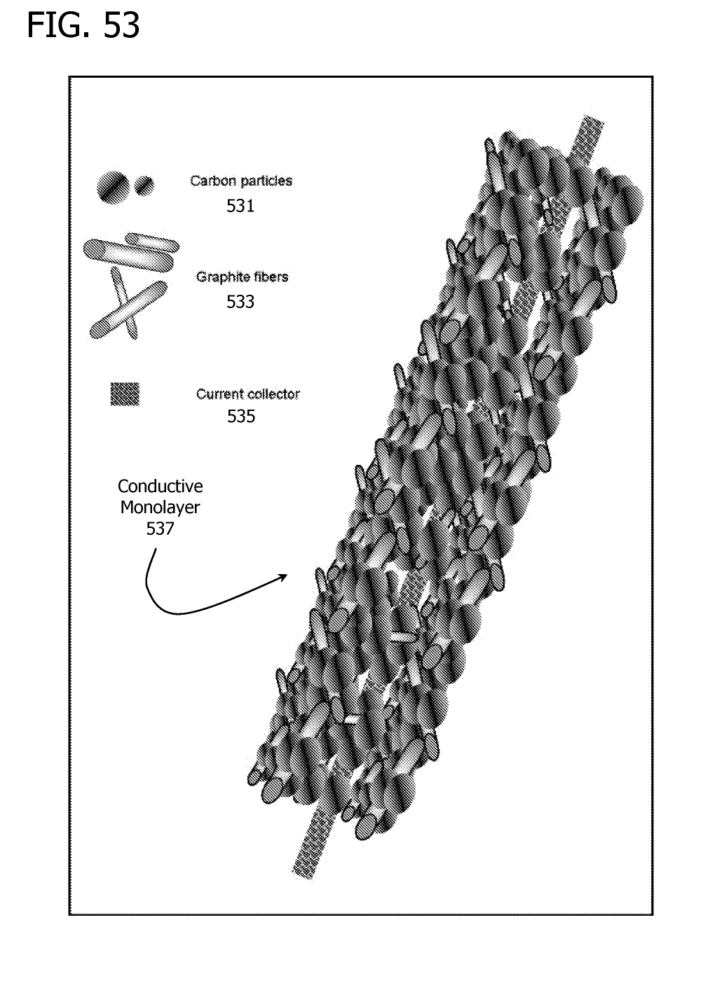

In other embodiments having a self-supporting bioanode catalyst support as shown in FIG. 53, each anode 157 comprises a current collector 535 embedded within the anode. In an embodiment, the current collector has a proximal end and a distal end and extends along a longitudinal axis. A conductive monolayer 537 in contact with the current collector 535 extends coaxially from the proximal end to the distal end of the current collector. A suitable electrical lead 169 is affixed to the collector 535. In yet other embodiments, the self-supporting bioanode catalyst support does not include an embedded current collector 535. The conductive monolayer 537 is a mixture of a first electrically conductive material, a second electrically conductive material, and a binder, and can be fabricated as described in the Self-Supporting Bioanode Catalyst Support Fabrication section below. A catalyst layer (not shown) is then applied to the surface of the monolayer 537 by the method described in the Conductive Polymer Based Nanowires section below.+ Alternatively, catalyst particles containing an enzyme (as described in the Encapsulated Enzyme Incorporation into Carbon Paste and Biocatalyst Ink Formulation sections below) can be added to the mixture used in forming the monolayer 537, or can be included in a paste or ink which is then applied to a surface of the catalyst support.

Each anode 157 is sized slightly larger than a corresponding frame opening 155 so that the side edge margins of the anode extend beyond respective sides of the frame opening for overlapping portions of the frame members 151A, 151B. The anodes 157 are secured to the frame members by a front layer 175 of adhesive disposed between the front frame member 151A and the monolayer 537 of the anodes 157, and a back layer 181 of adhesive between the back frame member 151B and the monolayer 537 of the anodes 157. The front and back adhesive layers 175, 181 comprise a urethane hot melt adhesive film having a thickness of about 0.005 in., for example. The front and back adhesive layers 175, 181 are configured to have a size and shape corresponding to the size and shape of the front and back frame members 151A, 151B, respectively. When heat is applied to the assembly (as by a hot press procedure), the adhesive melts to secure the two frame members 151A, 151B, and the monolayer 537 in fixed position relative to one another to form a unitary front anode structure.

The front anode assembly 45 is secured to the front face 111 of the manifold 15 so that the frame openings 155 and anodes 157 are in general alignment with respective front fuel reservoirs 41, the arrangement being such that fuel fluid in each reservoir 41 is adapted to contact a respective anode 157 of the front anode assembly 45. Desirably, the size and shape of the outline of each frame opening 155 approximates the size and shape of the corresponding fuel reservoir 45 so that substantially the entire area of the anode 157 is exposed to fuel fluid from the fuel reservoir. The anode assembly 45 is secured in a sealing manner to the manifold 15 by a layer of adhesive (e.g., a layer of 0.005 in. thick hot melt urethane adhesive melted at 128° C.) between the back face of the frame 151 and the front face 111 of the manifold 15. In this manner, a seal is provided which isolates each front fuel reservoir 41 and its respective anode 157 from each adjacent front fuel reservoir and its respective anode 157. The seal may be formed in other ways, as by the use of one or more gaskets.

The back anode assembly 47 is preferably constructed in a manner substantially identical to the front anode assembly 45, and corresponding parts are identified by corresponding reference numbers. The back anode assembly 47 is positioned against the back face 115 of the manifold 15 with the frame openings 155 and anodes 157 in registration with the fuel reservoirs 41 at the back side 23 of the manifold. The back anode assembly 47 is secured in position with respect to the manifold 15 and in sealing engagement with the back face 115 of the manifold in the same manner described above in regard to the front anode assembly 45. The anode assembly described above generally comprises a nickel current collector, a carbon-based gas diffusion layer, a PQQ-dependent alcohol dehydrogenase enzyme and PQQ as the electron mediator. However, a person of skill in the art would know that these components could be replaced with various alternatives as described below.

### Direct Electron Transfer (DET) at the Bioanode or Biocathode

In another aspect of this invention, a system using direct electron transfer is described. In the direct electron transfer based systems, the electron transfer is associated with, or occurs during, the catalytic transformation of the substrate to the product. The enzyme acts as an electrocatalyst and nanowires (tailored with appropriate surface functional groups) grafted on a first conductive material, such as carbon particles, facilitate the electron transfer between the enzyme, electron conductor (electrode), and the substrate molecule. In some embodiments, this process involves no electron mediator. When the nanowire increases the conductivity, but does not undergo reversible electron transfer, direct electron transfer is observed. A DET system usually offers more efficient electron transfer rates, because of operation in a potential range closer to the redox potential of the enzyme and the enzyme being less exposed to interfering reactions. Generally, the higher the integration/communication between the biomolecule and the electrode surface, the greater the electron transfer rates, and the more power output provided.

The performance of a high power output biofuel cell system based on direct electron transfer depends upon aspects of the enzyme immobilization procedure. For example, the nature of the electron conductor/support (e.g., chemical nature of the surface functional groups, dimensions of the nanowires, and electrical and ionic conductivity properties of the nanowires) and the properties and the stability of the biomolecule (e.g., immobilization technologies used to stabilize the enzyme) determine the performance of the biofuel cell.

In other embodiments, the nanowires (tailored with appropriate surface functional groups) grafted on first conductive material have electron mediators grafted on the surface of the first conductive material. These electron mediators can undergo reversible electron transfer at the anode or cathode. In various embodiments, the nanowire grafted particles can be used as a core for the immobilized enzyme coated particles described below.

Described below is a procedure for fabrication of custom bioanode and biocathode electron conductors (electrodes) for use in a biofuel cell.

### Self-Supporting Bioanode Catalyst Support

The bioanode catalyst support described herein is similar to the enzyme coated side of the biocathode, where a high surface area micro-porous structure is used for the enzyme immobilization and electrolyte/substrate incorporation. A schematic of the Bioanode Catalyst Support is shown in FIG. 53. In a similar fashion to the biocathode electrode, the first electrically conductive material (e.g., carbon black) can be modified with an electron mediator or dopant (e.g., by grafting doped conductive polymers onto its surface) to aid in electron transfer and electrical and ionic conductivity.

Self-Supporting Bioanode Catalyst Support Fabrication

The catalyst support layer used for the anode electrodes is made from a mixture of carbon materials, binder, pore forming agents, solvents and optional catalyst such as enzymes. By varying the ratios of these components, the properties of the support structure can be altered to provide desirable performance for specific applications. For example, properties that can be varied include: (1) electronic conduction, (2) hydrophobicity/hydrophilicity, (3) surface area, and (4) surface structure. The mixture forming the support structure is initially made up as a paste and then pressed into a frame (e.g., MDS filled Nylon 6/6 frame (0.020″ thick)) that is adhered to a polytetrafluoroethylene (PTFE) coated fiberglass temporary support (e.g., (0.020″ thick)) with a double-sided pressure adhesive film (e.g., (0.002″ thick)) for an electrode that does not have an embedded expanded metal current collector.

For an electrode with an embedded current collector support, two frames (e.g., MDS filled Nylon 6/6 frames (0.010″ thick)) with pressure adhesive film are fixed onto either face of a piece of expanded metal (e.g., (0.005″ thick)) and the PTFE coated fiberglass temporary support is not needed. Excess paste material on the frame and on top is removed with a tool (e.g., painter's knife or a spatula). While the paste is still moist, the electrode structure is pressed at 2000 pounds for 15 seconds in a press package consisting of two steel plates (6″×6″×0.065″), two PTFE coated fiberglass sheets (4″×4″×0.005″), and two paper towels folded to fit. The electrode(s) are removed from the package and any excess paste material on the frame is removed with a painter's knife and a paper towel. The entire assembly is then sintered at temperature up to 200° C. for up to 20 minutes, depending on the desired structure and formulation.

After sintering, the electrode is removed from the frame(s) and temporary support and cooled between two aluminum blocks (12″×12″×1″) until set, usually only a couple of minutes, prior to use in a biofuel cell. Conductivity measurements are made using a milliohm meter with the two points 1 cm separated. The measurements are reported relative to a commercial gas diffusion layer (GDL) material that was measured in the same fashion; the measurements are not a stated literature value where the conditions of the test and equipment are not known. The values are also given as approximations due to variances in the limited manual fabrication runs for each electrode type.

If the catalyst is not included in the conductive monolayer when it is formed, the catalyst layer can be applied to the catalyst support as described in the Encapsulated Enzyme Incorporation into Carbon Paste section below. Alternatively, catalyst particles containing an enzyme (as described in the Encapsulated Enzyme Incorporation into Carbon Paste and Biocatalyst Ink Formulation sections below) can be added to the mixture used in forming the monolayer 537, or can be included in a paste or ink which is then applied to a surface of the catalyst support.

### Materials and Components for Electrode and Catalyst Layer Fabrication

A variety of acceptable components can be used to construct the electrodes and catalyst layers described herein. The following tables detail various carbon blacks, pore forming reagents, binder materials, and conductive carbon fibers and their suppliers. These materials can be used to prepare the electron conductors (electrodes) described herein.

TABLE 1
Carbon blacks for use as the first electrically conductive
material in the bioelectrode GDL.

| Carbon Black Trade Name | Supplier |
|---|---|
| Vulcan XC-72 | Cabot |
| Polypyrrole, doped, composite | Sigma Aldrich |
| with carbon black | |
| Printex XE 2 | Degussa AG |
| KetjenBlack EC-600JD | Akzo Nobel Chemicals |
| KetjenBlack EC300J | Akzo Nobel Chemicals |
| Raven 5000 Ultra II | Columbian Chemical Company |
| Raven 7000 | Columbian Chemical Company |
| Monarch 880 | Cabot |
| Black Pearls 460 | Cabot |
| Black Pearls 1300 | Cabot |
| ChemSorb 1505 G5 | Molecular C*Chem |
| Monarch 1000 | Cabot |
| Timrex HSAG 300 CAT | Timcal-Stratmin |
| Black Pearls 2000 | Cabot |
| XPB F 138 | Degussa Engineered Carbons, LP. |
| Printex XE 2-B | Degussa AG |
| ChemSorb 1202 G5 | Molecular C*Chem |
| ChemSorb 1000-60 G5 | Molecular C*Chem |
| Conductex SC Ultra | Columbian Chemical Company |
| Raven 5000 Ultra III | Columbian Chemical Company |
| Monarch 1400 | Cabot |
| Black Pearls 570 | Cabot |
| Carbon Nanopowder | Sigma Aldrich |
| Carbon Nanofibers Powder | Nanostructured & Amorphous |
| | Materials Inc. |
| Glassy Carbon Spherical Powder | Alfa Aesar |
| Multiwall Carbon Nanotubes COOH | Cheap Tubes Inc. |
| functionalized | |
| Multiwall Carbon Nanotubes OH | Cheap Tubes Inc. |
| functionalized | |
| Multiwall Carbon Nanotubes | Cheap Tubes Inc. |
| Carbon Cones | n-TEC |
| Carbon Nanotubes, single walled | Sigma Aldrich |
| In-house produced modified | Akermin, Inc. |
| carbon blacks | |

TABLE 2
Pore forming agents for use in the bioelectrode GDL.

| Pore Forming Agents | Supplier |
|---|---|
| Ammonium Carbonate | Sigma |
| Ammonium bicarbonate | Sigma |
| Lithium Carbonate | Sigma |
| Ammonium Oxalate | Sigma |
| Ethylene Glycol | Sigma |
| Polyethylene Glycol | Sigma |
| Glycerol | Sigma |

TABLE 3
Binder materials for use in the bioelectrode GDL.

| Binder Agents | Supplier |
|---|---|
| Polyvinylidene difluoride (also known as | Sigma |
| Kynar) | |
| Polytetrafluoroethylene (also known as | Sigma |
| Teflon) | |

TABLE 4
Conductive carbon fibers for use as the second electrically
conductive material in the bioelectrode GDL.

| Graphite Fibers | Supplier |
|---|---|
| DKDX | Cytec Carbon Fiber |
| XN-100 | Nippon Graphite Fiber |

The carbon black materials are selected to affect the surface area of the electron conductor along with its electrical conductivity and electron transfer. The pore forming reagents are used to increase the surface area of the electron conductor (electrode) by forming pores within the structure and thus, increasing its surface area and the ability of substrate to diffuse to enzymes if present. The binder materials can be used to advantageously alter the hydrophobic/hydrophilic character of the electron conductor (electrode) to increase mass transport and also affect the structural integrity of the structure. The conductive carbon fibers can be selected to affect the conductivity along with affecting the structural integrity of the electron conductor (electrode).

### Alternative Bioanode Materials

The bioanode in accordance with some embodiments of this invention comprises a current collector (e.g., current collector 161), a gas diffusion layer (or electron conductor) (e.g., gas diffusion layer 165), optionally an electron mediator, optionally an electrocatalyst for the electron mediator, and an enzyme that is immobilized in an enzyme immobilization material. In some embodiments, these components are adjacent to one another, meaning they are physically or chemically connected by appropriate means.

1. Current Collector

The current collector (e.g., 161) is a substance that conducts electrons and provides a lattice support for the gas diffusion layer and catalyst layer. Thus, materials that provide these functions can be used for the current collector. For various bioanode embodiments, a nickel or nickel containing material (i.e., Inconel) is preferred. When a PQQ-dependent alcohol dehydrogenase enzyme is used as the bioanode enzyme, the nickel ions generated from the slow dissolution of the current collector act as a promoter for the enzymatic reaction.

2. Gas Diffusion Layer (GDL or Electron Conductor)

The gas diffusion layer (or electron conductor) (e.g, 165) is a substance that conducts electrons. The gas diffusion layer can be an organic or inorganic material as long as it is able to conduct electrons through the material. The gas diffusion layer can be a carbon-based material, stainless steel, stainless steel mesh, a metallic conductor, a semiconductor, a metal oxide, a modified conductor, or combinations thereof. In preferred embodiments, the gas diffusion layer is a carbon-based material.

Particularly suitable gas diffusion layers are carbon-based materials. Exemplary carbon-based materials are carbon cloth, carbon paper, carbon screen printed electrodes, carbon paper (Toray), carbon paper (ELAT), carbon black (Vulcan XC-72, E-tek), carbon black, carbon powder, carbon fiber, single-walled carbon nanotubes, double-walled carbon nanotubes, multi-walled carbon nanotubes, carbon nanotubes arrays, diamond-coated conductors, glassy carbon, mesoporous carbon, and combinations thereof. In addition, other exemplary carbon-based materials are graphite, uncompressed graphite worms, delaminated purified flake graphite (Superior® graphite), high performance graphite and carbon powders (Formula BT™, Superior® graphite), highly ordered pyrolytic graphite, pyrolytic graphite, polycrystalline graphite, and combinations thereof. A preferred gas diffusion layer is a sheet of carbon cloth.

In further embodiments, the gas diffusion layer can be made of a metallic conductor. Suitable electron conductors can be prepared from gold, platinum, iron, nickel, copper, silver, stainless steel, mercury, tungsten, other metals suitable for electrode construction, and combinations thereof. In addition, gas diffusion layers which are metallic conductors can be constructed of nanoparticles made of cobalt, carbon, and other suitable metals. Other metallic electron conductors can be silver-plated nickel screen printed electrodes.

In addition, the gas diffusion layer can be a semiconductor. Suitable semiconductor materials include silicon and germanium, which can be doped with other elements. The semiconductors can be doped with phosphorus, boron, gallium, arsenic, indium or antimony, or a combination thereof.

Additionally, the gas diffusion layer can be a metal oxide, metal sulfide, main group compound (i.e., transition metal compound), a material modified with an electron conductor, and combinations thereof. An exemplary gas diffusion layer of this type is nanoporous titanium oxide, tin oxide coated glass, cerium oxide particles, molybdenum sulfide, boron nitride nanotubes, aerogels modified with a conductive material such as carbon, solgels modified with conductive material such as carbon, ruthenium carbon aerogels, mesoporous silicas modified with a conductive material such as carbon, and combinations thereof. In some of the preferred embodiments, the gas diffusion layer comprises carbon black, mesoporous carbon, epoxy, and polytetrafluoroethylene.

In various preferred embodiments, the gas diffusion layer comprises dry components of Monarch 1400 carbon black (Cabot) and Chemsorb 1505 G5 porous, impregnated steam activated carbon (C*Chem), and wet components of Quick Set 2 part epoxy (The Original Super Glue Corp.) dissolved in acetone and 60% polytetrafluoroethylene (PTFE) dispersion in water (Sigma). The dry components are ground in a food grinder and the wet components are mixed with an ultra sonic homogenizer, then the dry and wet components are combined and mixed with a putty knife until the mixture has the consistency of toothpaste.

3. Electron Mediators

The bioanode electron mediator serves to accept or donate electron(s), readily changing from oxidized to reduced forms. The electron mediator is a compound that can diffuse into the enzyme immobilization material and/or be incorporated into the immobilization material. It is preferred that the electron mediator's diffusion coefficient is maximized.

Exemplary electron mediators are nicotinamide adenine dinucleotide (NAD⁺), flavin adenine dinucleotide (FAD), nicotinamide adenine dinucleotide phosphate (NADP), pyrroloquinoline quinone (PQQ), equivalents of each, and combinations thereof. Other exemplary electron mediators are phenazine methosulfate, dichlorophenol indophenol, short chain ubiquinones, potassium ferricyanide, a protein, a metalloprotein, stellacyanin, and combinations thereof.

Where the electron mediator cannot undergo a redox reaction at the electron conductor by itself, the bioanode comprises an electrocatalyst for an electron mediator which facilitates the release of electrons at the electron conductor. Alternatively, a reversible redox couple that has a standard reduction potential of 0.0V±0.5 V is used as the electron mediator. Stated another way, an electron mediator that provides reversible electrochemistry on the electron conductor surface can be used. This electron mediator is coupled with a naturally occurring enzyme contained in an organelle that is dependent on that electron mediator.

4. Electrocatalyst for an Electron Mediator

Generally, the electrocatalyst is a substance that facilitates the release of electrons at the electron conductor. Stated another way, the electrocatalyst improves the kinetics of a reduction or oxidation of an electron mediator so the electron mediator reduction or oxidation can occur at a lower standard reduction potential. The electrocatalyst can be reversibly oxidized at the bioanode to produce electrons and thus, electricity. When the electrocatalyst is adjacent to the electron conductor, the electrocatalyst and electron conductor are in electrical contact with each other, but not necessarily in physical contact with each other. In one embodiment, the electron conductor is part of, associates with, or is adjacent to an electrocatalyst for an electron mediator.

Generally, the electrocatalyst can be an azine, a conducting polymer or an electroactive polymer. Exemplary electrocatalysts are methylene green, methylene blue, luminol, nitro-fluorenone derivatives, azines, osmium phenanthrolinedione, catechol-pendant terpyridine, toluene blue, cresyl blue, nile blue, neutral red, phenazine derivatives, tionin, azure A, azure B, toluidine blue O, acetophenone, metallophthalocyanines, nile blue A, modified transition metal ligands, 1,10-phenanthroline-5,6-dione, 1,10-phenanthroline-5,6-diol, [Re(phen-dione)(CO)₃Cl], [Re(phen-dione)₃](PF₆)₂, poly(metallophthalocyanine), poly(thionine), quinones, diimines, diaminobenzenes, diaminopyridines, phenothiazine, phenoxazine, toluidine blue, brilliant cresyl blue, 3,4-dihydroxybenzaldehyde, poly(acrylic acid), poly(azure I), poly(nile blue A), poly(methylene green), poly(methylene blue), polyaniline, polypyridine, polypyrole, polythiophene, poly(thieno[3,4-b]thiophene), poly(3-hexylthiophene), poly(3,4-ethylenedioxypyrrole), poly(isothianaphthene), poly(3,4-ethylenedioxythiophene), poly(difluoroacetylene), poly(4-dicyanomethylene-4H-cyclopenta[2,1-b;3,4-b′]dithiophene), poly(3-(4-fluorophenyl)thiophene), poly(neutral red), a protein, a metalloprotein, stellacyanin, and combinations thereof. In one preferred embodiment, the electrocatalyst for the electron mediator is poly(methylene green).

5. Enzyme

An enzyme catalyzes the oxidation of the fuel fluid at the bioanode. Generally, naturally-occurring enzymes, man-made enzymes, artificial enzymes and modified naturally-occurring enzymes can be utilized. In addition, engineered enzymes that have been engineered by natural or directed evolution can be used. Stated another way, an organic or inorganic molecule that mimics an enzyme's properties can be used in an embodiment of the present invention.

Specifically, exemplary enzymes for use in a bioanode are oxidoreductases. In some embodiments, the oxidoreductases act on the CH—OH group or CH—NH group of the fuel (alcohols, ammonia compounds, carbohydrates, aldehydes, ketones, hydrocarbons, fatty acids and the like).

In other embodiments, the enzyme is a dehydrogenase. Exemplary enzymes include alcohol dehydrogenase, aldehyde dehydrogenase, formate dehydrogenase, formaldehyde dehydrogenase, glucose dehydrogenase, glucose oxidase, lactatic dehydrogenase, lactose dehydrogenase, pyruvate dehydrogenase, or lipoxygenase. Preferably, the enzyme is an alcohol dehydrogenase (ADH).

To maximize the energy density obtained from the fuel fluid when used in a biofuel cell, it is desirable to completely oxidize that fuel, meaning breaking as many bonds in the molecule as possible. The enzyme(s) selected for use in the bioanode are suitable for maximizing the energy density of a particular fuel fluid. For example, hydrogen fuel requires one enzyme, and methanol requires three. When ethanol is used as a fuel, the enzymes of Krebs cycle can be used. For example, aconitase, fumarase, malate dehydrogenase, succinate dehydrogenase, succinyl-CoA synthetase, isocitrate dehydrogenase, ketoglutarate dehydrogenase, citrate synthase and combinations thereof can be used in the bioanode.

In a preferred embodiment, the enzyme is a PQQ-dependent alcohol dehydrogenase. PQQ is the coenzyme of PQQ-dependent ADH and remains electrostatically attached to PQQ-dependent ADH and therefore the enzyme will remain in the enzyme immobilization material leading to an increased lifetime and activity for the biofuel cell. The PQQ-dependent alcohol dehydrogenase enzyme is extracted from gluconobacter. When extracting the PQQ-dependent ADH, it can be in two forms: (1) the PQQ is electrostatically bound to the PQQ-dependent ADH or (2) the PQQ is not electrostatically bound the PQQ-dependent ADH. For the second form where the PQQ is not electrostatically bound to the PQQ-dependent ADH, PQQ is added to the ADH upon assembly of the bioanode. In a preferred embodiment, the PQQ-dependent ADH is extracted from gluconobacter with the PQQ electrostatically bound.

6. Enzyme Immobilization Material

An enzyme or organelle immobilization material can be used to immobilize and stabilize enzymes or organelles. This discussion of immobilization materials applies to enzyme immobilization materials as well as organelle immobilization materials. In various embodiments, the enzyme immobilization material is permeable to a compound smaller than the enzyme so the desired reaction can be catalyzed by the immobilized enzyme.

Generally, an enzyme is used to catalyze various reactions and this enzyme is immobilized in an enzyme immobilization material that both immobilizes and stabilizes the enzyme. With respect to the stabilization of the enzyme, the enzyme immobilization material provides a chemical and mechanical barrier to prevent or impede enzyme denaturation. To this end, the enzyme immobilization material physically confines the enzyme, preventing the enzyme from unfolding. The process of unfolding an enzyme from a folded three-dimensional structure is one mechanism of enzyme denaturation. Typically, a free enzyme in solution loses its catalytic activity within a few hours to a few days, whereas a properly immobilized and stabilized enzyme of this invention can retain its catalytic activity for at least about 7 days to about 730 days or more. The retention of catalytic activity is defined by the number of days that the enzyme retains at least about 75% of its initial activity while continually catalyzing a chemical transformation. The enzyme activity can be measured by chemiluminescence, electrochemical, UV-Vis, radiochemical or fluorescence assay wherein the intensity of the property is measured at an initial time. Typically, a fluorescence assay is used to measure the enzyme activity. In other words, a stabilized enzyme of the invention retains at least about 75% of its initial activity while the enzyme is continually catalyzing a chemical transformation for at least about 7 days to about 730 days. In some embodiments, the immobilized and stabilized enzyme retains at least about 75% of its initial catalytic activity for at least about 30, 45, 60, 75, 90, 105, 120, 150, 180, 210, 240, 270, 300, 330, 365, 400, 450, 500, 550, 600, 650, 700, 730 days or more, preferably retaining at least about 80%, 85%, 90%, 95% or more of its initial catalytic activity for at least about 5, 10, 15, 20, 25, 30, 45, 60, 75, 90, 105, 120, 150, 180, 210, 240, 270, 300, 330, 365, 400, 450, 500, 550, 600, 650, 700, 730 days or more. For purposes of the present invention, an enzyme is “stabilized” (for use in a bioanode or biocathode of a biofuel cell or other uses wherein relatively long periods of catalytic activity are needed) if it retains at least about 75% of its initial catalytic activity for at least about 30 days to about 730 days or more when actively catalyzing a chemical transformation.

Also, in various embodiments, after immobilization in the enzyme immobilization material, the enzyme retains at least about 0.65, 0.7, 0.75, 0.8, 0.85, 0.9, 0.95, or more, of its activity relative to the activity of the enzyme before immobilization.

An immobilized enzyme is an enzyme that is physically confined in a certain region of the enzyme immobilization material while retaining its catalytic activity. There are a variety of methods for enzyme immobilization, including carrier-binding, cross-linking and entrapping. Carrier-binding is the binding of enzymes to water-insoluble carriers. Cross-linking is the intermolecular cross-linking of enzymes by bifunctional or multifunctional reagents. Entrapping is incorporating enzymes into the lattices of a semipermeable material. The particular method of enzyme immobilization is not critically important, so long as the enzyme immobilization material (1) immobilizes the enzyme, and (2) stabilizes the enzyme. In various embodiments, the enzyme immobilization material is also permeable to a compound smaller than the enzyme.

An immobilized organelle is an organelle that is physically confined in a certain region of the immobilization material while retaining its catalytic activity.

With reference to the immobilization material's permeability to various compounds that are smaller than an enzyme or organelle, the immobilization material allows the movement of a substrate, fuel fluid, or oxidant compound through it so the compound can contact the enzyme or organelle. The immobilization material can be prepared in a manner such that it contains internal pores, channels, openings or a combination thereof, which allow the movement of the compound throughout the immobilization material, but which constrain the enzyme or organelle to substantially the same space within the immobilization material. Such constraint allows the enzyme or organelle to retain its catalytic activity. In various preferred embodiments, the enzyme or organelle is confined to a space that is substantially the same size and shape as the enzyme or organelle, wherein the enzyme or organelle retains substantially all of its catalytic activity. The pores, channels, or openings have physical dimensions that satisfy the above requirements and depend on the size and shape of the specific enzyme or organelle to be immobilized.

In some embodiments, the enzyme or organelle is entrapped within the openings of an immobilization material and contacted with nanowires grafted to a first conductive material such as carbon black particles. In some instances, the nanowires comprise a polymeric material, an oxide, an organometallic material, or a metallic material. Such materials are discussed above in the DET section and in the Conductive Polymer Based Nanowires section below.

In one embodiment, the enzyme or organelle is preferably located within a pore of the immobilization material and the compound travels in and out of the immobilization material through transport channels. The relative size of the pores and transport channels can be such that a pore is large enough to immobilize an enzyme or organelle, but the transport channels are too small for the enzyme or organelle to travel through them. Further, a transport channel preferably has a diameter of at least about 10 nm. In still another embodiment, the pore diameter to transport channel diameter ratio is at least about 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1 or more. In yet another embodiment, preferably, a transport channel has a diameter of at least about 2 nm and the pore diameter to transport channel diameter ratio is at least about 2:1, 2.5:1, 3:1, 3.5:1, 4:1, 4.5:1, 5:1, 5.5:1, 6:1, 6.5:1, 7:1, 7.5:1, 8:1, 8.5:1, 9:1, 9.5:1, 10:1 or more.

In some of the embodiments, the immobilization material has a micellar or inverted micellar structure. Generally, the molecules making up a micelle are amphipathic, meaning they contain a polar, hydrophilic group and a nonpolar, hydrophobic group. The molecules can aggregate to form a micelle, where the polar groups are on the surface of the aggregate and the hydrophobic, nonpolar groups are sequestered inside the aggregate. Inverted micelles have the opposite orientation of polar groups and nonpolar groups. The amphipathic molecules making up the aggregate can be arranged in a variety of ways so long as the polar groups are in proximity to each other and the nonpolar groups are in proximity to each other. Also, the molecules can form a bilayer with the nonpolar groups pointing toward each other and the polar groups pointing away from each other. Alternatively, a bilayer can form wherein the polar groups can point toward each other in the bilayer, while the nonpolar groups point away from each other.

In one preferred embodiment, the micellar immobilization material is a modified perfluoro sulfonic acid-PTFE copolymer (or modified perfluorinated ion exchange polymer) (modified Nafion® or modified Flemion®) membrane. The perfluorinated ion exchange polymer membrane is modified with a hydrophobic cation that is larger than the ammonium (NH₄⁺) ion. The hydrophobic cation serves the dual function of (1) dictating the membrane's pore size and (2) acting as a chemical buffer to help maintain the pore's pH level, both of which stabilize the enzyme.

With regard to the first function of the hydrophobic cation, mixture-casting a perfluoro sulfonic acid-PTFE copolymer (or perfluorinated ion exchange polymer) with a hydrophobic cation to produce a modified perfluoro sulfonic acid-PTFE copolymer (or modified perfluorinated ion exchange polymer) (Nafion® or Flemion®) membrane provides an immobilization material wherein the pore size is dependent on the size of the hydrophobic cation. Accordingly, the larger the hydrophobic cation, the larger the pore size. This function of the hydrophobic cation allows the pore size to be made larger or smaller to fit a specific enzyme or organelle by varying the size of the hydrophobic cation.

Regarding the second function of the hydrophobic cation, the properties of the perfluoro sulfonic acid-PTFE copolymer (or perfluorinated ion exchange polymer) membrane are altered by exchanging the hydrophobic cation for protons as the counterion to the —SO₃⁻ groups on the perfluoro sulfonic acid-PTFE copolymer (or anions on the perfluorinated ion exchange polymer) membrane. This change in counterion provides a buffering effect on the pH because the hydrophobic cation has a much greater affinity for the —SO₃⁻ sites than protons do. This buffering effect of the membrane causes the pH of the pore to remain substantially unchanged with changing solution pH; stated another way, the pH of the pore resists changes in the solution's pH. In addition, the membrane provides a mechanical barrier, which further protects the immobilized enzymes or organelles.

In order to prepare a modified perfluoro sulfonic acid-PTFE copolymer (or perfluorinated ion exchange polymer) membrane, the first step is to cast a suspension of perfluoro sulfonic acid-PTFE copolymer (or perfluorinated ion exchange polymer), particularly Nafion®, with a solution of the hydrophobic cations to form a membrane. The excess hydrophobic cations and their salts are then extracted from the membrane, and the membrane is re-cast. Upon re-casting, the membrane contains the hydrophobic cations in association with the —SO₃⁻ sites of the perfluoro sulfonic acid-PTFE copolymer (or perfluorinated ion exchange polymer) membrane. Removal of the salts of the hydrophobic cation from the membrane results in a more stable and reproducible membrane; if they are not removed, the excess salts can become trapped in the pore or cause voids in the membrane.

In one embodiment, a modified Nafion® membrane is prepared by casting a suspension of Nafion® polymer with a solution of a salt of a hydrophobic cation such as quaternary ammonium bromide. Excess quaternary ammonium bromide or hydrogen bromide is removed from the membrane before it is re-cast to form the salt-extracted membrane. Salt extraction of membranes retains the presence of the quaternary ammonium cations at the sulfonic acid exchange sites, but eliminates complications from excess salt that may be trapped in the pore or may cause voids in the equilibrated membrane. The chemical and physical properties of the salt-extracted membranes have been characterized by voltammetry, ion exchange capacity measurements, and fluorescence microscopy before enzyme immobilization. Exemplary hydrophobic cations are ammonium-based cations, quaternary ammonium cations, alkyltrimethylammonium cations, alkyltriethylammonium cations, organic cations, phosphonium cations, triphenylphosphonium, pyridinium cations, imidazolium cations, hexadecylpyridinium, ethidium, viologens, methyl viologen, benzyl viologen, bis(triphenylphosphine)iminium, metal complexes, bipyridyl metal complexes, phenanthroline-based metal complexes, [Ru(bipyridine)₃]²⁺ and [Fe(phenanthroline)₃]³⁺.

In one preferred embodiment, the hydrophobic cations are ammonium-based cations. In particular, the hydrophobic cations are quaternary ammonium cations. In another embodiment, the quaternary ammonium cations are represented by Formula 1:

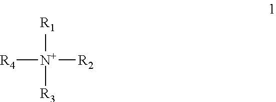

wherein R₁, R₂, R₃, and R₄ are independently hydrogen, hydrocarbyl, substituted hydrocarbyl, or heterocyclo wherein at least one of R₁, R₂, R₃, and R₄ is other than hydrogen. In a further embodiment, preferably, R₁, R₂, R₃, and R₄ are independently hydrogen, methyl, ethyl, propyl, butyl, pentyl, hexyl, heptyl, octyl, nonyl, decyl, undecyl, dodecyl, tridecyl or tetradecyl wherein at least one of R₁, R₂, R₃, and R₄ is other than hydrogen. In still another embodiment, R₁, R₂, R₃, and R₄ are the same and are methyl, ethyl, propyl, butyl, pentyl or hexyl. In yet another embodiment, preferably, R₁, R₂, R₃, and R₄ are butyl. Preferably, the quaternary ammonium cation is tetrapropylammonium (T3A), tetrapentylammonium (T5A), tetrahexylammonium (T6A), tetraheptylammonium (T7A), trimethylicosylammonium (TMICA), trimethyloctyldecylammonium (TMODA), trimethylhexyldecylammonium (TMHDA), trimethyltetradecylammonium (TMTDA), trimethyloctylammonium (TMOA), trimethyldodecylammonium (TMDDA), trimethyldecylammonium (TMDA), trimethylhexylammonium (TMHA), tetrabutylammonium (TBA), triethylhexylammonium (TEHA), and combinations thereof.

In other various embodiments, exemplary micellar or inverted micellar immobilization materials are hydrophobically modified polysaccharides, these polysaccharides are selected from chitosan, cellulose, chitin, starch, amylose, alginate, glycogen, and combinations thereof. In various embodiments, the micellar or inverted micellar immobilization materials are polycationic polymers, particularly, hydrophobically modified chitosan. Chitosan is a poly[β-(1-4)-2-amino-2-deoxy-D-glucopyranose]. Chitosan is typically prepared by deacetylation of chitin (a poly[β-(1-4)-2-acetamido-2-deoxy-D-glucopyranose]). The typical commercial chitosan has approximately 85% deacetylation. These deacetylated or free amine groups can be further functionalized with hydrocarbyl, particularly, alkyl groups. Thus, in various embodiments, the micellar hydrophobically modified chitosan corresponds to the structure of Formula 2

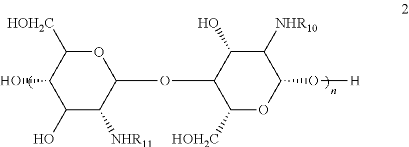

wherein n is an integer; R₁₀ is independently hydrogen, hydrocarbyl, substituted hydrocarbyl, or a hydrophobic redox mediator; and R₁₁ is independently hydrogen, hydrocarbyl, substituted hydrocarbyl, or a hydrophobic redox mediator. In certain embodiments of the invention, n is an integer that gives the polymer a molecular weight of from about 21,000 to about 500,000; preferably, from about 90,000 to about 500,000; more preferably, from about 150,000 to about 350,000; more preferably, from about 225,000 to about 275,000. In many embodiments, R₁₀ is independently hydrogen or alkyl and R₁₁ is independently hydrogen or alkyl. Further, R₁₀ is independently hydrogen or hexyl and R₁₁ is independently hydrogen or hexyl. Alternatively, R₁₀ is independently hydrogen or octyl and R₁₁ is independently hydrogen or octyl.

In other various embodiments, the micellar hydrophobically modified chitosan is a micellar hydrophobic redox mediator modified chitosan corresponding to Formula 2A

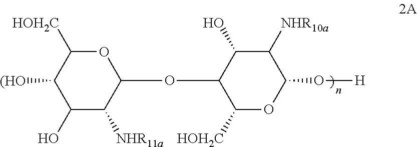

wherein n is an integer; R₁₀ₐ is independently hydrogen, or a hydrophobic redox mediator; and R₁₁ₐ is independently hydrogen, or a hydrophobic redox mediator.

Further, in various embodiments, the micellar hydrophobically modified chitosan is a modified chitosan or redox mediator modified chitosan corresponding to Formula 2B

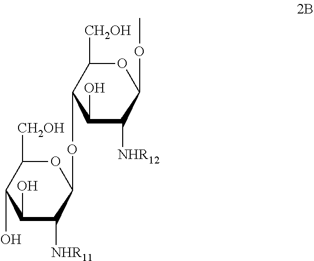

wherein R₁₁, R₁₂, and n are defined as in connection with Formula 2. In some embodiments, R₁₁ and R₁₂ are independently hydrogen or straight or branched alkyl; preferably, hydrogen, butyl, pentyl, hexyl, heptyl, octyl, nonyl, decyl, undecyl, or dodecyl. In various embodiments, R₁₁ and R₁₂ are independently hydrogen, butyl, or hexyl.

The micellar hydrophobically modified chitosans can be modified with hydrophobic groups to varying degrees. The degree of hydrophobic modification is determined by the percentage of free amine groups that are modified with hydrophobic groups as compared to the number of free amine groups in the unmodified chitosan. The degree of hydrophobic modification can be estimated from an acid-base titration and/or nuclear magnetic resonance (NMR), particularly ¹H NMR, data. This degree of hydrophobic modification can vary widely and is at least about 1, 2, 4, 6, 8, 10, 12, 14, 16, 18, 20, 25, 30, 32, 24, 26, 28, 40, 42, 44, 46, 48%, or more. Preferably, the degree of hydrophobic modification is from about 10% to about 45%; from about 10% to about 35%; from about 20% to about 35%; or from about 30% to about 35%.

In other various embodiments, the hydrophobic redox mediator of Formula 2A is a transition metal complex of osmium, ruthenium, iron, nickel, rhodium, rhenium, or cobalt with 1,10-phenanthroline (phen), 2,2′-bipyridine (bpy) or 2,2′,2″-terpyridine (terpy), methylene green, methylene blue, poly(methylene green), poly(methylene blue), luminol, nitro-fluorenone derivatives, azines, osmium phenanthrolinedione, catechol-pendant terpyridine, toluene blue, cresyl blue, nile blue, neutral red, phenazine derivatives, tionin, azure A, azure B, toluidine blue O, acetophenone, metallophthalocyanines, nile blue A, modified transition metal ligands, 1,10-phenanthroline-5,6-dione, 1,10-phenanthroline-5,6-diol, [Re(phen-dione)(CO)₃Cl], [Re(phen-dione)₃](PF₆)₂, poly(metallophthalocyanine), poly(thionine), quinones, diimines, diaminobenzenes, diaminopyridines, phenothiazine, phenoxazine, toluidine blue, brilliant cresyl blue, 3,4-dihydroxybenzaldehyde, poly(acrylic acid), poly(azure I), poly(nile blue A), polyaniline, polypyridine, polypyrole, polythiophene, poly(thieno[3,4-b]thiophene), poly(3-hexylthiophene), poly(3,4-ethylenedioxypyrrole), poly(isothianaphthene), poly(3,4-ethylenedioxythiophene), poly(difluoroacetylene), poly(4-dicyanomethylene-4H-cyclopenta[2,1-b;3,4-b′]dithiophene), poly(3-(4-fluorophenyl)thiophene), poly(neutral red), or combinations thereof.

Preferably, the hydrophobic redox mediator is Ru(phen)₃⁺², Fe(phen)₃⁺², Os(phen)₃⁺², Co(phen)₃⁺², Cr(phen)₃⁺², Ru(bpy)₃⁺², Os(bpy)₃⁺², Fe(bpy)₃⁺², Co(bpy)₃⁺², Cr(bpy)₃⁺², Os(terpy)₃⁺², Ru(bpy)₂(4-methyl-4′-(6-hexyl)-2,2′-bipyridine)⁺², Co(bpy)₂(4-methyl-4′-(6-hexyl)-2,2′-bipyridine)⁺², Cr(bpy)₂(4-methyl-4′-(6-hexyl)-2,2′-bipyridine)⁺², Fe(bpy)₂(4-methyl-4′-(6-hexyl)-2,2′-bipyridine)⁺², Os(bpy)₂(4-methyl-4′-(6-hexyl)-2,2′-bipyridine)⁺², or combinations thereof. More preferably, the hydrophobic redox mediator is Ru(bpy)₂(4-methyl-4′-(6-hexyl)-2,2′-bipyridine)⁺², Co(bpy)₂(4-methyl-4′-(6-hexyl)-2,2′-bipyridine)⁺², Cr(bpy)₂(4-methyl-4′-(6-hexyl)-2,2′-bipyridine)⁺², Fe(bpy)₂(4-methyl-4′-(6-hexyl)-2,2′-bipyridine)⁺², Os(bpy)₂(4-methyl-4′-(6-hexyl)-2,2′-bipyridine)⁺², or combinations thereof. In various preferred embodiments, the hydrophobic redox mediator is Ru(bpy)₂(4-methyl-4′-(6-hexyl)-2,2′-bipyridine)⁺².

For the immobilization material having a hydrophobic redox mediator as the modifier, the hydrophobic redox mediator is typically covalently bonded to the chitosan or polysaccharide backbone. Typically, in the case of chitosan, the hydrophobic redox mediator is covalently bonded to one of the amine functionalities of the chitosan through a —N—C— bond. In the case of metal complex redox mediators, the metal complex is attached to the chitosan through an —N—C— bond from a chitosan amine group to an alkyl group attached to one or more of the ligands of the metal complex. A structure corresponding to Formula 2C is an example of a metal complex attached to a chitosan

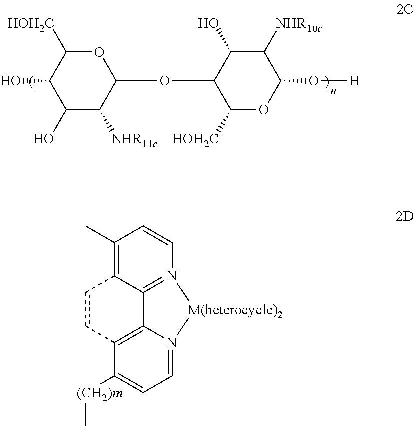

wherein n is an integer; R_{10c} is independently hydrogen or a structure corresponding to Formula 2D; R_{11c} is independently hydrogen or a structure corresponding to Formula 1D; m is an integer from 0 to 10; M is Ru, Os, Fe, Cr, or Co; and heterocycle is bipyridyl, substituted bipyridyl, phenanthroline, acetylacetone, and combinations thereof.

The hydrophobic group used to modify chitosan serves the dual function of (1) dictating the immobilization material's pore size and (2) modifying the chitosan's electronic environment to maintain an acceptable pore environment, both of which stabilize the enzyme or organelle. With regard to the first function of the hydrophobic group, hydrophobically modifying chitosan produces an immobilization material wherein the pore size is dependent on the size of the hydrophobic group. Accordingly, the size, shape, and extent of the modification of the chitosan with the hydrophobic group affects the size and shape of the pore. This function of the hydrophobic group allows the pore size to be made larger or smaller or a different shape to fit a specific enzyme or organelle by varying the size and branching of the hydrophobic group.

Regarding the second function of the hydrophobic cation, the properties of the hydrophobically modified chitosan membranes are altered by modifying chitosan with hydrophobic groups. This hydrophobic modification of chitosan affects the pore environment by increasing the number of available exchange sites to proton. In addition to affecting the pH of the material, the hydrophobic modification of chitosan provides a membrane that is a mechanical barrier, which further protects the immobilized enzymes.

Table 5 shows the number of available exchange sites to proton for the hydrophobically modified chitosan membrane.

TABLE 5
Number of available exchange sites to proton
per gram of chitosan polymer

| | Exchange sites per gram |
|---|---|
| Membrane | (×10⁻⁴ mol SO₃/g) |
| Chitosan | 10.5 ± 0.8 |
| Butyl Modified | 226 ± 21 |
| Hexyl Modified | 167 ± 45 |
| Octyl Modified | 529 ± 127 |
| Decyl Modified | 483 ± 110 |

Further, such polycationic polymers are capable of immobilizing enzymes or organelle and increasing the activity of enzymes immobilized therein as compared to the activity of the same enzyme or organelle in a buffer solution. In various embodiments, the polycationic polymers are hydrophobically modified polysaccharides, particularly, hydrophobically modified chitosan. For example, for the hydrophobic modifications noted, the enzyme activities for glucose oxidase were measured. The highest enzyme activity was observed for glucose oxidase in a hexyl modified chitosan suspended in t-amyl alcohol. These immobilization membranes showed a 2.53 fold increase in glucose oxidase enzyme activity over enzyme in buffer. Table 6 details the glucose oxidase activities for a variety of hydrophobically modified chitosans.

TABLE 6
Glucose oxidase enzyme activity for modified chitosans

| | Enzyme Activity |
|---|---|
| Membrane/Solvent | (Units/gm) |
| Buffer | 103.61 ± 3.15 |
| UNMODIFIED CHITOSAN | 214.86 ± 10.23 |
| HEXYL CHITOSAN | |
| Chloroform | 248.05 ± 12.62 |
| t-amyl alcohol | 263.05 ± 7.54 |
| 50% acetic acid | 118.98 ± 6.28 |
| DECYL CHITOSAN | |
| Chloroform | 237.05 ± 12.31 |
| t-amyl alcohol | 238.05 ± 10.02 |
| 50% acetic acid | 3.26 ± 2.82 |
| OCTYL CHITOSAN | |
| Chloroform | 232.93 ± 7.22 |
| t-amyl alcohol | 245.75 ± 9.77 |
| 50% acetic acid | 127.55 ± 11.98 |
| BUTYL CHITOSAN | |
| Chloroform | 219.15 ± 9.58 |
| t-amyl alcohol | 217.10 ± 6.55 |
| 50% acetic acid | 127.65 ± 3.02 |

To prepare the hydrophobically modified chitosans of the invention having an alkyl group as a modifier, a chitosan gel was suspended in acetic acid followed by addition of an alcohol solvent. To this chitosan gel was added an aldehyde (e.g., butanal, hexanal, octanal, or decanal), followed by addition of sodium cyanoborohydride. The resulting product was separated by vacuum filtration and washed with an alcohol solvent. The modified chitosan was then dried in a vacuum oven at 40° C. and resulted in a flaky white solid.

To prepare a hydrophobically modified chitosan of the invention having a redox mediator as a modifier, a redox mediator ligand was derivatized by contacting 4,4′-dimethyl-2,2′-bipyridine with lithium diisopropylamine followed by addition of a dihaloalkane to produce 4-methyl-4′-(6-haloalkyl)-2,2′-bipyridine. This ligand was then contacted with Ru(bipyridine)₂Cl₂ hydrate in the presence of an inorganic base and refluxed in a water-alcohol mixture until the Ru(bipyridine)₂Cl₂ was depleted. The product was then precipitated with ammonium hexafluorophosphate, or optionally a sodium or potassium perchlorate salt, followed by recrystallization. The derivatized redox mediator (Ru(bipyridine)₂(4-methyl-4′-(6-bromohexyl)-2,2′-bipyridine)⁺²) was then contacted with deacetylated chitosan and heated. The redox mediator modified chitosan was then precipitated and recrystallized.

The hydrophobically modified chitosan membranes have advantageous insolubility in ethanol. For example, the chitosan enzyme immobilization materials described above generally are functional to immobilize and stabilize the enzymes in solutions having up to about 99 wt. % or 99 volume % ethanol. In various embodiments, the chitosan immobilization material is functional in solutions having 15, 20, 25, 30, 35, 40, 45, 50, 55, 60, 65, 70, 75, 80, 85, 90, 95 or more wt. % or volume % ethanol.

In other embodiments, the micellar or inverted micellar immobilization materials are polyanionic polymers, such as hydrophobically modified polysaccharides, particularly, hydrophobically modified alginate. Alginates are linear unbranched polymers containing β-(1-4)-linked D-mannuronic acid and α-(1-4)-linked L-guluronic acid residues. In the unprotonated form, β-(1-4)-linked D-mannuronic acid corresponds to the structure of Formula 3A

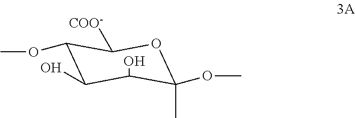

and in the unprotonated form, α-(1-4)-linked L-guluronic acid corresponds to the structure of Formula 3B

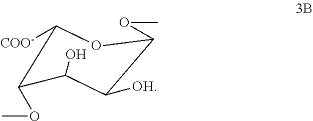

Alginate is a heterogeneous polymer consisting of polymer blocks of mannuronic acid residues and polymer blocks of guluronic acid residues.

Alginate polymers can be modified in various ways. One type is alginate modified with a hydrophobic cation that is larger than the ammonium (NH₄⁺) ion. The hydrophobic cation serves the dual function of (1) dictating the polymer's pore size and (2) acting as a chemical buffer to help maintain the pore's pH level, both of which stabilize the enzyme or organelle. With regard to the first function of the hydrophobic cation, modifying alginate with a hydrophobic cation produces an immobilization material wherein the pore size is dependent on the size of the hydrophobic cation. Accordingly, the size, shape, and extent of the modification of the alginate with the hydrophobic cation affects the size and shape of the pore. This function of the hydrophobic cation allows the pore size to be made larger or smaller or a different shape to fit a specific enzyme or organelle by varying the size and branching of the hydrophobic cation.

Regarding the second function of the hydrophobic cation, the properties of the alginate polymer are altered by exchanging the hydrophobic cation for protons as the counterion to the —CO₂⁻ groups on the alginate. This change in counterion provides a buffering effect on the pH because the hydrophobic cation has a much greater affinity for the —CO₂⁻ sites than protons do. This buffering effect of the alginate membrane causes the pH of the pore to remain substantially unchanged with changing solution pH; stated another way, the pH of the pore resists changes in the solution's pH. In addition, the alginate membrane provides a mechanical barrier, which further protects the immobilized enzymes or organelles.

In order to prepare a modified alginate membrane, the first step is to cast a suspension of alginate polymer with a solution of the hydrophobic cation to form a membrane. The excess hydrophobic cations and their salts are then extracted from the membrane, and the membrane is re-cast. Upon re-casting, the membrane contains the hydrophobic cations in association with —CO₂⁻ sites of the alginate membrane. Removal of the salts of the hydrophobic cation from the membrane results in a more stable and reproducible membrane; if they are not removed, the excess salts can become trapped in the pore or cause voids in the membrane.

In one embodiment, a modified alginate membrane is prepared by casting a suspension of alginate polymer with a solution of a salt of a hydrophobic cation such as quaternary ammonium bromide. Excess quaternary ammonium bromide or hydrogen bromide are removed from the membrane before it is re-cast to form the salt-extracted membrane. Salt extraction of membranes retains the presence of the quaternary ammonium cations at the carboxylic acid exchange sites, but eliminates complications from excess salt that may be trapped in the pore or may cause voids in the equilibrated membrane. Exemplary hydrophobic cations are ammonium-based cations, quaternary ammonium cations, alkyltrimethylammonium cations, alkyltriethylammonium cations, organic cations, phosphonium cations, triphenylphosphonium, pyridinium cations, imidazolium cations, hexadecylpyridinium, ethidium, viologens, methyl viologen, benzyl viologen, bis(triphenylphosphine)iminium, metal complexes, bipyridyl metal complexes, phenanthroline-based metal complexes, [Ru(bipyridine)₃]²⁺ and [Fe(phenanthroline)₃]³⁺.

In one preferred embodiment, the hydrophobic cations are ammonium-based cations. In particular, the hydrophobic cations are quaternary ammonium cations. In another embodiment, the quaternary ammonium cations are represented by Formula 4:

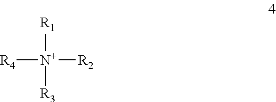

wherein R₁, R₂, R₃, and R₄ are independently hydrogen, hydrocarbyl, substituted hydrocarbyl, or heterocyclo wherein at least one of R₁, R₂, R₃, and R₄ is other than hydrogen. In a further embodiment, preferably, R₁, R₂, R₃, and R₄ are independently hydrogen, methyl, ethyl, propyl, butyl, pentyl, hexyl, heptyl, octyl, nonyl, decyl, undecyl, dodecyl, tridecyl or tetradecyl wherein at least one of R₁, R₂, R₃, and R₄ is other than hydrogen. In still another embodiment, R₁, R₂, R₃, and R₄ are the same and are methyl, ethyl, propyl, butyl, pentyl or hexyl. In yet another embodiment, preferably, R₁, R₂, R₃, and R₄ are butyl. Preferably, the quaternary ammonium cation is tetrapropylammonium (T3A), tetrapentylammonium (T5A), tetrahexylammonium (T6A), tetraheptylammonium (T7A), trimethylicosylammonium (TMICA), trimethyloctyldecylammonium (TMODA), trimethylhexyldecylammonium (TMHDA), trimethyltetradecylammonium (TMTDA), trimethyloctylammonium (TMOA), trimethyldodecylammonium (TMDDA), trimethyldecylammonium (TMDA), trimethylhexylammonium (TMHA), tetrabutylammonium (TBA), triethylhexylammonium (TEHA), and combinations thereof.

The pore characteristics were studied and the pore structure of this membrane is ideal for enzyme immobilization, because the pores are hydrophobic, micellar in structure, buffered to external pH change, and have high pore interconnectivity.

In another experiment, ultra low molecular weight alginate and dodecylamine were placed in 25% ethanol and refluxed to produce a dodecyl-modified alginate by amidation of the carboxylic acid groups. Various alkyl amines can be substituted for the dodecylamine to produce alkyl-modified alginate having a C₄-C₁₆ alkyl group attached to varying numbers of the reactive carboxylic acid groups of the alginate structure. In various embodiments, at least about 1, 2, 4, 6, 8, 10, 12, 14, 16, 18, 20, 22, 24, 26, 28, 30, 32, 34, 36, 38, 40, 42, 44, 46, 48%, or more of the carboxylic acid groups react with the alkylamine

The hydrophobically modified alginate membranes have advantageous insolubility in ethanol. For example, the alginate enzyme immobilization materials described above generally are functional to immobilize and stabilize the enzymes in solutions having at least about 25 wt. % or 25 volume % ethanol. In various embodiments, the alginate immobilization material is functional in solutions having 25, 30, 35, 40, 45, 50, 55, 60, 65, 70, 75, 80, 85, 90 or more wt. % or volume % ethanol.

In order to evaluate the most advantageous immobilization material for a particular enzyme or organelle, the selected enzyme or organelle can be immobilized in various immobilization materials, deposited on an electron conductor, and treated with a solution containing an electron mediator (e.g., NAD⁺) and/or a substrate for the particular enzyme in a buffer solution. A fluorescence micrograph is obtained and shows fluorescence when the enzyme or organelle immobilized in the particular immobilization material is still a catalytically active enzyme after immobilization. This is one way to determine whether a particular immobilization material will immobilize and stabilize an enzyme or organelle while retaining the enzyme's or organelle's catalytic activity. For example, for starch consuming amylase, the enzyme immobilization material that provided the greatest relative activity is provided by immobilization of the enzyme in butyl chitosan suspended in t-amyl alcohol. For maltose consuming amylase, the greatest relative activity is provided by immobilization of the enzyme in medium molecular weight decyl modified chitosan.

### Cathode Assemblies

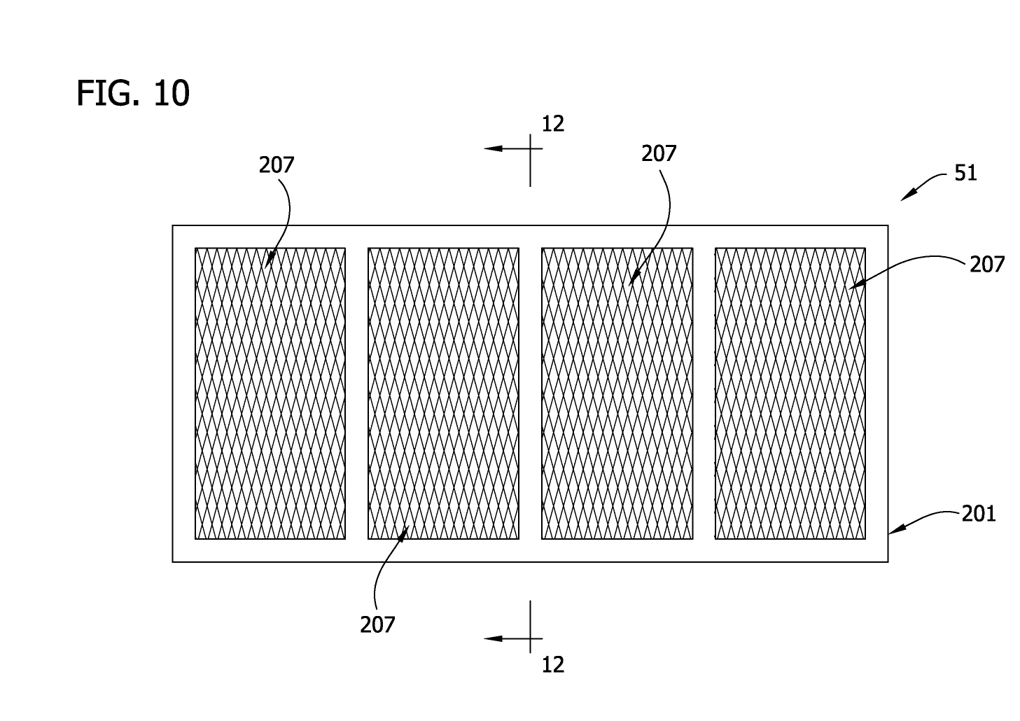

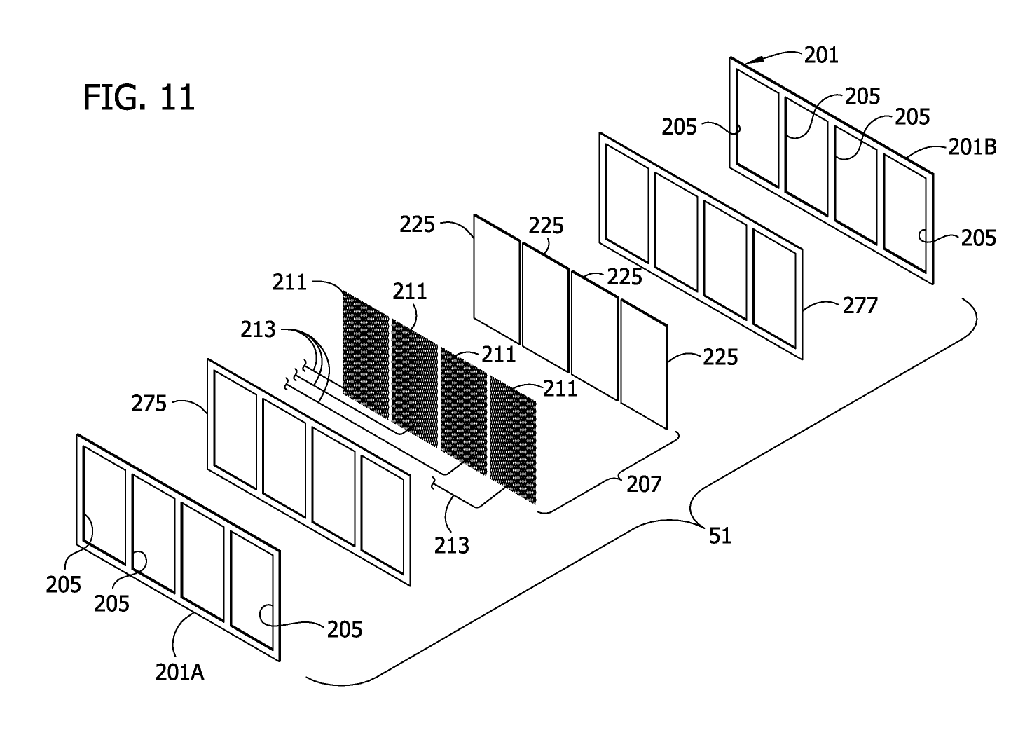

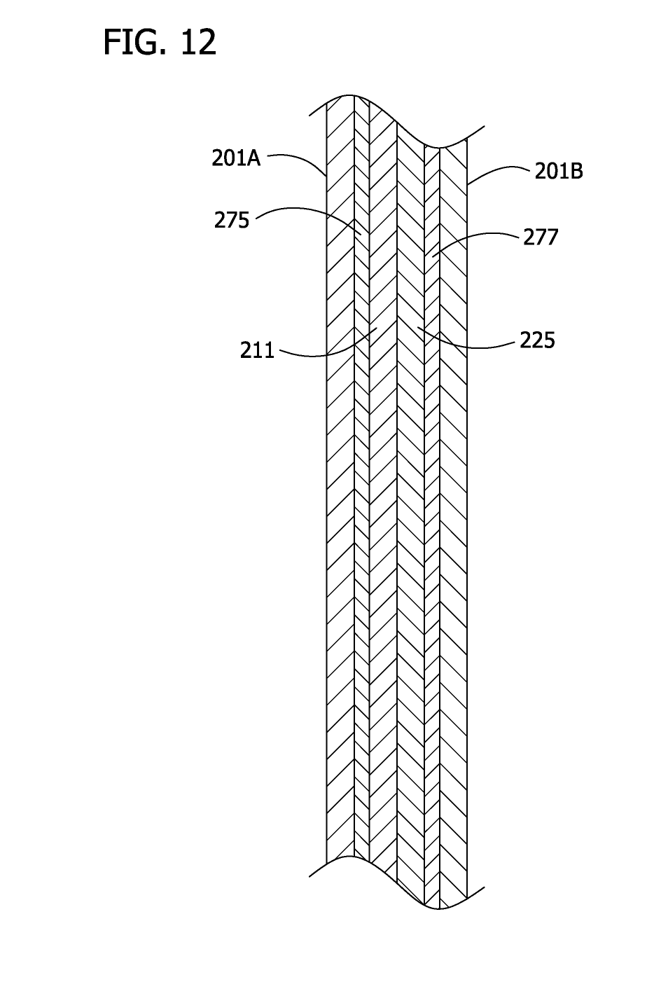

As shown in FIGS. 10-12, the front cathode assembly 51 at the front side 21 of the manifold 15 is constructed in a manner similar to the front anode assembly 45. That is, the assembly 51 includes a similar frame, generally designated 201, comprising a pair of mating frame members 201A, 201B having openings 205, and a number of cathodes, each generally designated 207, held by the frame 201 in the frame openings 205, one cathode per frame opening.

In some embodiments, each cathode 207 comprises a current collector 211. In one embodiment, the current collector 211 comprises a wire mesh panel of gold-plated stainless steel having a thickness of about 0.018 in. A suitable electrical lead 213 (e.g., a 28-gauge conductor) is affixed to the collector 211. The cathode 207 also includes a layered catalyst structure, generally designated 225, on the back face of the current collector 211. This layered catalyst structure comprises a gas diffusion layer, a catalyst layer, and a polyelectrolyte membrane (Nafion®). In some instances, the cathode gas diffusion layer comprises dry components of Monarch 1400 carbon black (Cabot) and Chemsorb 1505 G5 porous, impregnated steam activated carbon (C*Chem), and wet components of Quick Set 2 part epoxy (The Original Super Glue Corp.) dissolved in acetone and 60% polytetrafluoroethylene (PTFE) dispersion in water (Sigma). The dry components are ground in a food grinder and the wet components are mixed with an ultra sonic homogenizer, then the dry and wet components are combined and mixed with a putty knife until the mixture has the consistency of toothpaste. In some of the various embodiments, the gas diffusion layer and catalyst layer need not be distinct layers, but can be combined. Upon assembly, this layered catalyst structure is affixed to the back face of the current collector 211. In a particular embodiment, the catalyst layered structure is prepared by applying an ink comprising a platinum black catalyst and Nafion® ionomer to one side of the gas diffusion layer (e.g., E-Tek as LT2500W Low Temperature Elat with microporous layer on either side). Once the ink comprising the catalyst has dried, the catalyst layered structure is assembled by placing the gas diffusion layer on top of the current collector with platinum black catalyst side up, then placing the polyelectrolyte membrane (e.g., Nafion®) on top of the gas diffusion and catalyst layers. This assembly is soaked with water and then fixed together by hot pressing, resulting in a stand alone cathode fixture. The polyelectrolyte membrane (e.g., Nafion® ionomer) is impermeable to the fuel fluid, but is able to conduct electrons and protons.

Each cathode 201 is sized slightly larger than a corresponding frame opening 205 so that the side edge margins of the cathode extend beyond respective sides of the frame opening for overlapping portions of the frame members 201A, 201B. The cathodes 201 are secured to the frame members by a front layer 275 of adhesive disposed between the front frame member 201A and the current collectors 211 of the cathodes 201, and a back layer 277 of adhesive between the back frame member 201B and the layered catalyst structure 225 of the cathodes 201. The front and back adhesive layers 275, 277 comprise a urethane hot melt adhesive film having a thickness of about 0.0005 in., for example. The front and back adhesive layers 275, 277 are configured to have a size and shape corresponding to the size and shape of the front and back frame members 201A, 201B, respectively. When heat is applied to the assembly (as by a hot press procedure), the adhesive melts to secure the two frame members 201A, 201B, collectors 211 and catalyst structures 225 in fixed position relative to one another to form a unitary front cathode structure.

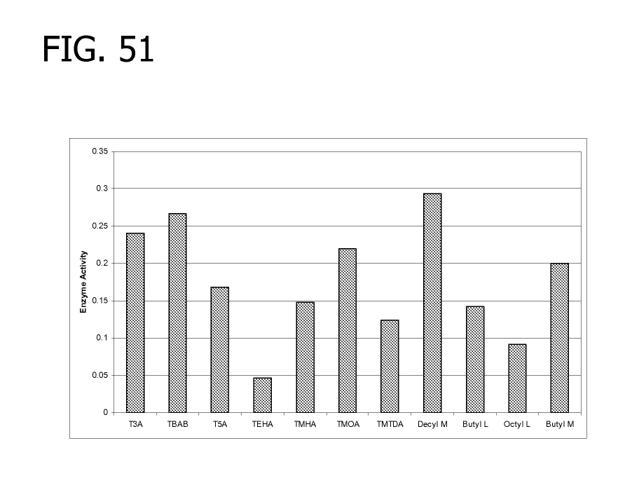

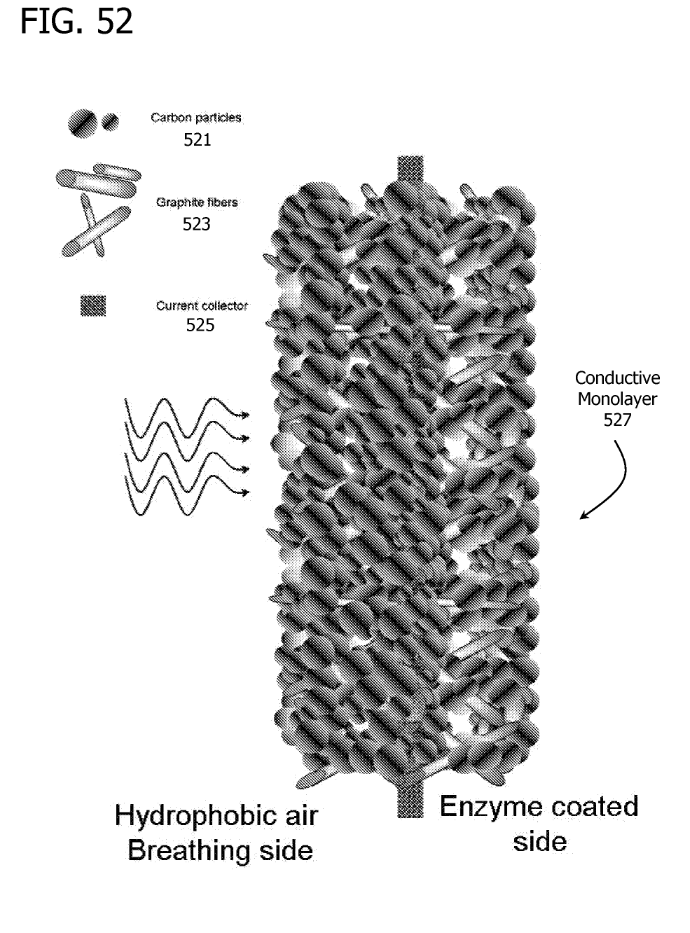

In other embodiments having a self-supporting biocathode catalyst support as shown in FIG. 52, each cathode 207 comprises a current collector 525 embedded within the cathode. In an embodiment, the current collector has a proximal end and a distal end and extends along a longitudinal axis. A conductive monolayer 527 in contact with the current collector 525 extends coaxially from the proximal end to the distal end of the current collector. A suitable electrical lead 213 is affixed to the collector 525. In yet other embodiments, the self-supporting biocathode catalyst support does not include an embedded current collector 525. The conductive monolayer 527 is a mixture of a first electrically conductive material, a second electrically conductive material, and a binder, and can be fabricated as described in the Self-Supporting Biocathode Catalyst Support Fabrication section below. A side of the conductive monolayer 527 functions as a hydrophobic air breathing portion of a biocathode. A catalyst layer containing enzymes (not shown) is then applied to an opposite side of the monolayer 527 by the method described in the Conductive Polymer Based Nanowires section below. The resulting biocathode includes a hydrophobic air breathing side on one face of the current collector 525, and an enzyme containing side on the back face of the collector 525. Alternatively, catalyst particles containing an enzyme (as described in the Encapsulated Enzyme Incorporation into Carbon Paste section below) can be added to the mixture used in forming the monolayer 527 to provide enzymes within the conductive monolayer.

Each cathode 201 is sized slightly larger than a corresponding frame opening 205 so that the side edge margins of the cathode extend beyond respective sides of the frame opening for overlapping portions of the frame members 201A, 201B. The cathodes 201 are secured to the frame members by a front layer 275 of adhesive disposed between the front frame member 201A and a side of the monolayer 527 of the cathodes 201, and a back layer 277 of adhesive between the back frame member 201B and the opposite side of the monolayer 527 of the cathodes 201. The front and back adhesive layers 275, 277 comprise a urethane hot melt adhesive film having a thickness of about 0.0005 in., for example. The front and back adhesive layers 275, 277 are configured to have a size and shape corresponding to the size and shape of the front and back frame members 201A, 201B, respectively. When heat is applied to the assembly (as by a hot press procedure), the adhesive melts to secure the two frame members 201A, 201B, collectors 525 and monolayer 527 in fixed position relative to one another to form a unitary front cathode structure.

The front cathode assembly 51 is secured in fixed position with respect to the front anode assembly 45 and the manifold 15 so that the anodes 157 and cathodes 207 are in general alignment with one another and with respective fuel reservoirs 41 at the front side 21 of the fuel manifold. In one embodiment, the front cathode frame 201 is secured to the front anode frame 151 by adhesive or other suitable mechanical means. A seal (not shown) is provided between the front cathode frame 201 and the front anode frame 151 to isolate each anode/cathode set from each adjacent anode/cathode set. The seal may be formed in different ways, as by the use of a suitable layer of adhesive between the rear face of the cathode frame 201 and the front face of the anode frame 151, or by one or more sealing members (e.g., gaskets), or in other ways.

The back cathode assembly 53 at the back side 23 of the manifold 15 is constructed in a manner substantially identical to the front cathode assembly 51, and corresponding parts are identified by the same reference numbers. The frame 201 of the back cathode assembly 53 is positioned against the back anode assembly 47 with the back cathodes 201 and back anodes 157 in registration with one another and with respective fuel reservoirs 41 at the back side 23 of the manifold 15. The back cathode assembly 53 is secured in fixed position with respect to the manifold 15 and the back anode assembly 47 in the same manner described above in regard to the front cathode assembly 51.

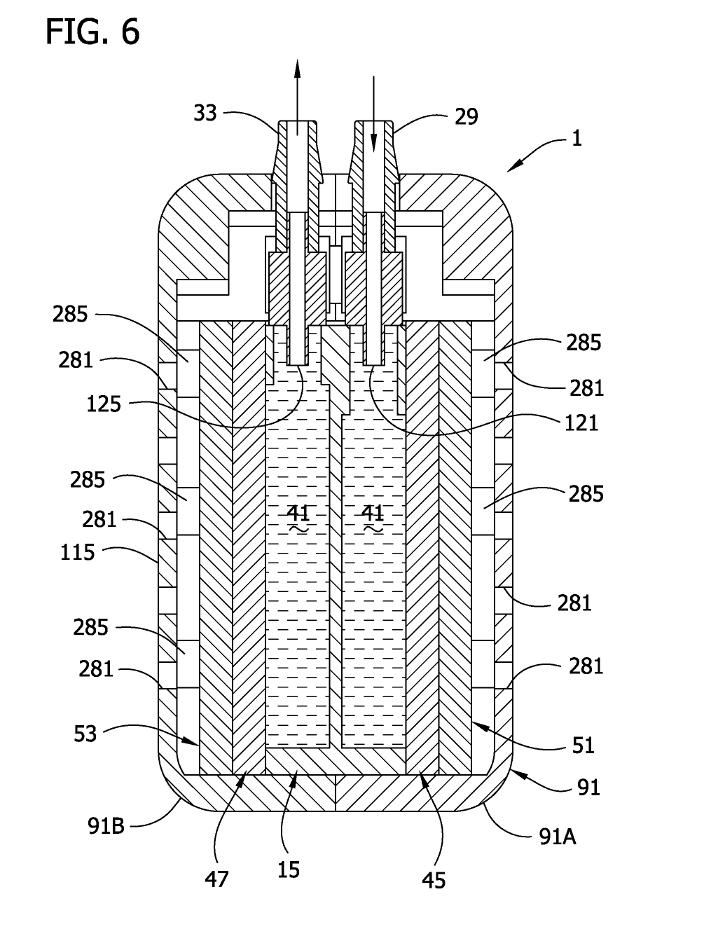

Preferably, the perimeter size and shape of the manifold 15, front and back anode assemblies 45, 47, and front and back cathode assemblies 51, 53 are substantially the same so that these components can be stacked or layered to form a compact unitary structure as shown in FIG. 6 for placement in the housing 91. The size of the structure will vary depending on the number of fuel cells “stacked” together. (Each fuel cell comprises a fuel reservoir 41, an anode 157, and a cathode 201.) By way of example, a fuel cell device 1 having a stack of eight cells, as shown in FIGS. 1-6 may have the following dimensions: 3.5×2.0×1.0 inches (approximately 8.9 cm×5.1 cm×2.54 cm). In the design of this invention, any number of fuel cells can be readily stacked together to form a compact unit.

It will be noted that when the various components described above are assembled, the anodes 157 and cathodes 201 exposed within the respective frame openings 155, 205 are positioned below the chambers or spaces 131 at the tops of respective fuel reservoirs 41 so that any air bubbles trapped in these spaces will not contact respective anodes and cathodes. This construction is best illustrated in FIG. 5, where the elevation of the top edges of the aligned anode and cathode frame openings 155, 201 is indicated by the line 291. This elevation 291 is below the chambers 131, or at least below the tops of the chambers 131, so that any air bubbles in the fuel reservoirs 41 will ascend to a location out of contact with the respective electrode structures.

### Cathodes

Cathodes and biocathodes of the invention generally comprise a catalyst, an electron conductor (gas diffusion layer), and optionally a current collector. A cathode or biocathode of the invention includes a catalyst that is selective for reduction of oxygen in the air, capable of direct electron transfer with the cathode electron conductor, and capable of minimal, if any, catalysis of the oxidation of an alcohol fuel fluid when used in a fuel cell. When an enzyme is used as the catalyst, the cathode further comprises an enzyme immobilization material. The cathode also includes an electron conductor (gas diffusion layer) that is permeable to air and the fuel fluid, facilitates direct electron transfer with the catalyst, and manages the water produced in the oxygen reduction reaction to minimize or prevent flooding of the cathode. In various preferred embodiments, the catalyst is capable of gaining electrons directly from the electron conductor and releasing them to the oxidant, which is oxygen. In other embodiments, the cathode or biocathode further comprises an electron mediator that mediates the electron transfer from the electron conductor to the catalyst. In various other embodiments, the cathode or biocathode further comprises an electron mediator and an electrocatalyst for the electron mediator, where the electron mediator and the electrocatalyst facilitate the transfer of electrons from the electron conductor to the catalyst and further to the oxidant, oxygen.

Air Breathing Cathodes

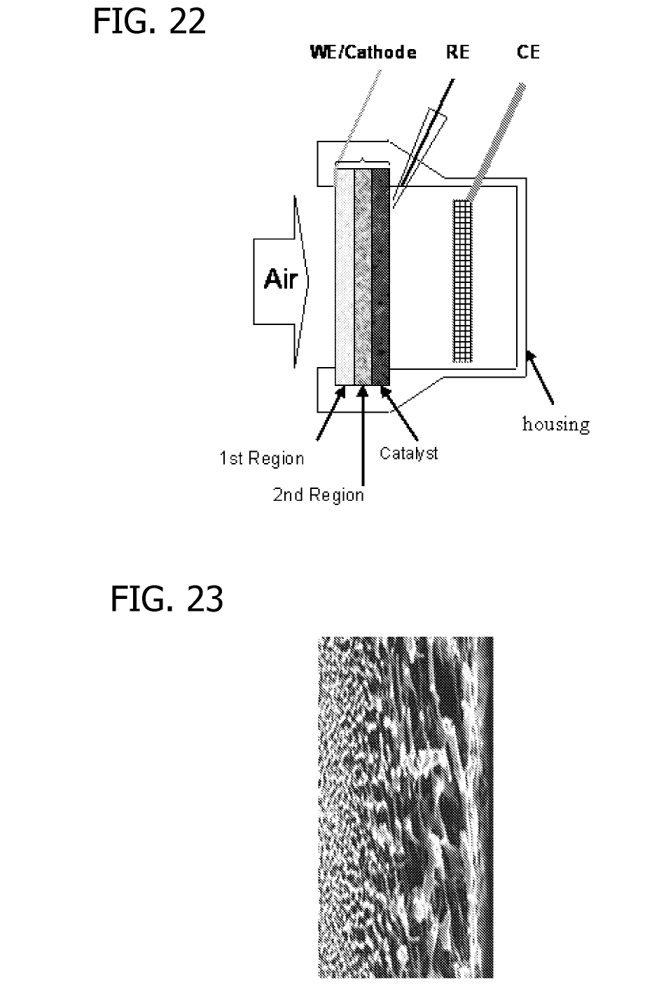

Among the various aspects of the present invention is an electrode as illustrated in FIG. 22. The electrode comprises a first region of electrically conductive material that is permeable to air and impermeable to a fuel fluid, a second region of conductive material that is permeable to the fuel fluid and to air, and a catalyst that is able to contact both the fuel fluid and air. The electrode is depicted in FIG. 22 as the working electrode (WE) of an air-breathing half-cell. The working electrode (WE) contains the regions or layers labeled 1st region, 2nd region, and catalyst. The half cell also includes a reference electrode (RE) placed near the working electrode and a counter electrode (CE) of preferably a precious metal mesh or carbon sheet. An air-breathing half-cell comprising this electrode (WE) generates a current density of at least about 16, 17, 18, 19, 20, 25, 30, 35, 40, 45, 50, 55, 60, 65, 70, 75, 80, or more mA/cm² when operating at room temperature, an electron potential of 0.4 V, and a catalyst loading of 10 mg/cm². When an air breathing cathode of the invention is incorporated into a fuel cell, it has been found to provide greater current density at room temperature, 0.4 V electron potential and a catalyst loading of 10 mg/cm² as compared to the same fuel cell which instead includes a known air-breathing non-platinum cathode.

Another of the various aspects of the invention is an electrode comprising an electron conductor, at least one non-precious metal catalyst, and an optional carbon-supported polyamine. In many preferred embodiments, the electrode has undergone heat treatment to increase metal atom interaction with the polyamine and the non-precious metal catalyst selectively reduces oxygen to water. Further, an air-breathing half-cell comprising the electrode generates at least about 16, 17, 18, 19, 20, 25, 30, 35, 40, 45, 50, 55, 60, 65, 70, 75, 80, or more mA/cm² when operating at room temperature, an electron potential of 0.4 V, and a catalyst loading of 10 mg/cm².

In other embodiments, the electrode comprises an electron conductor, an enzyme capable of reacting with an oxidant to produce water, an enzyme immobilization material, and optionally an electron mediator and/or an electrocatalyst for the electron mediator. The enzyme immobilization material immobilizes and stabilizes the enzyme. The electron conductor comprises a functionalized multi-walled carbon nanotube or an activated carbon based material for increasing current density as compared to an electrode with the same electron conductor that is not functionalized or activated.

As described in more detail below, cathode and biocathode embodiments wherein there is direct electron transfer from the electron conductor to the catalyst are preferred, although embodiments of enzyme-catalyzed biocathodes having electron mediators or electron mediators and electrocatalysts are within the scope of the invention.

When tested in an air-breathing half cell as described above, various embodiments of the cathodes and biocathodes of the invention produce a current density of at least about 16, 17, 18, 19, 20, 25, 30, 35, 40, 45, 50, 55, 60, 65, 70, 75, 80, or more mA/cm² when operating at room temperature, an electron potential of 0.4 V, and a catalyst loading of 10 mg/cm².

Cathode Catalyst

The cathode catalyst can generally be an enzyme or a non-precious metal catalyst. Preferably, the catalyst is selective for reduction of the oxidant, oxygen. This selectivity is preferred because such a cathode catalyst will not react to oxidize the fuel fluid and thus, maintains high utilization of fuel and high cathode potential. Also, the anode and cathode do not have to be separated by a polymer electrolyte membrane, thus improving the cost and efficiency of the fuel cell.

When an enzyme is used as the catalyst, it must be capable of reducing oxygen at the biocathode. Generally, naturally-occurring enzymes, man-made enzymes, artificial enzymes and modified naturally-occurring enzymes can be utilized. In addition, engineered enzymes that have been engineered by natural or directed evolution can be used. Stated another way, an organic or inorganic molecule that mimics an enzyme's properties can be used in an embodiment of the present invention. In various preferred embodiments, the enzyme is bilirubin oxidase, laccase, superoxide dismutase, peroxidase, or combinations thereof. Preferably, the enzyme comprises bilirubin oxidase.

In other embodiments, the cathode catalyst is a non-precious metal catalyst. Preferably, the non-precious metal catalyst selectively reduces oxygen without reacting with the fuel fluid. Another preferred characteristic of the non-precious metal catalyst is that it is substantially tolerant to the presence of the fuel fluid. When a catalyst has substantial tolerance to the fuel fluid, the catalyst activity is not substantially decreased upon increasing the concentration of fuel fluid in contact with the catalyst. Stated another way, the current density generated by a half-cell comprising the catalyst when using an electrolyte solution containing an alcohol is not substantially less than (i.e., is at least about 75% of) the maximum current density generated by the same half-cell when using an electrolyte solution containing 5% alcohol. For example, when the fuel fluid is an alcohol, the current density using an electrolyte solution containing 30 wt. % alcohol in a half cell is at least about 75% of the maximum current density using an electrolyte solution containing 5 wt. % alcohol. In particular, the catalyst is tolerant to the presence of methanol and ethanol.

To increase the current density of a cathode containing a non-precious metal catalyst, the catalyst can be heat treated at about 500-900° C. The non-precious metal catalyst can be a transition metal, a transition metal macrocycle, or combinations thereof. When the catalyst is a transition metal macrocycle, it can be a transition metal phthalocyanine, a transition metal porphyrin, derivatives or analogs thereof, or combinations thereof. Exemplary transition metal macrocycles are iron phthalocyanine, cobalt phthalocyanine, iron porphyrin, cobalt porphyrin, derivatives or analogs thereof, or combinations thereof. Preferred transition metal macrocycles comprise cobalt(II)1,2,3,4,8,9,10,11,15,16,17,18,22,23,24,25-hexadecafluoro-29H,31H-phthalocyanine, or derivatives or analogs thereof.

The non-precious metal catalyst preferably interacts or associates with a polyamine. In particularly preferred embodiments, the polyamine is a carbon-supported amine. The polyamine can be polyaniline, polypyrrole, derivatives or analogs thereof, or combinations thereof. In various preferred embodiments, the polyamine comprises polypyrrole or derivatives or analogs thereof.

To increase the interaction or association between the non-precious metal catalyst and the polyamine, a heat treatment step is performed to break down the interactions within the non-precious metal catalyst and the polyamine and make interactions (or bonds) between the non-precious metal catalyst and the polyamine. This heat treatment step is preferably performed in an inert atmosphere. During the heat treatment step, the non-precious metal catalyst, particularly the metal macrocycle catalyst, is heated while in contact with the polyamine or carbon-supported polyamine to about 500° C. to about 900° C.; preferably, about 550° C. to about 650° C.; more preferably, about 590° C. to about 610° C. The duration of this heating step is typically for about 0.5 hours to about 6 hours; preferably, about 0.5 hours to about 3 hours; more preferably, about 1 hour.

As described in more detail below, the hydrophobicity of the electron conductor of these electrodes can be controlled to manage the water produced during the reduction of oxygen. To that end, a hydrophilic agent, such as phosphotungstic acid, poly(4-styrenesulfonic acid), or combinations thereof can be added to decrease the hydrophobicity of the electron conductor.

Table 7 below lists the various acceptable materials and process conditions used to prepare the electrodes containing a non-precious metal catalyst and a polyamine, and performance characteristics observed when these electrodes are incorporated into a half cell as described above. Each material, process condition, or performance characteristic is contemplated in combination with the electron conductor materials described below and every other each material, process condition, or performance characteristic listed.

TABLE 7

| | | | | Current |
|---|---|---|---|---|
| | | | | density in |
| | | Heat | | half cell |
| Catalyst | Polyamine | treatment | tolerance | (mA/cm²) |
| Non-precious metal | Polyaniline | 500° C.-900° C. | Fuel fluid | 16 |
| | | for | tolerant | |
| | | 0.5 h | | |
| Transition metal | Polyaniline | 550° C.-650° C. | Alcohol | 20 |
| | derivatives | for | tolerant | |
| | | 0.5 h | | |
| Transition metal macrocycle | Polyaniline | 590° C.-610° C. | Ethanol | 25 |
| | analogs | for | tolerant | |
| | | 0.5 h | | |
| Transition metal porphyrin | Polypyrrole | 500° C.-900° C. | Methanol | 30 |
| | | for | tolerant | |
| | | 1 h | | |
| Transition metal phthalocyanine | Polypyrrole | 550° C.-650° C. | Acid | 35 |
| | derivatives | for | tolerant | |
| | | 1 h | | |
| Transition metal porphyrin derivative | Polypyrrole | 590° C.-610° C. | | 40 |
| | analogs | for | | |
| | | 1 h | | |
| Transition metal porphyrin analog | Carbon- | 500° C.-900° C. | | 45 |
| | supported | for | | |
| | Polyaniline | 2 h | | |
| Transition metal phthalocyanine | Carbon- | 550° C.-650° C. | | 50 |
| derivative | supported | for | | |
| | Polyaniline | 2 h | | |
| | derivatives | | | |
| Transition metal phthalocyanine | Carbon- | 590° C.-610° C. | | 55 |
| analog | supported | for | | |
| | Polyaniline | 2 h | | |
| | analogs | | | |
| Iron porphyrin | Carbon- | | | 60 |
| | supported | | | |
| | Polypyrrole | | | |
| Iron porphyrin derivative | Carbon- | | | 65 |
| | supported | | | |
| | Polypyrrole | | | |
| | derivatives | | | |
| Iron porphyrin analog | Carbon- | | | 70 |
| | supported | | | |
| | Polypyrrole | | | |
| | analogs | | | |
| Cobalt porphyrin | | | | 75 |
| Cobalt porphyrin derivative | | | | 80 |
| Cobalt porphyrin analog | | | | |
| Iron phthalocyanine | | | | |
| Iron phthalocyanine derivative | | | | |
| Iron phthalocyanine analog | | | | |
| Cobalt phthalocyanine | | | | |
| Cobalt phthalocyanine derivative | | | | |
| Cobalt phthalocyanine analog | | | | |
| cobalt(II)1,2,3,4,8,9,10,11,15,16,17,18, | | | | |
| 22,23,24,25-hexadecafluoro- | | | | |
| 29H,31H-phthalocyanine | | | | |
| cobalt(II)1,2,3,4,8,9,10,11,15,16,17,18, | | | | |
| 22,23,24,25-hexadecafluoro- | | | | |
| 29H,31H-phthalocyanine derivatives | | | | |
| cobalt(II)1,2,3,4,8,9,10,11,15,16,17,18, | | | | |
| 22,23,24,25-hexadecafluoro- | | | | |
| 29H,31H-phthalocyanine analogs | | | | |

Electron Conductor (Gas Diffusion Layer)

Generally, the electron conductor is a substance that conducts electrons. The electron conductor can be organic or inorganic in nature as long as it is able to conduct electrons through the material. In many of the various embodiments, preferably the electron conductor is a carbon-based material. Exemplary carbon-based materials are carbon cloth (E-Tek), carbon paper, carbon screen printed electrodes, carbon paper (Toray), carbon paper (ELAT), carbon black (Vulcan XC-72, Cabot), carbon black, carbon powder, carbon fiber, single-walled carbon nanotubes, double-walled carbon nanotubes, multi-walled carbon nanotubes, carbon nanotubes arrays, diamond-coated conductors, glassy carbon, mesoporous carbon, graphite, uncompressed graphite worms, delaminated purified flake graphite (Superior® graphite), high performance graphite and carbon powders (Formula BT™, Superior® graphite), highly ordered pyrolytic graphite, pyrolytic graphite, polycrystalline graphite, and combinations thereof.

For specific uses various types of carbon-based electron conductors provide optimal performance. For example, electron conductors having a porous carbon structure wherein the porosity varies depending on the position within the electron conductor layer is useful for fuel cells utilizing a liquid electrolyte or fuel fluid. Additionally, for biocathodes, functionalized multi-walled carbon nanotubes and activated carbon electron conductors facilitate direct electron transfer from the electron conductor to the enzyme in the biocathode.

In some of the various embodiments, an electron conductor (gas diffusion layer) having pores that are larger in one region of the electron conductor than in another region of the electron conductor are used. For example, an electron conductor having an asymmetrical pore distribution is depicted in FIG. 23. The pore sizes are controlled so that a first region of the electron conductor is permeable to air, but impermeable to a fuel fluid (the light portions shown in FIG. 23) and a second region of the electron conductor is permeable to air and a fuel fluid (the dark portions shown in FIG. 23). In certain fuel cell and biofuel cell embodiments, the electron conductor is substantially permeable to a material (e.g., air or fuel fluid) when a substantial amount (i.e., at least about 50, 55, 60, 65, 70, 75, 80, 85 or more volume %) of the material is able to permeate through the material over a particular amount of time. For example, the electron conductor is substantially permeable to a fuel fluid when at least about 50 volume % of the fuel fluid passes through the electron conductor within about 3 hours.

This type of electron conductor is particularly useful for fuel cells using a liquid electrolyte rather than a solid electrolyte. Typically, such electron conductors comprise carbon black. However, acceptable alternatives are electrically conducting carbon materials having a high surface area, an acceptable porosity in terms of being permeable to air and/or permeable to air and fuel fluid, and an appropriate hydrophobicity. The hydrophobicity is controlled to manage water produced from the reduction of oxygen. The hydrophobicity can be increased by adding increasing amounts of polytetrafluoroethylene to the electron conductor. Thus, the more polytetrafluoroethylene added to the electron conductor, the greater the hydrophobicity of the electron conductor. Further, the hydrophobicity can be decreased by either adding lower amounts of polytetrafluoroethylene or by adding a hydrophilic agent such as phosphotungstic acid, or poly(4-styrenesulfonic acid).

Electron conductors having a porosity gradient can be prepared by adding a pore-forming agent. Acceptable pore-forming agents diffuse into the electron conductor (e.g., carbon layer) and then are easily removed from the electron conductor. An exemplary pore-forming agent is ammonium carbonate.

In various other embodiments, the electron conductor comprises functionalized multi-walled carbon nanotubes (MWCNT). These functionalized MWCNT are modified by hydroxyl, carboxyl, amino, or thiol groups, or combinations thereof on the surface of the nanotubes. In various preferred embodiments, the functionalized MWCNT are modified with hydroxyl or carboxyl groups, or combinations thereof. The functionalized MWCNT have an average diameter of less than about 15 nm. Preferably, the functionalized MWCNT have an average diameter of less than about 8 nm. These functionalized MWCNT are particularly preferred in biocathodes having an enzyme as the catalyst and wherein direct electron transfer between the electron conductor and the enzyme is desired.

Other electron conductors comprise activated carbon. A variety of carbon materials can be activated as described below. Preferably, the carbon black that is activated is a carbon black sold under the Printex XE-2 name having a highly structured, extra conductive black with an average particle size of 30 nm and a BET surface area of about 910 m²/g; it is commercially available from Degussa. The carbon materials are activated by heating to 600-900° C., followed by immersing in cold water. Without being bound by a particular theory, it is believed that the heating followed by rapid cooling breaks the carbon sheet and forms structures that have a high surface area and may be similar to nanotubes.

Without being bound by a particular theory, it is believed that the function of the functionalized MWCNT and the activated carbon when used in an enzyme-catalyzed biocathode is to (1) interact with the amino acid side groups of the enzyme by hydrogen bonding; (2) orient the enzyme to keep the active side of the biocathode to the enzyme; and (3) provide an advantageous orientation of the electron tunnel of the enzyme in the biocathode.

### Preparation of Materials for Air-Breathing Cathodes

The various electron conductors, catalysts, and cathodes described above can be prepared using the following general procedures.

Electron Conductor Having a Gradient Pore Size

To prepare the electron conductor having a desired porosity gradient, an electron conductor having the desired surface area, porosity, and hydrophobicity is prepared. Generally, an electron conductor is prepared by immersing a piece of carbon-based support material in an electrophoretic deposition bath containing the desired electron conductor material (e.g., carbon black), a non-ionic surfactant, and a hydrophobic agent (e.g., polytetrafluoroethylene (PTFE)). The electrophoretic deposition is performed under standard conditions known in the art and using a counter electrode. Following the electrophoretic deposition, the electron conductor is rinsed with water and dried. A coating dough of the desired electron conductor material (e.g., carbon black), a hydrophobic agent (e.g., PTFE), and solvent is prepared and coated on both sides of the electron conductor prepared by electrophoretic deposition. The solvent in the coating dough is evaporated to form a coating film. The coating film is hot pressed and then sintered. The pore distribution can be controlled by brushing a pore-forming agent on one side of the electron conductor, allowing the agent to diffuse into the electron conductor and then heat decomposing the pore-forming agent to form the pores.

Specifically, the electron conductor pictured in FIG. 2 was prepared by immersing a piece of carbon cloth (18 cm², E-Tek, B1A) in the electrophoretic deposition bath containing 20 mL of a solution of 0.60 g carbon black (XE2, degussa), 0.60 mL Triton X-100, 0.67 g 60% polytetrafluoroethylene (PTFE) dispersion (Aldrich) and 100 mL milliQ water. The electrophoretic deposition was performed at 40 V for 20 minutes using carbon paper as the counter electrode and a distance of 3 mm between the carbon cloth and the carbon paper. Once the deposition was complete, the carbon cloth was rinsed with water to remove Triton X-100 and dried in a vacuum oven at 100° C. for 1 hour. Dough of 0.40 g carbon black (Degussa, XE2), 0.33 g 60% PTFE suspension (Aldrich) and 8 mL ethanol was prepared. Then the dough was coated on both sides of the carbon cloth made by electrophoretic deposition as described above. The solvent in the coated film was evaporated at room temperature for 30 minutes. Then, the film was hot pressed at a pressure of 500 pounds at 95° C. before sintering it at 380° C. for 30 minutes. The PTFE content in the coated film was about 33 wt. %. Further, the pore distribution in the coated film was controlled by brushing 2 mL of pore-forming reagent (1.0 wt. % ammonium carbonate in isopropanol solution) on one side of the carbon cloth. The agent migrated into the coated film and resulted in a gradient. The agent was then heat decomposed at 90° C. and then the carbon cloth was cleaned in a vacuum oven at 120° C. and 28 inch-Hg.

Heat Treated and Non-Heat Treated Non-Precious Metal Catalysts

A non-precious metal catalyst, such as a cobalt macrocycle (e.g., cobalt phthalocyanine (CoPc) and cobalt(II) 1,2,3,4,8,9,10,11,15,16,17,18,22,23,24,25-hexadecafluoro-29H,31H-phthalocyanine (CoPcF)), is prepared by dispersing the non-precious metal catalyst (e.g., CoPc or CoPcF) in a solvent and placing the dispersion in an ultrasonic bath. Solvent is then evaporated and the dry powder is placed in a crucible and heat-treated in an inert atmosphere at a temperature of 500-900° C. The resulting catalyst is combined with a Nafion solution and dispersed in a solvent using an ultrasonic bath. This mixture is slowly coated onto the active side of an electron conductor (gas diffusion layer) and dried. In some cases, a hydrophilic agent (e.g., phosphotungstic acid) is added to the mixture with the non-precious metal catalyst and Nafion solution and dispersed in an ultrasonic bath before coating on the electron conductor. When a non-precious metal catalyst was used without heat treatment, the non-precious metal catalyst (e.g., CoPc or CoPcF) and Nafion solution are dispersed in a solvent and this solution is slowly coated onto the active side of the electron conductor and dried.

Heat Treated and Non-Heat Treated Non-Precious Metal Catalysts with Polyamine

A non-precious metal catalyst, such as a cobalt macrocycle (e.g., cobalt phthalocyanine (CoPc) and cobalt(II) 1,2,3,4,8,9,10,11,15,16,17,18,22,23,24,25-hexadecafluoro-29H,31H-phthalocyanine (CoPcF)), is prepared by dispersing the non-precious metal catalyst (e.g., CoPc or CoPcF) and a polyamine (e.g., polypyrrole) in a solvent and placing the dispersion in an ultrasonic bath. Solvent is then evaporated and the dry powder is placed in a crucible and heat-treated in an inert atmosphere at a temperature of 500-900° C. The resulting catalyst is combined with a Nafion solution and dispersed in a solvent using an ultrasonic bath. This mixture is slowly coated onto the active side of an electron conductor (gas diffusion layer) and dried. In some cases, a hydrophilic agent (e.g., phosphotungstic acid) is added to the mixture with the CoPc or CoPcF and Nafion solution and dispersed in an ultrasonic bath before coating on the electron conductor. When a non-precious metal catalyst with polyamine was used without heat treatment, the non-precious metal catalyst (e.g., CoPc or CoPcF), polyamine, and Nafion solution are dispersed in a solvent and this solution is slowly coated onto the active side of the electron conductor and dried.

Heat Treated Non-Precious Metal Catalysts on Carbon

A non-precious metal catalyst, such as a cobalt macrocycle (e.g., cobalt phthalocyanine (CoPc) and cobalt(II) 1,2,3,4,8,9,10,11,15,16,17,18,22,23,24,25-hexadecafluoro-29H,31H-phthalocyanine (CoPcF)), is prepared by dispersing the non-precious metal catalyst (e.g., CoPc or CoPcF) and a carbon material (e.g., carbon black) in an ultrasonic bath with subsequent evaporation of the solvent. The dry powder is placed in a crucible and heat-treated in an inert atmosphere at a temperature of 500-900° C. The powder is then combined with a Nafion solution and dispersed in a solvent in an ultrasonic bath and slowly coated onto the active side of the electron conductor (gas diffusion layer) and dried.

Preparation of Enzyme Layer

A carbon material was dispersed in solvent in an ultrasonic bath to make a carbon suspension. An enzyme (such as BOD or laccase) solution in buffer was added into the suspension followed by shaking. This mixture was slowly coated on to the active side of an electron conductor (gas diffusion layer) and then dried.

### Self-Supporting Biocathode Catalyst Support

The biocathode catalyst support design provides the flexibility of structural design, materials selection, and the ability to create multilayer structures with appropriate hydrophobic/hydrophilic properties for supporting a biocathode catalyst such as an enzyme. A schematic of the Biocathode Catalyst Support is shown in FIG. 52. As described above, the biocathode catalyst support includes an embedded expanded metal material 525 for collecting current and for increasing the rigidity of the biocathode catalyst support, and an electrically conductive monolayer 527 surrounding the current collector 525. The current collector 525 is an optional component of the biocathode catalyst support; if it is not included, current is collected from the electrically conductive monolayer 527 of the biocathode catalyst support by an electrical connection.

Regardless of whether an embedded expanded metal material is present in the biocathode catalyst support, an optimal biocathode electrode allows for water management (i.e., water rejection when there is excess water) on the air breathing or oxidant reactant side of the electrode to prevent excess generated water from blocking oxygen transport to the electrode. This is generally achieved by rendering the surface or the whole structure of the conductive monolayer hydrophobic. On the surface of the electrode that is opposite the air breathing or oxidant reactant side of the electrode, a slightly hydrophilic, high surface area micro-porous layer is adjacent to an outer surface of the conductive monolayer for enhanced enzyme-electrode interaction. This can be accomplished for a biofuel cell with the electrode structure described herein in Example 27. In this example and as represented in FIG. 52, the micro-porous layer (not shown) for the enzyme is formed on the surface of the conductive monolayer 527 that handles water management and reactant mass transport. In some embodiments, the first electrically conductive material is modified with an electron mediator, such as carbon black modified with a doped conductive polymer, for increasing electronic and ionic conductivity and improving DET.

In various preferred embodiments, the first electrically conductive layer of one or more carbon blacks is mixed with the second electrically conductive layer of one or more carbon fibers, and one or more binders to form the conductive monolayer. The carbon blacks are present in the mixture in a concentration of about 30 wt. % to about 45 wt. %, the carbon fibers are present in the mixture in a concentration of about 20 wt. % to about 40 wt. % and the binders are present in the mixture in a concentration of about 25 wt. % to about 40 wt. %. In various preferred embodiments, the carbon blacks are present in the mixture in a concentration of about 33 wt. %, the carbon fibers are present in the mixture in a concentration of about 33 wt. %, and the binders are present in the mixture in a concentration of about 33 wt. %.

Self-Supporting Biocathode Catalyst Support Fabrication

The catalyst support layer used for the biocathode electrodes is made from a mixture of carbon materials, binder, pore forming agents, solvents, and optional catalyst such as enzymes, similar to that of the bioanode. By varying the ratio of these components, the properties of the entire structure can be altered to provide desired properties for a specific application or a combination of these components can be used to make an electrode with two or more distinct regions for water management and enzyme interaction. Examples of such properties include: (1) substrate permeation, (2) electronic conduction, hydrophobicity/hydrophilicity, (3) surface area, and (4) surface structure.

The fabrication of the biocathode catalyst support material is similar to that described for the bioanode with the exception of the frame material and sintering cycles and temperatures. For example, the MDS Nylon 6/6 frame material used in the bioanode can be replaced by a similar thickness PTFE coated fiberglass sheet. The sintering cycle for the biocathode can be changed due to the use of polytetrafluoroethylene (PTFE) as a binder as replacement for the poly(vinylidene fluoride) binder. For a PTFE based GDL, the entire assembly (i.e., frame(s) and electrode material), is first sintered at a temperature up to 200° C. for up to 20 minutes, depending on the desired structure and formulation. After sintering, the electrode is removed from the frame(s) and temporary support and cooled between two aluminum blocks (12″×12″×1″) until set, usually only a couple of minutes, prior to a second sintering at a temperature of 300° C. for up to 10 minutes. These fabrication steps are the same regardless of whether an embedded expanded metal material is present in the biocathode catalyst support.

If the catalyst is not included in the conductive monolayer when it is formed, the catalyst layer can be applied to the catalyst support as described in the Encapsulated Enzyme Incorporation into Carbon Paste section below. Alternatively, catalyst particles containing an enzyme (as described in the Encapsulated Enzyme Incorporation into Carbon Paste and Biocatalyst Ink Formulation sections below) can be added to the mixture used in forming the monolayer 527, or can be included in a paste or ink which is then applied to a surface of the catalyst support.

### Anode and Cathode Fabrication Techniques

Specific procedures used to fabricate the anode and cathode assemblies are described in more detail below in the examples.

Conductive Polymer Based Nanowires

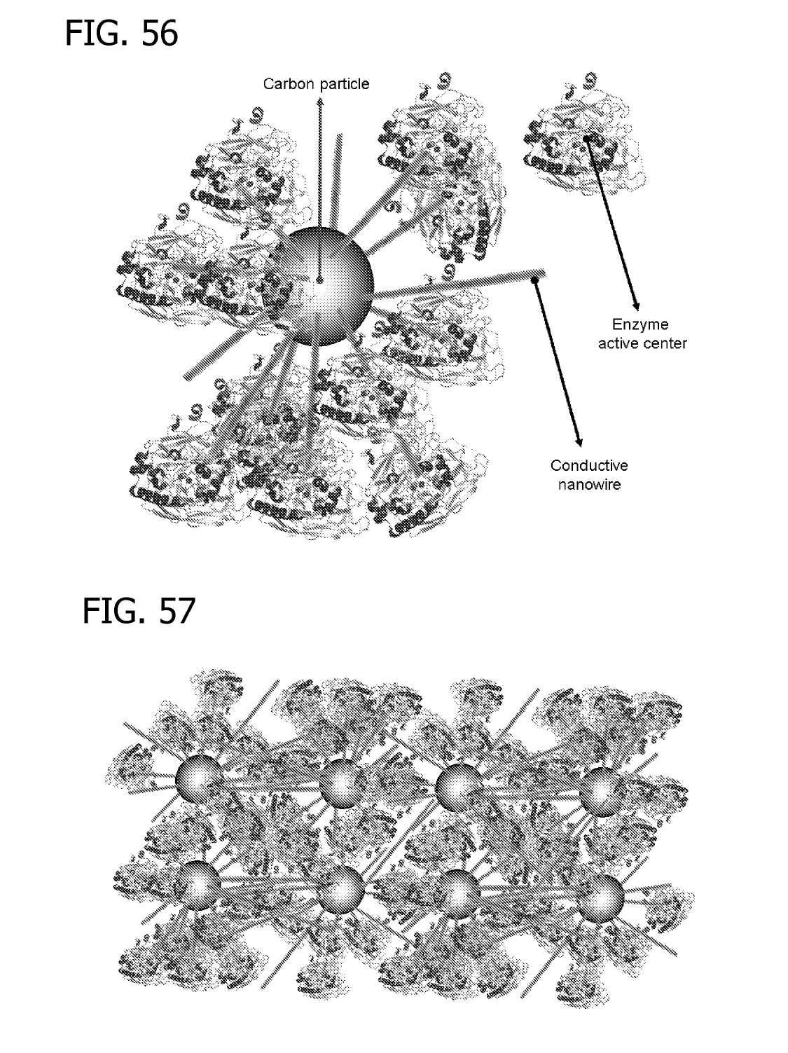

The major properties for tailoring nanowires that improve direct electron transfer in biological systems for biofuel cell applications are (1) electric and ionic conductivity, (2) high aspect ratio to penetrate into the enzyme active center, (3) thermal stability of the precursor material, and (4) electrochemical stability of the precursor material under fuel cell operating conditions. The major functionality of the nanowires is to provide a nano-architectural structure with pre-defined electron transfer pathways interconnecting the redox site within the enzyme and the electrode surface (see FIG. 56 and FIG. 57). FIG. 56 shows a schematic of a nanowire array interacting with enzyme and carbon particles. FIG. 57 shows the interaction of nanowires with each other creating a neural structure-like electron transfer network between carbon particles, which are the major component used in manufacturing the base electrode.

Conductive polymers (such as polyaniline, polypyrrole, polythiophene, etc.) are exemplary polymeric materials for manufacturing nanowires via an oxidative polymerization route. With the appropriate dopant (to improve the conductivity of the polymer) and a first conductive material such as carbon black particles as nucleation sites for nanowire growth, conductive nanowires (e.g., electric and ionic) have been grown and grafted that have the desired dimensions and thermal and electrochemical stability. Some dopants have more than one function, and may impact the nanowire dimension during the synthesis by acting as an internal pore structure or inner diameter modifier.

Nanowires not only can be grown from polymeric materials, but also from oxide, organometallic, and metallic materials under the appropriate synthesis procedures. For a direct electron transfer process, preferably, the polymeric precursor or oxide/organometallic precursors form a conductive nanowire that can transfer electrons efficiently.

Biocathode Nanowires for Enzymatic Oxygen Reduction Reaction

In this section, examples of conductive polymer based nanowires will be given for enzymatic oxygen reduction reaction in biofuel cells, but this invention is not limited only with conductive polymers. Conductive oxide precursors, conductive whiskers precursors, and metallic nanowires that can be grown and grafted onto various base support materials (i.e., carbon particles) and can be utilized to immobilize enzymes besides creating neural-network-like structures that are highly efficient in direct electron processes in biological systems for biofuel cells.

Various polymers can be used as conductive polymers in forming the nanowires, for example, polyaniline, polypyrrole, polyacetylene, leucoemaraldine base, emaraldine base, pernigraniline base form of aniline, polythiophene, poly(p-phenylene), poly(p-phenylene vinyl) and their binary, tertiary, quaternary combinations can be used as precursors to grow conductive nanowires. Chemical and electrochemical polymerization routes can used to polymerize the base monomer to obtain the desired nanowires. To obtain the required dimensions, use of a dopant or dopants is preferred. Various organic sulfonic acids can be used to produce conductive polymeric nanowires. For example, naphthalenesulfonic acids (camphorsulfonic acid, naphthoquinone sulfonic acid, and etc), toluenesulfonic acids (such as pyridinium p-toluenesulfonate, hydroxypyridinium p-toluenesulfonate, tetrabutylammonium p-toluenesulfonate, etc.), multicharged conjugated zwitterionic complexes (containing both positive and negatively charged groups on the same molecule) (such as 1-(3-Sulfopropyl)pyridinium hydroxide inner salt, 3-(1-Pyridinio)-1-propanesulfonate, etc.) can be used as dopants.

For conductive oxide precursors used as nanowires in biofuel cell applications, the oxides should be stable under acidic or basic conditions. For example, oxides of titanium, ruthenium, osmium, iridium, platinum, gold, palladium, rhenium, aluminum, indium-tin oxide (ITO) and their binary, tertiary, quaternary combinations can yield conductive nanowires useful for the purposed described herein. These oxides can be modified for this purpose by either conventional synthesis procedures (chemical vapor deposition, ion-plasma based deposition, etc.) or hydrothermal synthesis protocols.

Examples of conductive whiskers precursors are metal-complexed macrocyclic phtalocyanine or porphine complexes and non-metal complexed various phthalocyanine/porphine species (such as copper phthalocyanine, cobalt phthalocyanine, nickel phthalocyanine, iron phthalocyanine, zinc phthalocyanine, copper porphine, cobalt porphine, ruthenium porphine, palladium porphine, vanadium porphine, zinc porphine, and the like, and combinations thereof. Conductive whiskers can be grown using conventional low and high vacuum based deposition techniques (e.g., evaporative, glow-discharge, gas-phase chemical processes, and liquid-phase chemical formation technologies).

Examples of acid or base stable metallic nanowire precursors include titanium, ruthenium, osmium, iridium, platinum, gold, palladium, rhenium, and their binary, tertiary, or quaternary combinations to manufacture conductive nanowires for direct electron transfer pathways between biological systems and base electrode structure. Metallic nanowires/nanowhiskers can be grown using conventional low and high vacuum based deposition techniques (e.g., evaporative, glow-discharge, gas-phase chemical processes, and liquid-phase chemical formation technologies).

Encapsulated Enzyme Incorporation into Carbon Paste

In many embodiments, the electrode support fabrication is done prior to enzyme deposition; this process results in two distinct layers. With the spray drying procedure described herein, enzyme immobilized carbon particles can be incorporated into carbon pastes without the typical enzyme activity loss from solvent and temperature-induced denaturation to provide an integrated enzyme/carbon electrode structure. As described for other GDL formulations, encapsulated enzyme/carbon diffusion electrode supports can be fabricated in a custom tailored fashion to have desirable characteristics for either the anode or cathode. Preferably, the anode can have a more hydrophilic paste that uses a hydrophilic component as discussed below. Further, the cathode support can have a greater Teflon content to provide higher hydrophobicity while retaining partial hydrophilicity.

Depending on specific requirements for the electrode, various components can provide a range of parameters that can be varied to produce electrodes having desired properties. In particular, the selection of the specific carbon materials (including graphite fibers for rigidity), binder agents, and pore forming agents along with their respective ratios can be varied to provide electrodes with a range of properties. Initial testing illustrated retention of activity and good mechanical stability in half cell configurations.

As with the catalyst ink formulations discussed below, placing high surface area high conductive carbon blacks into the paste formulation provides greater direct electron transfer from the enzyme to the electrode (anode) or the electrode to the enzyme (cathode).

Encapsulated Enzyme Fabrication Procedure

In some embodiments, an enzyme is immobilized on a highly conductive high surface area carbon black such as those given in the table above. Once the enzyme is immobilized, the carbon is dried, and then it is mixed with graphite fibers, carbon blacks, an alcohol solvent, poly(vinylidene fluoride) (PVDF) and/or PTFE binder, and optionally, a hydrophilic agent (i.e., ammonium carbonate, poly(ethylene)glycol, polyvinyl alcohol, or silica gel).

When mixing the carbon paste, it is desirable to first weigh out the desired quantities of all the dry components into a container. The dry components are then mixed together with a mortar and pestle until evenly dispersed. Alcohol is then added in small quantities as the slurry is stirred into an even paste. Too little solvent leaves the paste dry and unworkable, whereas too much solvent will leave the paste soupy and uneven.

The paste is then spread onto expanded metal, typically nickel or stainless steel (any expanded metal can be used), with a shape conforming frame around it to make the desired electrode size. Any type of tool (e.g., spatula, spoon, trowel, etc.) can be used to form the paste and spread it. After spreading, a paper towel is placed around the electrodes and they are mechanically pressed at 5,000 lbs to compress them and to help remove excess solvent.

After the mechanical press step is finished, the shape conforming frame is removed. A Kimwipe is placed on either side of the electrodes, and they are hot pressed at 5,000 lbs at a temperature of 125° C. for 20 seconds.

### Biocatalyst Ink Formulations

As described herein, a method for spray coating immobilized enzyme onto various particles such as carbons, polymers, and metal oxides was developed. This immobilization method allows the preparation of conventional catalyst inks and MEA manufacturing using conventional protocols for regular PEM fuel cell systems. In traditional PEM fuel cells, catalyst inks are painted onto electrode support materials, dried, and hot pressed onto an ion exchange membrane such as Nafion®. When the enzyme is not immobilized, this fabrication method would denature the enzyme due to interaction with the solvent environment or from exposure to heat during hot pressing.

The greater stability of the enzyme in the immobilization material has allowed development of ink formulations that can be directly painted onto commercial electrode supports or electrode supports described herein for use in fuel cell applications. The ink formulation consists of enzyme encapsulated carbon, carbon black filler, and Nafion® solution. The enzyme encapsulated carbon consists of a carbon particle surrounded by enzyme that is entrapped within an immobilization polymer.

Biocathode Catalyst Ink Formulations

Various aspects of the present invention are directed to a particle comprising a core coated with an immobilized enzyme. The core can be a material that provides a support for the immobilized enzyme layer that is coated on the core. The immobilized enzyme layer comprises an enzyme, an enzyme immobilization material, and an optional electron mediator. The immobilized enzyme has an activity of at least about 0.65, 0.7, 0.75, 0.8, 0.85, 0.9, 0.95, or more, relative to its initial activity before immobilization and coating, and/or retains at least about 75% of its initial catalytic activity for at least about 1, 2, 3, 4, 5, 6, 7 days of continuously catalyzing a chemical transformation. In various other embodiments, the enzyme retains at least 75% of its initial catalytic activity for at least 5, 10, 15, 20, 25, 30, 45, 60, 75, 90, 105, 120, 150, 180, 210, 240, 270, 300, 330, 365, 400, 450, 500, 550, 600, 650, 700, 730 days or more. The components of these particles are described in more detail below.

Another of the various aspects of the present invention is a process for preparing a particle coated with an immobilized enzyme. This process comprises mixing a solution comprising an enzyme with a suspension comprising at least one support particle, an immobilization material, and a liquid medium to form a mixture. This mixture is then spray-dried to produce the coated particles.

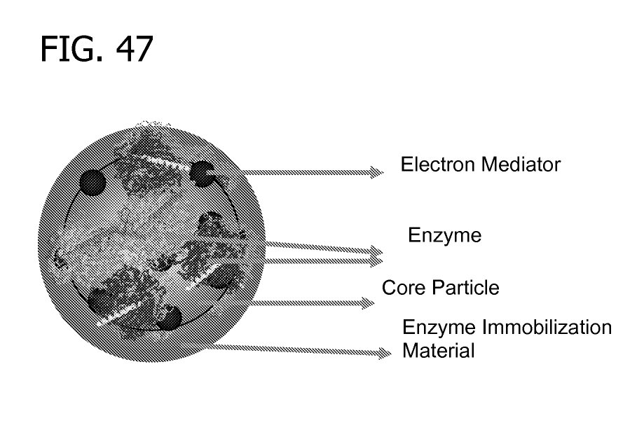

The particle produced can include a core, an optional electron mediator, an enzyme, and an enzyme immobilization material (e.g., polymer matrix) as shown in FIG. 47. The polymer matrix, which functions to stabilize the enzyme and fix it to the support, can be the various enzyme immobilization materials described below. Additionally, various compounds can be added in addition to the enzyme in the matrix that aid enzyme function. For example, electron mediators, cofactors, and coenzymes can be immobilized and will not leach into a liquid upon contact or repeated washes.

In various preferred embodiments, the enzyme is not covalently attached or adsorbed to the core. Further, preferably, the enzyme does not leach from the enzyme immobilization material into a liquid medium that the immobilized enzyme layer contacts. Typically, the immobilized enzyme particles comprise from about 0.1 wt. % to about 25 wt. % of the core and about 0.1 wt. % to about 70 wt. % of the coating and the coating comprises from about 0.1 wt. % to about 29 wt. % of the enzyme, about 0.1 wt. % to about 43 wt. % of the enzyme immobilization material, up to about 29 wt. % of the electron mediator. Typically, the total weight percent of the enzyme and the electron mediator can be up to 57 wt. % of the coating.

Core Component

The core is any particle that provides a support for the immobilized enzyme layer and that can be spray-dried. The core particle can be, for example, a polymer particle, a carbon particle, a zeolite particle, a metal particle, a ceramic particle, a metal oxide particle, or a combination thereof. In some embodiments, the core particle is an inert core particle. In various embodiments, the core particle is not a polymer particle. Preferred core particles do not adversely affect the stability of the enzyme or the chemical transformation involving the enzyme. In some embodiments, the core particles have an average diameter from about 200 nm to about 100 nm, depending upon the intended use of the particles when coated with the immobilized enzyme.

Methods of Preparing Coated Particles

The coated particles are prepared by mixing a solution comprising an enzyme or organelle with a suspension comprising at least one core particle, an immobilization material, and a liquid medium and spray-drying the resulting mixture. The solution, suspension, and spray-drying step are described in more detail below.

An enzyme solution comprising the enzyme and a solvent is used in the coating procedure. Alternatively, an organelle solution comprising the organelle and a solvent is used in the coating procedure. The enzyme is combined with a solvent and mixed until a solution is formed. Acceptable enzymes and organelles are described in more detail above. The solvent can be an aqueous solution, particularly a buffer solution, such as an acetate buffer or phosphate buffer. The buffer pH is designed to provide an acceptable pH for the particular enzyme or organelle to be immobilized. Also, in various embodiments, the enzyme solution can contain an electron mediator as described above.

A suspension is prepared by combining a core particle, the desired immobilization material and a liquid medium. Exemplary core particles and immobilization materials are described above. The liquid medium can be a solvent or buffer, such as an acetate buffer or phosphate buffer. When a buffer is used as the liquid medium, the buffer pH is selected to provide an acceptable pH for the particular enzyme or organelle to be immobilized and coated.

Once the enzyme or organelle solution and the suspension are prepared, they are combined and mixed well. The resulting mixture is then dried. A preferred drying method is spray-drying because the drying also results in coating of the core particles with the immobilized enzyme layer. Conventional spray drying techniques can be used in the methods of the invention. Alternatives to spray-drying include other conventional processes for forming coated particles, such as fluidized bed granulation, spray dry granulation, rotogranulation, fluidized bed/spray drying granulation, extrusion and spheronization.

In some of the various embodiments, the solution comprises from about 0.1 wt. % to about 15 wt. % of the enzyme and about 85 wt. % to about 99.1 wt. % of a solvent, and the suspension comprises from about 0.1 wt. % to about 50 wt. % of the core particles, from about 4 wt. % to about 10 wt. % of the enzyme immobilization material, and from about 50 wt. % to about 75 wt. % of the liquid medium. Other ways to make the casting solution include mixing the particles and the enzyme or organelle together in buffer to form a suspension and then adding solubilized immobilization material to complete the mixture or by combining all of the materials at once to form a suspension.

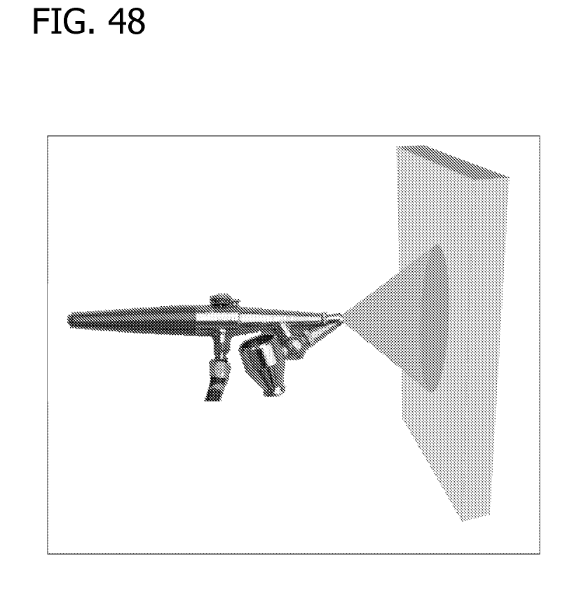

In various preferred embodiments, a mixture of enzyme, enzyme immobilization material, and optionally, electron mediators can be coated onto supporting particles using a spray coating/drying technique. For example, an airbrush (e.g., Paasche VL series) can be used to generate an aerosol of the components of the mixture and propel them towards a target. See FIG. 48. The aerosol is generated using compressed nitrogen gas regulated at about 25 psi. The mixture is airbrushed onto a surface such as a polycarbonate shield from a distance of about 40 cm from the tip of the airbrush to the shield. The airbrush can be moved in a raster pattern while moving vertically down the polycarbonate target in a zigzag pattern applying the casting solution. This procedure is used to minimize the coating thickness on the shield and minimize the particle-particle interaction while drying. The casting solution is allowed to dry on the shield for about 20 minutes before being collected by a large spatula/scraper.

Bioanode Ink Formulations

When preparing an anode ink, the same considerations as discussed and plotted above need to be taken into account. Instead of shuttling electrons to the enzyme they need to be shuttled away from the enzyme. Electron mediator choices would be different because of this, but carbon black choices would likely be similar. In order to observe direct electron transfer, carbon black filler is preferably used.

Incorporation of the electron mediator into the ink formulation for the bioanode helps alleviate the need for carbon black filler as demonstrated by Examples 34 and 35. Hexamine ruthenium(III) was used for the example but any electron mediator with a desirable electron transfer potential can be used. For example, electron mediators such as nickelocene, ferrocene, cobalt bipyridine, and ferricyanide have been used.

TBAB Polymer based GDE

The MEA was fabricated by hot pressing the platinum anode catalyst and the laccase immobilized cathode onto a solid proton-conducting electrolyte membrane. The membrane used was a 0.005 inch thick Nafion® Membrane N115 (from E.I. du Pont de Nemours). Kapton polyimide film is then covered above and below the MEA because of its durability at high temperature and also to prevent the MEA from sticking to the steel plates. The kapton covered MEA of 5 cm² was formed by hot pressing both anode and cathode electrodes simultaneously between the Nafion® membrane at temperature of 125° C. at 3000 lbs of pressure using the two steel plates. A schematic of the press package for this MEA is shown in FIG. 66.

### Chitosan Polymer Based GDE

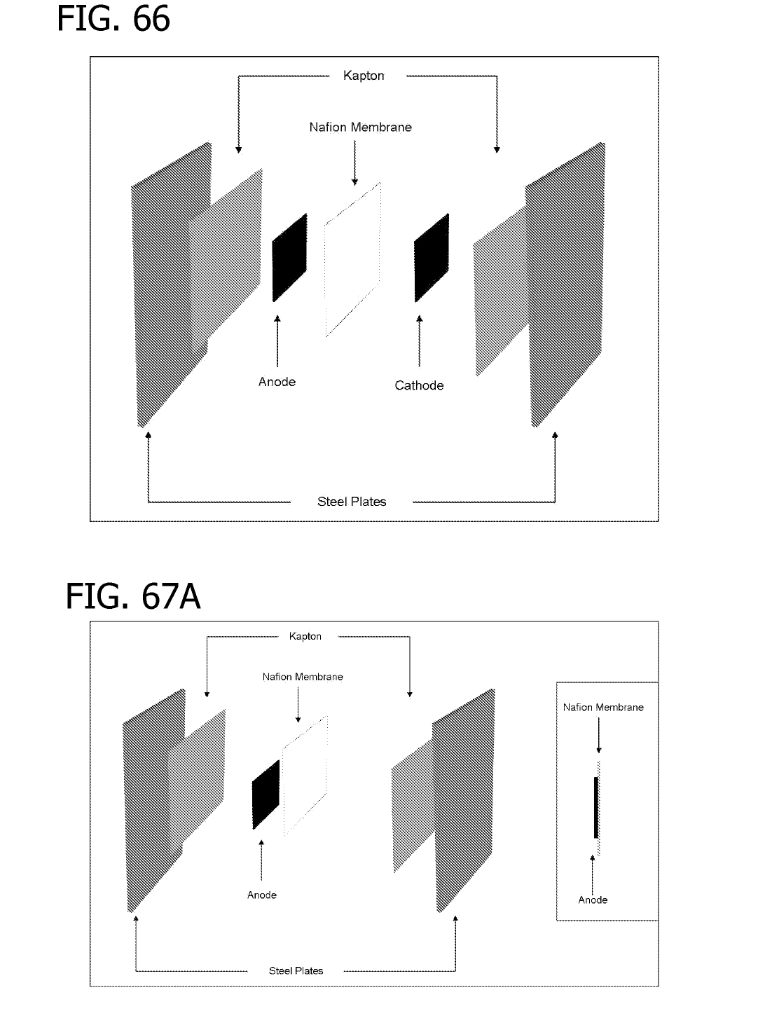

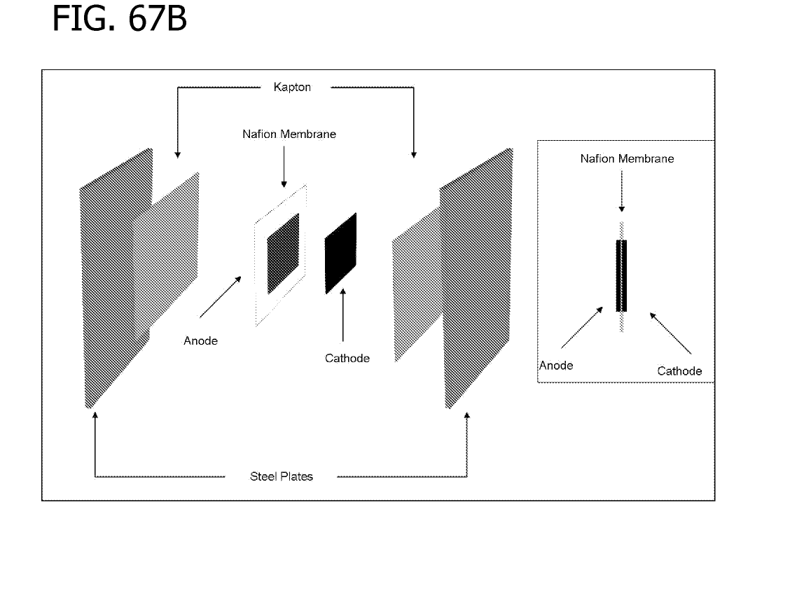

The MEA was fabricated in a two step process by first pressing the platinum anode catalyst and then pressing the laccase immobilized cathode against each face of a solid proton-conducting electrolyte. The membrane used was a 5 mil thick Nafion® Membrane N115 (from E.I. du Pont de Nemours). Kapton polyimide film was then covered above and below the MEA because of its durability at high temperature and also to prevent the MEA from sticking to the steel plates. For the first step only the platinum anode electrode was hot pressed against the Nafion® membrane at temperature of 125° C. at 3000 lbs of pressure. A schematic of the press package the first step is shown in FIG. 67A. The second step is the hot pressing of the chitosan immobilized laccase cathode electrode at temperature of 85° C. at 3000 lbs of pressure. A schematic of the press package the first step is shown in FIG. 67B. This two step process is necessary due to the thermal decomposition of chitosan at temperatures above 85° C.

### Electronic Controller and Supplemental Power Circuit

In the embodiment shown in the drawings, the fuel cell device 1 comprises a “stack” of eight fuel cells, each cell including a fuel reservoir 41 and associated anode and cathode assemblies. However, it will be understood that the number of such cells can vary from one to any number greater than one.

FIG. 14 illustrates an embodiment of device 1 in block diagram form. As shown, one or more fuel cells 321 are electrically connected to the electronic controller 71 via line 323. The cells 321 may be stacked as described above. For example, line 323 comprises a flat ribbon cable connector or the like providing 16 electrical connections to controller 71 for a stack of eight cells. The electronic controller 71 controls the output of each cell 321 according to a desired mode of operation. In a first defined operating mode, the cells 321 are electrically connected in series and controller 71 switches them on and off together at a predetermined duty cycle, such as 25% at 1000 Hz. Advantageously, operating cells 321 according to the predetermined duty cycle improves fuel cell performance. In particular, cycling the cells 321 on and off improves stability for long term use as measured by current decay at a set voltage. Moreover, cycling cells 321 in this manner improves the power output of the device 1 by allowing time for cells 321 to go from load to an open circuit condition. In the open circuit condition, cells 321 have a larger reactance available to the catalyst layer without being oxidized, which results in a larger power output when subsequently under load.

In a second defined mode of operation, controller 71 controls the output of cells 321 so that one cell is disconnected from load 5 while the remaining cells are connected to load 5 (e.g., one cell off and seven cells on for an eight cell stack). In this embodiment, allowing each cell 321 to periodically be in an open circuit condition while the remaining cells are under load also improves stability and power output and, thus, improves fuel cell performance.

As described above, the supplemental power circuit 81 provides power to supplement the normal output of device 1, as needed. This is particularly useful during conditions in which load 5 draws a greater amount of current, such as when starting, or powering up, an electronic device. In the illustrated embodiment, supplemental power circuit 81 is implemented as part of controller 71. The controller 71 monitors the voltage output of cells 321 and executes a comparator for comparing the voltage output to a minimum output reference voltage, such as 1.5 V. If the monitored voltage output falls below this threshold, controller 71 switches on a battery assist, or hybrid, circuit for supplementing the output power. In this embodiment, a supplemental power source, such as a battery 325 (e.g., a rechargeable lithium ion battery), provides power to controller 71 via line 327 to supplement the output of cells 321. Although illustrated as part of controller 71, it is to be understood that supplemental power circuit 81 may be a separate circuit connected to the battery 325 and controller 71.

In a third defined operating mode, controller 71 disconnects all of the fuel cells 321 from the load 5. The third mode may be used for recharging battery 325 with the output voltage of cells 321.

FIG. 14 also shows a boost circuit 331 for regulating the output of cells 321 (or the hybrid output of cells 321 and battery 325) provided via line 329. Regulated in this manner, fuel cell device 1 supplies a relatively constant voltage at its output, generally designated 333 (see also FIGS. 2 and 3), that can be used on a variety of load specifications. It is to be understood that the output 333 may be hard-wired to the load 5 and connected to fuel cell device 1 via a plug or the like, or vice versa. In the illustrated embodiment, fuel cell devise 1 includes a capacitor 335, which charges when the system is “dormant.”

Advantageously, the capacitor 335 provides supplemental power in addition to, or instead of, battery 325. As an example, the boost circuit 331 comprises a step up DC-DC converter circuit that supplies a regulated 5 V on its output to the load 5.

Referring now to FIG. 15, a block diagram illustrates aspects of controller 71 in greater detail. As shown, a processor, such as a first microprocessor 337, controls a first switch circuit 339 that receives the output of cells 321. The microprocessor 337 executes computer-executable instructions for operating the cells 321 according to the desired modes of operation. Depending on the mode, the switch circuit 339 is responsive to microprocessor 337 for turning the output of each of the individual cells 321 on or off In one embodiment, switch circuit 339 comprises a plurality of single pole double throw switches, each connected to one of the cells 321 for selectively connecting it's output to (or disconnecting it's output from) the load 5. The supplemental power circuit 81 comprises a second microprocessor 341 and a second switch circuit, generally designated 343. This second microprocessor 341 monitors the voltage output of cells 321 (at line 329 from switch circuit 339) and compares the voltage output to the minimum output reference voltage. If the monitored voltage output falls below the minimum threshold, microprocessor 341 causes the switch circuit 343 to electrically connect the battery 325 to the load 5 and, thus, supplement the output of cells 321. Several microprocessors, including, for example, one of the CY8C29XXX family of Programmable System on Chip mixed signal array controller devices available from Cypress Semiconductor Corporation is suitable for use as microprocessor 337 and one of the CY8C21XXX family of Programmable System on Chip mixed signal array controller devices available from Cypress Semiconductor Corporation is suitable for use as microprocessor 341. Moreover, it is to be understood that the control functions of monitoring and comparing output voltages, controlling switch circuit 339, controlling switch circuit 343, and so forth, may be performed by a single processor, such as either microprocessor 337 or microprocessor 341.

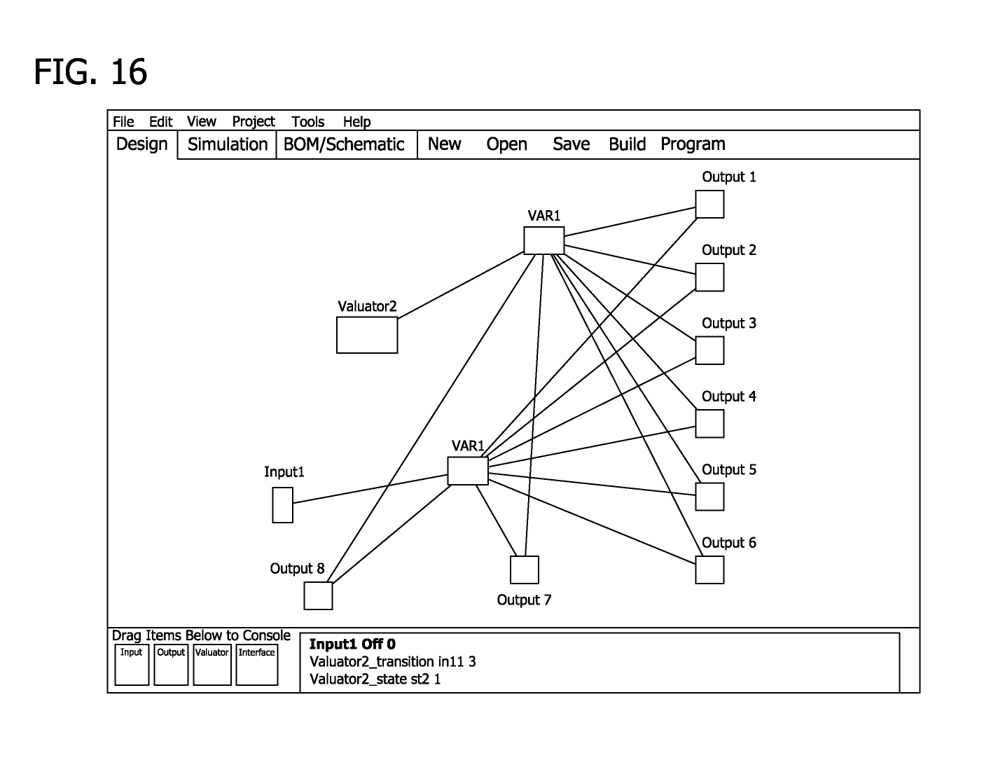

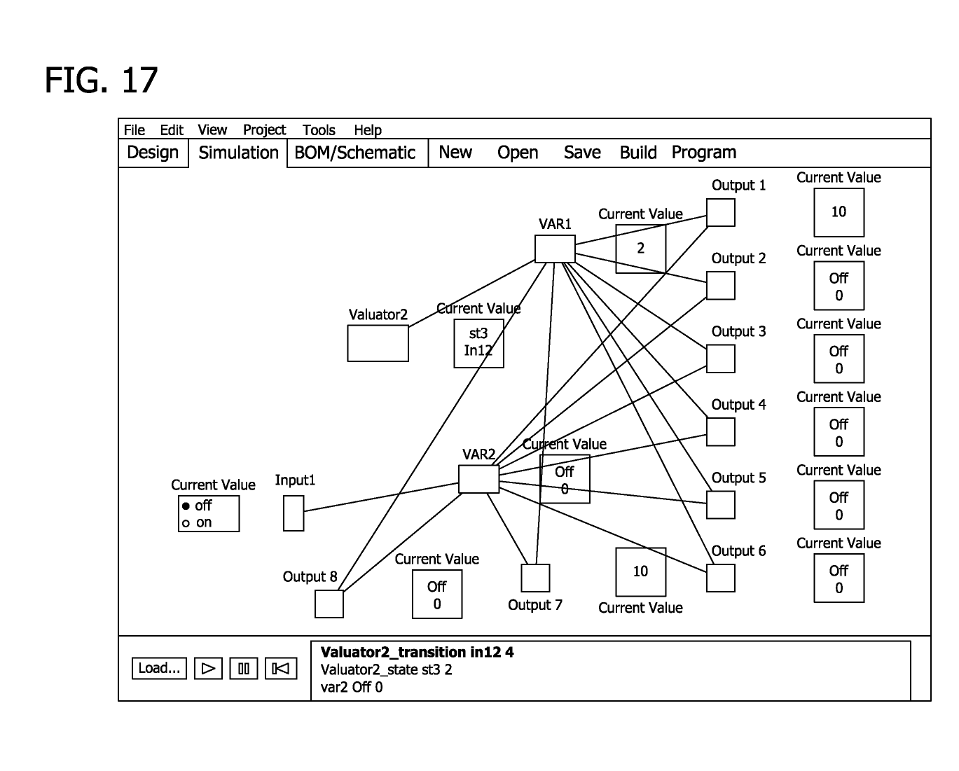

In one embodiment, a computer (not shown) executes software for use in programming microprocessor 337 to control switch circuit 339 according to one of the biofuel cell device's operating modes. FIGS. 16 and 17 illustrate an exemplary user interface displayed on the computer for receiving user input to design and simulate the modes for an eight cell biofuel cell device. In FIG. 16, Outputs 1 to 8 represent the state of each of the cells of the fuel cell device (e.g., cells 321 of device 1). Input 1 represents an external push button switch (not shown) for changing among the various operating modes. VAR2 is responsive to Input 1 and represents the device's operating mode. For example, pushing Input 1 until the VAR2 value increments to 1 initiates the first mode. In this mode, Output 1 is set to the predetermined duty cycle (e.g., 25% at 1000 Hz). Because cells 321 are electrically connected in series, all of the cells 321 turn on and off together at the predetermined duty cycle. The microprocessor 337 controls switch circuit 339 in the second mode when VAR2 has a value of 0. When the value of VAR2 increments to 0, or off, Output 1 is set to another predetermined duty cycle (e.g., 10% at 1000 Hz). In addition, VAR 1 turns on and initiates a phase shift. The phase shift provides sufficient delay when operating at the 10% duty cycle so that seven of the eight cells 321 in the illustrated embodiment are on while one of the eight cells 321 is off. The particular cell 321 that is off rotates among the total number of cells so that each cell is off for an approximately equal amount of time. The user interface shown in FIG. 17 corresponds to a simulation of this second operating mode in which VAR2 is off and VAR1 is on. In the third operating mode, the VAR2 value increments to a value of 2, which turns off all of the Outputs 1 to 8. The third mode may be used for recharging battery 325 with the output voltage of cells 321.

The operating modes described above, including the duty cycles, are exemplary and those skilled in the art will recognize that other operating modes may be defined without deviating from the scope of the invention depending on the requirements of load 5 and the physical construction (e.g., the number of cells) of fuel cell device 1.

Referring now to FIG. 18, an electronics assembly, generally designated 345 (see also FIG. 3), includes a first printed circuit board 347 on which electronic controller 71, including supplemental power circuit 81, are mounted. In addition, the electronics assembly 345 includes a second printed circuit board 349 providing the electrical connections for the battery 325. A metal receiver 353 mounted on the second printed circuit board 349 forms a pocket or receptacle in which battery 325 rests when installed. In the illustrated embodiment, receiver 353 has one or more spring members 355 that are biased against the battery 325 to retain the battery in position within the receiver and to form an electrical connection with one of the battery's terminals. A conductive pad (not shown) on printed circuit board 349 provides the electrical connection for the other battery terminal A wire (not shown) or other conductive means electrically connects the first and second printed circuit boards 347, 349 to connect battery 325 to controller 71. Additionally, a plurality of wires, generally designated 357, or other conductive means electrically connect controller 71 to the fuel cells 321.

### Housing

The housing 91 is desirably of multi-part construction to facilitate assembly and disassembly of the fuel cell device 1. In one embodiment (FIGS. 2 and 3), the housing comprises first and second parts 91A, 91B which, when combined, form an enclosure having a volume sufficient to snugly receive the stacked components of the fuel cell device 1. The two parts are secured 91A, 91B together in a releasable manner by one or more fasteners (e.g., hex head bolts 275) or other mechanical means. A gasket or other sealing device (not shown) seals the joint between the two parts 91A, 91B when they are secured together. The housing 91 has at least one opening 277 for allowing delivery of fuel fluid from the fuel source 7 to the inlet 29 of the manifold and for allowing delivery of fluid from the outlet 33 of the manifold to the waste destination 9. The walls of the housing 91 have holes 281 to permit air flow to and from the interior of the housing for ventilating and cooling components inside the housing. The housing may be molded, machined or otherwise fabricated from a suitable material such as acrylic.

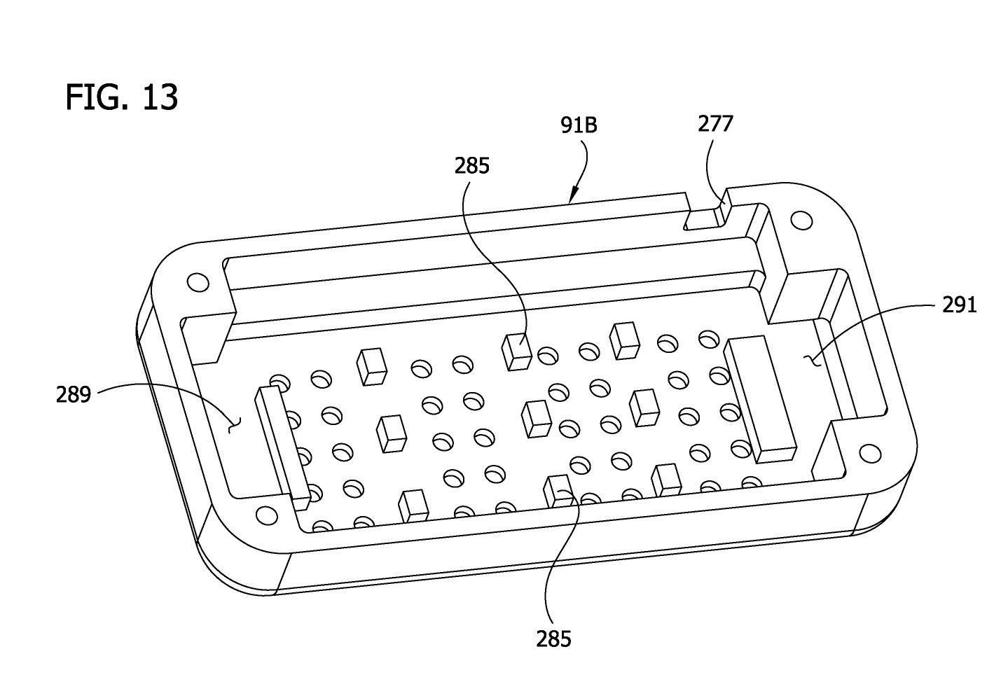

As illustrated in FIGS. 3 and 13, projections 285 on the inside surfaces of the housing parts 91A, 91B provide support for the electrode structure of the fuel cell device, i.e., the fuel manifold 15, cathode assemblies 51, 53 and anode assemblies 45, 47, to provide proper support and positioning of these components inside of the housing. Some of these projections 285 may also define locations, e.g., compartments 289, 291, for receiving the electronic controller 71 and power circuit 81. Alternatively or in combination, recesses may be formed in the interior surfaces of the housing to receive these components.

### Operation of Device

In operation, fuel is delivered to the fuel cell device 1 from the source 9 by suitable means (e.g., a syringe or pump) until the fuel reservoirs 41 are filled and the fuel fluid contacts respective anodes 157. As in a standard electrochemical cell, the anode is the site for an oxidation reaction of a fuel fluid with a concurrent release of electrons and protons. The electrons are directed from the anode through an electrical connector to some power consuming device. The protons move through the fuel fluid and polyelectrolyte membrane to the cathode. The electrons move through the device to another electrical connector, which transports the electrons to the biofuel cell's cathode where the electrons are used along with the protons to reduce an oxidant (in this case oxygen from air) to produce water. In this manner, the biofuel cell of the present invention acts as an energy source (electricity) for an electrical load external thereto. To facilitate the fuel fluid's redox reactions, the electrodes comprise a current collector, a gas diffusion layer (an electron conductor), optionally an electron mediator, optionally an electrocatalyst for the electron mediator, an enzyme, and an enzyme immobilization material.

The electron mediator is a compound that can accept electrons or donate electrons. In a presently preferred biofuel cell, the oxidized form of the electron mediator reacts with the fuel fluid and the enzyme to produce the oxidized form of the fuel fluid and the reduced form of the electron mediator at the bioanode. Subsequently or concurrently, the reduced form of the electron mediator reacts with the oxidized form of the electrocatalyst to produce the oxidized form of the electron mediator and the reduced form of the electrocatalyst. The reduced form of the electrocatalyst is then oxidized at the bioanode and produces electrons to generate electricity. The redox reactions at the bioanode, except the oxidation of the fuel fluid, can be reversible, so the enzyme, electron mediator and electrocatalyst are not consumed. Optionally, these redox reactions can be irreversible if an electron mediator and/or an electrocatalyst is added to provide additional reactant.

Alternatively, an electron conductor and an enzyme can be used wherein an electron mediator in contact with the bioanode is able to transfer electrons between its oxidized and reduced forms at unmodified electrodes. If the electron mediator is able to transfer electrons between its oxidized and reduced forms at an unmodified bioanode, the subsequent reaction between the electrocatalyst and the electron mediator is not necessary and the electron mediator itself is oxidized at the bioanode to produce electrons and thus, electricity.

At the cathode, electrons originating from the bioanode flow into the cathode's current collector and gas diffusion layer. There, the electrons contact a catalyst capable of gaining electrons from the gas diffusion layer and reacting with an oxidant to produce an oxidized form of the catalyst and water.

### Alternative Fuel Cell Embodiment

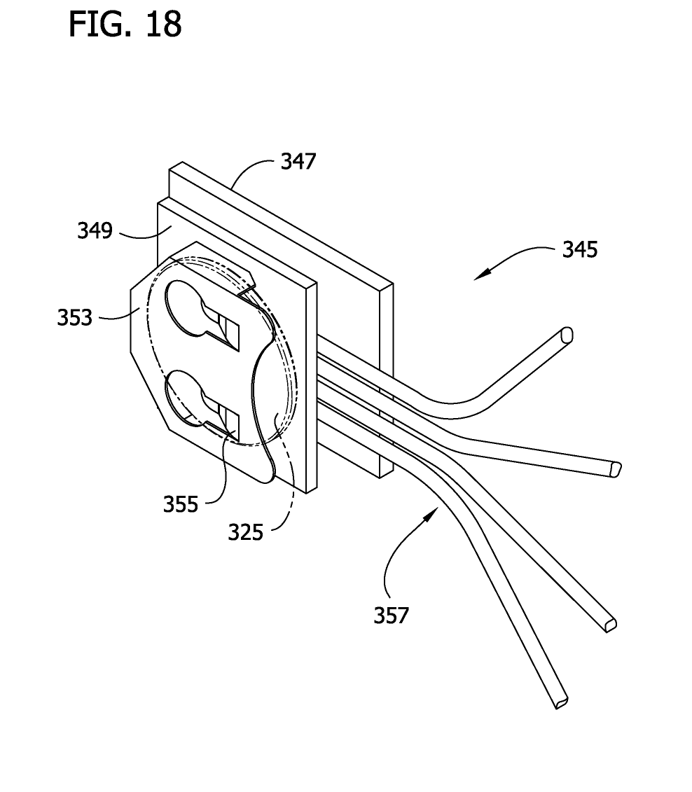

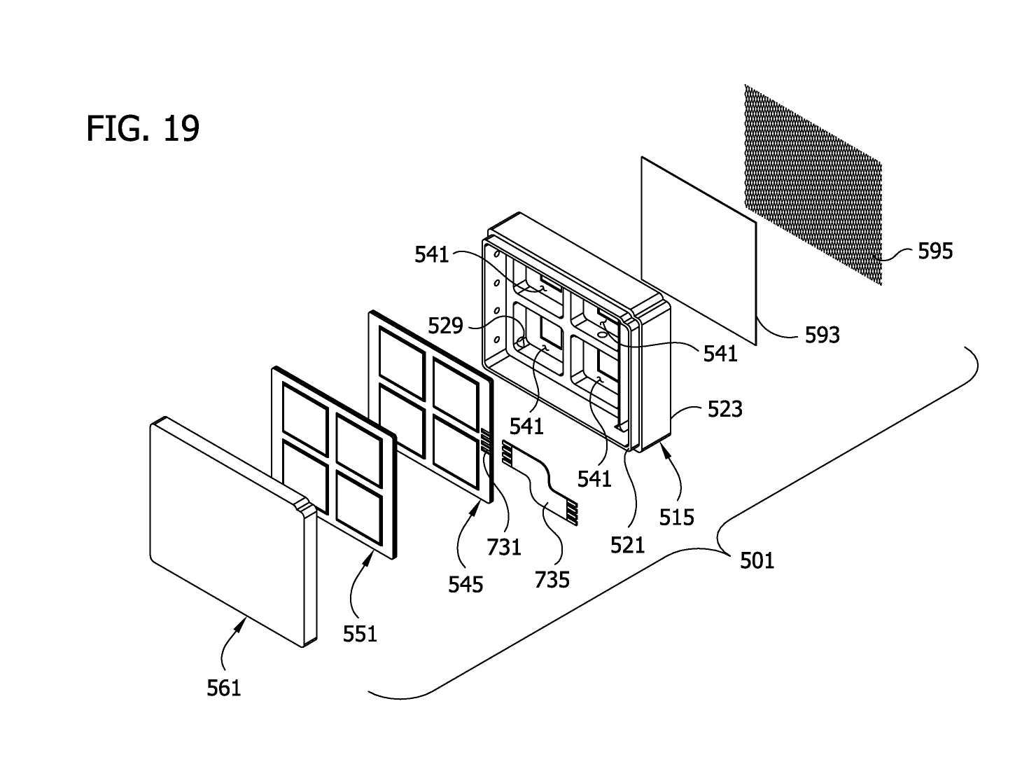

A fuel cell device of a second embodiment of the present invention is designated in its entirety by the reference number 501 in FIG. 19. The fuel cell device 501 is generally similar to the embodiment described above except for some features that will be described in further detail below. Portions of the device 501 of the second embodiment that are similar to features of the device 1 of the first embodiment will be referred to using reference numbers similar to the first embodiment but incremented by 500.

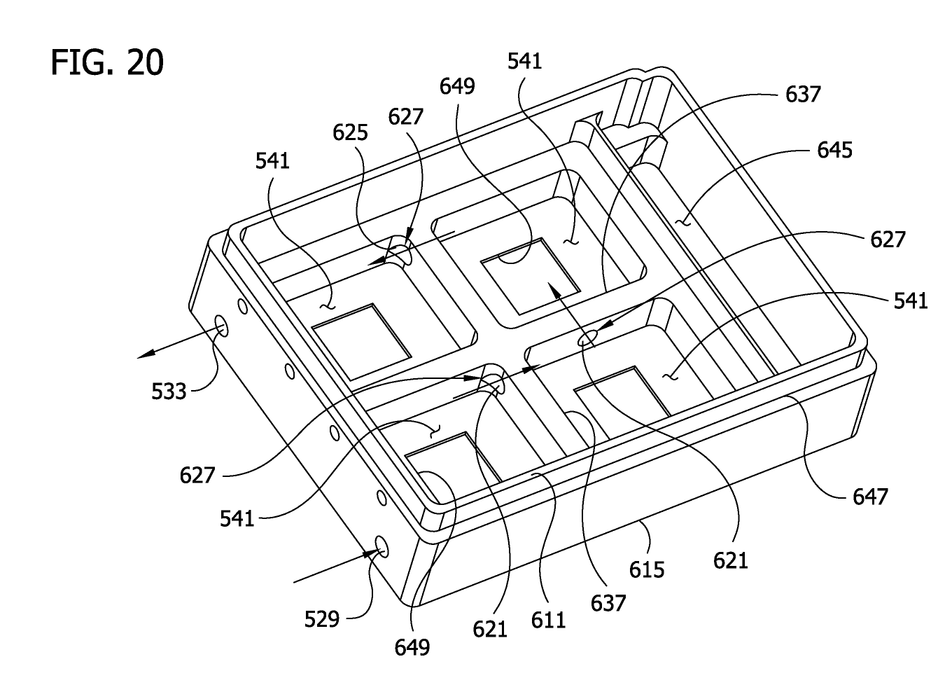

The fuel cell device 501 of FIG. 19 is separated to illustrate the various components of the device 501. The device 501 generally comprises a fuel manifold 515 having a front side 521, a back side 523, an inlet 529 for receiving fuel from a fuel source (not shown) and an outlet 533 (FIG. 20) for exhausting fuel from the manifold to a waste destination (not show). The manifold 515 has four fuel reservoirs, each designated 541. The fuel cell device 501 also includes an anode assembly, generally designated 545, for reacting with fuel in the fuel reservoirs 541, and a cathode assembly, generally designated 551 adjacent a lid or cover 561. An electronic controller (not shown) is provided for controlling operation of the device 501, and a supplemental power circuit (not shown) is included for providing power to supplement the normal output of the fuel cells, as needed. A permeable membrane 593 and a protective screen 595 are provided on the back side 523 of the device 501. The components described above provide a fuel cell device 501 presenting a self-contained, compact unit.

As illustrated in FIG. 20, the fuel manifold 515 has an inlet 529 permitting fuel fluid to enter the manifold from a fuel source (not shown) and an outlet 533 permitting fuel fluid to exit the manifold to a waste destination (not shown). The inlet 529 and outlet 533 may include tubing nipples similar to those of the manifold 15 of the first embodiment illustrated in FIG. 4. As further illustrated in FIG. 20, the manifold 515 has four fuel reservoirs 541. The manifold 515 comprises a body or block 601 of suitable dielectric material having a top 605, a bottom 607, opposite ends 609, a front face 611 and a back face 615. The block 601 may be made of polymer-based or non-polymer-based materials that are chemically insert to the fuel being used. In one embodiment, the block 601 is made of acrylic. The block 601 is formed (e.g., molded, machined, etc.) to have a rectangular shape and is preferably constructed from a single one-piece member. The fuel reservoirs 541 are defined by cavities (also designated 541) in the front face 611 of the block. In an alternative embodiment (not shown), the cavities defining the reservoirs may be formed in the front face 611 and back face 615 of the block 601. Although the cavities 541 may have other volumes without departing from the scope of the present invention, in one embodiment each cavity has a volume of about 1.74 cubic centimeters. Fuel enters each fuel reservoir 541 through an inlet port 621 and exits the same reservoir through an outlet port 625. Each inlet port 621 and corresponding outlet port 625 are positioned on opposite ends of passages, generally designated by 627, extending through interior walls 637 separating the cavities 541. As shown in FIG. 20, the elevation of each outlet port 625 is at least as high as a top of each inlet port 621. This arrangement allows for the complete filling of the fuel reservoirs 541 without the air bubbles coming into contact with the anode assemblies and cathode assemblies as will be described later. A check valve (not shown) is provided in each passage 627 between the outlet port 625 of one reservoir 541 and the inlet port 621 of the next reservoir to prevent the back-flow of fuel from one reservoir to another thereby breaking ionic communication between the cells and preventing shorts. Although other check valves may be used without departing from the scope of the present invention, in one embodiment each check valve is a stainless steel check valve having a 0 psi cracking pressure press fit into a 2.5 mm diameter passage.

The manifold includes a compartment 645 for receiving the electronic controller and power circuit. As will be appreciated by those skilled in the art, a lip 647 is formed around the front face 611 of the block 601 for engaging the lid 561. Openings 649 are provided adjacent a back side of each cavity 541 to exhaust carbon dioxide generated during the reaction. Air holes are also provided in the manifold 515 to permit air to enter the fuel cell. As other features of the fuel manifold 515 of the second embodiment are similar to those of the first embodiment, they will not be described in further detail.

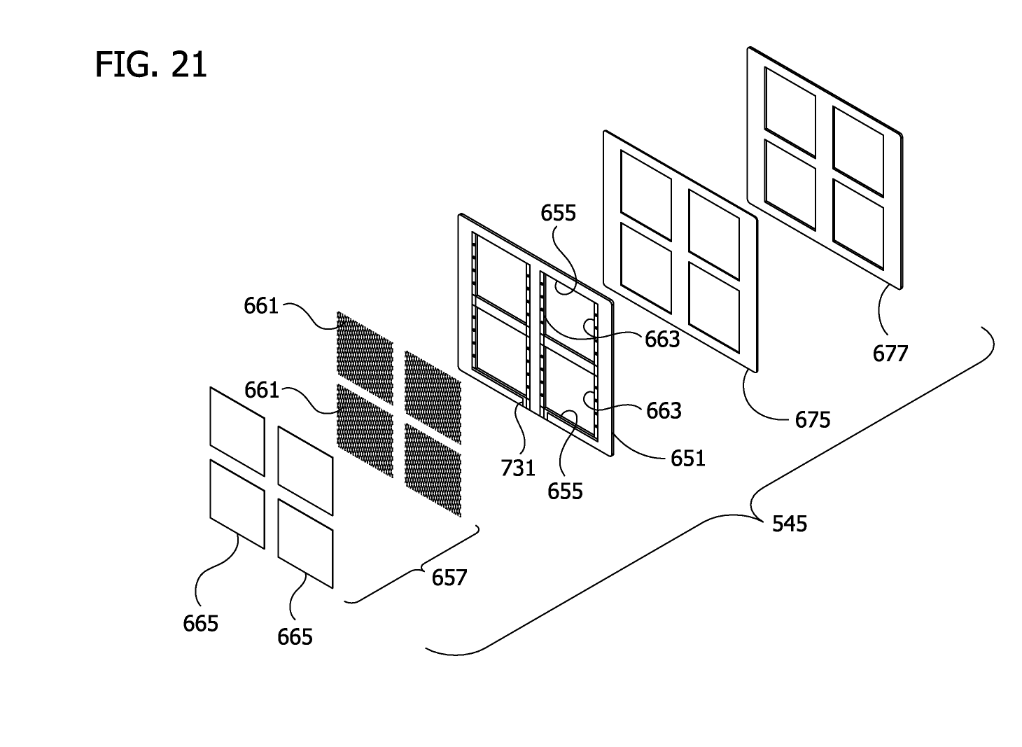

FIG. 21, illustrates the anode assembly 545, which reacts with fuel in the fuel reservoir 541 and the cathode assembly 551 adjacent the anode assembly. The anode assembly 545 includes a printed circuit board frame 651. The frame 651 has a plurality of openings 655 configured and arranged to match the configuration and arrangement of fuel reservoirs 541 in the front face 611 of the manifold 615. The anode assembly 545 also includes a number of anodes, each generally designated 657, held by the frame 651 in the frame openings 655, one anode per frame opening. Each anode 657 comprises a current collector 661 secured in a respective frame opening 655. In one embodiment, the current collector 661 comprises two gold plated stainless steel mesh panels spot welded together. One panel is sized to precisely fit in the frame opening 655 and the other panel is sized to overlap the opening. The collectors 661 are spot welded to pads 663 printed on opposite margins of the openings 655. When the collectors 661 are spot welded to the pads 663, it is important that the welding parameters be set so the welder does not arc. Using a CD250DP Sunspot-b dual pulse spot welders, the following parameters have found to provide acceptable results: energy level—14; pulse 1—12; pulse 2—45; and welder energy—14. These parameters provide a mechanically stable weld without damaging the current collectors 661.

Each anode 657 also includes a gas diffusion layer 665 on the back face of the current collector 661. This diffusion layer 665 may be a carbon paste structure comprising dry components of Monarch 1400 carbon black (Cabot) and Chemsorb 1505 G5 porous, impregnated steam activated carbon (C*Chem), and wet components of Quick Set 2 part epoxy (The Original Super Glue Corp.) dissolved in acetone and 60% polytetrafluoroethylene (PTFE) dispersion in water (Sigma). The dry components are ground in a food grinder and the wet components are mixed with an ultrasonic homogenizer, then the dry and wet components are combined and mixed with a putty knife until the mixture is the consistency of toothpaste. A catalyst layer (not shown) is then added to the gas diffusion layer 665 by applying a cast mixture of enzyme in buffer solution and tetrabutylammonium-modified Nafion® ionomer. The catalyst layer is allowed to dry before joining it to the anode assembly. In preferred embodiments, the enzyme used in the catalyst layer is pyrroloquinoline quinone-dependent alcohol dehydrogenase (PQQ-ADH). A layer of hot melt 675 and a vinyl frame 677 are applied to the anode as shown.

Each cathode assembly 551 is constructed using a similar method as described above with respect to the anode assembly 545. The cathode assembly 551 also includes a layered catalyst structure on the back face of its current collector. This layered catalyst structure comprises a gas diffusion layer, a catalyst layer, and a polyelectrolyte membrane (Nafion®). Upon assembly, this layered catalyst structure is affixed to the back face of the current collector. In a particular embodiment, the catalyst layered structure is prepared by applying an ink comprising a platinum black catalyst and Nafion® ionomer to one side of the gas diffusion layer (e.g., E-Tek as LT2500W Low Temperature Elat with microporous layer on either side). Once the ink comprising the catalyst has dried, the catalyst layered structure is assembled by placing the gas diffusion layer on top of the current collector with platinum black catalyst side up, then placing the polyelectrolyte membrane (e.g., Nafion®) on top of the gas diffusion and catalyst layers. This assembly is soaked with water and then fixed together by hot pressing, resulting in a stand alone cathode fixture (e.g., at 125° C. at 3000 pounds for 35 seconds. The polyelectrolyte membrane (e.g., Nafion® ionomer) is impermeable to the fuel fluid, but is able to conduct electrons and protons.

Once the anode assembly 545 and the cathode assembly 551 are prepared as described above, they are assembled together by coating connector pads 731 on each of the printed circuit board frames 651 with solder paste or ordinary spooled solder. An eight conductor ribbon cable 735 is then tacked down to one board with about 0.020 inch of bare conductor hanging off the edge of the board. The second board is then aligned with the first board and cable and held in place with firm pressure. Each conductor is then touched with a soldering iron to reflow/melt the solder paste/solder on the upper and lower boards making good electrical contact between the boards and the cable. Continuity is then checked between the far end of the flat flex cable and each of the individual mounting pads for the expanded metal on the frames. Shorts between the conductors are also checked. The assembly/conductors are reflowed as needed until proper operation is achieved. The connector pads 731 are offset from center so that the pads of one board are not aligned with the pads of the other board but so they all align with one conductor of the cable 735.

The solder mask is removed prior to assembly in order to assure a leak-free stack. The solder mask removal may be accomplished by soaking the printed circuit boards in a dichloromethane solution until the entire solder mask is loose and easily removable. Once the solder mask is removed, the circuit boards are taken out of the dichloromethane solution and rinsed thoroughly with dichloromethane. The boards are then allowed to dry while the other components necessary are prepared.

After the anode and cathode assemblies 545, 551, respectively, are assembled and soldered together, they are pressed (e.g., at 125° C. and 1000 pounds for about 10 to about 20 seconds). The completed stack is trimmed as needed and sealed to the casing by adhesive bonding (e.g., with hot melt and pressing at 2000 pounds until cooled). Once cooled, the anode reactant can be added to the fuel reservoirs.

The carbon dioxide permeable membrane 593 covers the openings 649 at the back sides of the reservoirs 541. The membrane 593 selectively permits passage of carbon dioxide to remove gas generated in the reservoirs 541 to remove the gas from reservoirs without allowing unreacted fuel to exit the reservoirs. Examples of polymer membranes that are selectively carbon dioxide permeable are silicone, styrenic thermoplastic elastomers, polyamide based thermoplastic elastomers, polybutadiene based thermoplastic elastomers, EPDM rubber based thermoplastic elastomers. Due to very high selective carbon dioxide permeability, during the fuel cell operation the generated carbon dioxide gas vents through porous structure while acting as a barrier for alcohol fuel.

### Applications and Uses of Coated Particles

Particles coated with immobilized enzymes can be used as catalysts for a variety of chemical transformations. Enzymes can be immobilized in enzyme immobilization materials and coated on particles using processes described herein and deposited on various substrates. These immobilized enzyme particles can then contact reaction mixtures and catalyze the desired chemical transformation. The particles of the invention can replace enzymes in the embodiments as described below.

In particular, immobilized enzyme particles can be used for catalyzing a reaction wherein the enzyme immobilization material immobilizes and stabilizes the enzyme, is permeable to a compound smaller than the enzyme and is a micellar hydrophobically modified polysaccharide. In various preferred embodiments, the micellar hydrophobically modified polysaccharide is a hydrophobically modified chitosan or a hydrophobically modified alginate.

Further, immobilized enzyme particles can be used for detecting an analyte. The enzyme immobilization material immobilizes and stabilizes the enzyme, is permeable to a compound smaller than the enzyme and is a micellar hydrophobically modified polysaccharide. In various preferred embodiments, the micellar hydrophobically modified polysaccharide is a hydrophobically modified chitosan or a hydrophobically modified alginate.

For example, enzymes are used to degrade stains in laundry soil, such as in detergents to break down and remove proteins from clothes. Generally, the enzymes used in detergents are proteases, amylases, carbohydrases, cellulases, and lipases. These enzymes can be immobilized and stabilized in enzyme immobilization materials described herein and dispersed in a detergent or in an aqueous carrier to provide a laundry soil treatment. The enzyme immobilization materials could stabilize the enzyme to the other components of the detergent and improve storage stability. Various detergent products containing enzymes are described in U.S. Pat. Nos. 7,179,780, 6,894,013, and 6,827,795; these patents are herein incorporated by reference.

Also, enzymes are used in wastewater treatment to break down various wastes in the stream. For example, lipases, cellulases, amylases, and proteases are used in addition to bacteria to eliminate various wastes. The components in specific waste streams and the appropriate enzymes used to degrade such waste streams are known to a person skilled in the art. For example, various enzymes used in wastewater treatment are disclosed in U.S. Pat. Nos. 7,053,130, 6,802,956, 5,531,898, and 4,882,059; these patents are herein incorporated by reference. These enzymes can be replaced with the particles of the invention containing such enzymes to improve enzyme stability.

Another example of industrial use of enzymes is for converting corn or other cereals to high fructose corn syrup. Enzymes are used in three steps of high fructose corn syrup processing; these steps are liquefaction of the corn or cereal, saccharification of corn or other cereals to convert starch into sugars, and isomerization of glucose to fructose. In particular, glucose isomerase is used to convert glucose to fructose. The enzymes used could be advantageously immobilized in the enzyme immobilization materials described herein. This immobilization of the enzymes would be advantageous because the enzymes would be stabilized to denaturation and the enzymes could be easily removed resulting in a more controlled process. Also, the immobilized enzyme particles could be easily separated from the high fructose corn syrup product. These processing steps are described in more detail in U.S. Pat. Nos. 5,593,868 and 4,567,142; these patents are herein incorporated by reference.

Additionally, enzymes are used in food processing because these processes require enzymes that catalyze various reactions of proteins. For example, in baking processes, fungal amylases, hemicellulase, pentosanases, xylanases, proteases, pullulanases, and acid proteinases are used for various purposes. In one process, fungal amylase is used to modify flours for baking and produce more uniform dough and products. Also, maltogenic amylases are used to extend shelf-life of various types of bread and pullulanase is used as an antistaling agent in baked goods. In brewing, amylases, proteases, β-glucanase, and acetolactate decarboxylase are used in various steps. For beer, some of these enzymes can be added to the malted barley to aid conversion of starch to fermentable sugars, to remove “chill haze” and to improve filtration. For cheese and whey production, proteases (e.g., pepsin) and lipases are used in the milk curdling and cheese ripening steps and lactase is used for production of whey syrup. Further, β-glucosidase transforms isoflavone phytoestrogens in soymilk. Each of these enzymes can be immobilized in an edible immobilization material by the processes described herein and be advantageously used as catalysts for these reactions. These processes are described in more detail in U.S. Pat. Nos. 7,014,878, 6,936,289, 6,830,770, 4,358,462, and 6,372,268; these patents are herein incorporated by reference.

Various chemical synthesis processes use enzymes for esterifications, chiral synthesis, and interesterification and degumming of oils. For example, various carboxylic acid compounds including polymers having pendant carboxylic acid groups can be esterified with alcohols using various enzymes. The enzymes used to catalyze an esterification reaction are generally hydrolytic enzymes, specifically lipases, proteases, and esterases. Illustrative enzymes include Candida antarctica Lipase B (manufactured by Novozyme), Mucor meihei Lipase IM, Pseudomonas Cepacia Lipase PS-30, Pseudomonas aeruginosa Lipase PA, Pseudomonas fluoresenses Lipase PF, Aspergillus niger lipase, and Candida cylinderacea lipase from porcine pancreatic lipase. These reactions are described in more detail in U.S. Pat. Nos. 7,183,086 and 6,924,129; these patents are herein incorporated by reference. These enzymes can be replaced with the particles of the invention containing such enzymes to improve enzyme stability.

For chemical synthesis, a variety of enzymes can catalyze various chemical transformations. For example, glutaminase is used to convert glutamine to glutamates, penicillin acylase is used in chemical synthesis, chloroperoxidase is used in steroid synthesis, aspartic β-decarboxylase is use to make L-alanine from L-aspartic acid, and cyclodextrin glycosyltransferase is used to make cyclodextrins from starch. Also, synthesis of various chiral compounds use enzymes. Subtilisin is used for the chiral resolution of chemical compounds or pharmaceuticals, aminoacylase can optically resolve amino acids, alcohol dehydrogenase is used in the chiral synthesis of chemicals and amino acid oxidase is used for resolution of racemic amino acid mixtures. Some of these reactions are described in more detail in U.S. Pat. Nos. 6,036,983, 5,358,860, 6,979,561, 5,981,267, 6,905,861, and 5,916,786; these patents are herein incorporated by reference. These enzymes can be replaced with the particles of the invention containing such enzymes to improve enzyme stability during chemical synthesis.

Oils can be interesterified or degummed using various enzymes. For example, enzymatic interesterification is an efficient way of controlling the melting characteristics of edible oils and fats. This is done by controlling the degree of conversion/reaction. No chemicals are used in the process and no trans fats are formed as in other production methods. An immobilized lipase can be used to interesterify fatty acids on oils and fats used in the production of margarine and shortening. Further, enzymatic processes can be used to remove gums in vegetable oil; this process is typically called degumming Enzymatic degumming using a phospholipase enzyme converts non-hydratable lecithin (gums) to water-soluble lyso-lecithin, which is separated by centrifugation. Many of these processes are described in U.S. Pat. Nos. 6,162,623, 6,608,223, 7,189,544, and 6,001,640; these patents are herein incorporated by reference. These enzymes can be replaced with the particles of the invention containing such enzymes to improve enzyme stability in such interesterification or degumming processes.

Further, immobilized enzyme particles can be used in biosensors. Generally, these biosensors are used in diagnostic methods to sense various analytes in complex mixtures such as body fluids and industrial mixtures. For example, various sensors can be used to detect urea, uric acid, and cholesterol in various body fluids. Various sensors are described in U.S. Pat. No. 5,714,340; this patent is herein incorporated by reference.

Immobilized enzyme particles can be used in various assay methods to determine the presence and/or concentration of various compounds or organisms in body fluids (e.g., saliva, blood, or urine). These assay methods use various enzymes to interact with an analyte and an enzyme inhibitor; these interactions allow for a large number of molecules to be formed or transformed from detection of one or a few analyte molecules or organisms. In turn, the enzyme activity is proportional to the analyte concentration and allows low concentrations of analyte to be detected. Analytes can range from small molecule pesticides and other toxins to microbes. Various assay probes having a high specificity for capture and detection of particular analytes can be used. Assay methods using enzyme amplification are described in U.S. Pat. Nos. 6,171,802, 6,383,763, and 4,067,774; these patents are herein incorporated by reference.

Also, immobilized enzyme particles can be used for purification of substances and separation of components in mixtures. For example, enzymes can be used to separate chiral molecules and isomers from racemic mixtures, to remove sulfur from oils, gases, and other industrial materials, to break down and separate lignocellulose components from plants, to treat and purify wastewater, and for food processing to remove undesirable compounds.

Desulfurization of oils, gases, and other industrial materials use various enzymes. These enzymes are generally known as desulfurization enzymes. One important desulfurization enzyme is desulfinase. These desulfurization enzymes decompose thiophene in various petroleum products and remove sulfur atoms from the petroleum feed stocks prior to combustion. These processes are described in U.S. Pat. Nos. 6,461,859 and 7,045,314; these patents are herein incorporated by reference. These enzymes can be replaced with the particles of the invention containing such enzymes to improve enzyme stability during desulfurization.

Lignin from various plants can be degraded by lignin peroxidase. Lignin peroxidase catalyzes a variety of oxidations to result in various cleavage and other oxidation products. These oxidation reactions include carbon-carbon bond cleavage of the propyl side chains of the lignin, hydroxylation of benzylic methylene groups, oxidation of benzyl alcohols to corresponding aldehydes or ketones, and phenol oxidation. These processes are described in more detail in U.S. Pat. No. 7,049,485; this patent is herein incorporated by reference. The lignin peroxidase can be immobilized according to the invention to improve enzyme stability.

Fruit juice is processed using pectinases, amylases, and cellulases that break down various structures of the fruit cells and enhance the juice extraction process. Polysaccharides released from cells during the fruit processing are insoluble in the juice and make the juice cloudy. To clarify the juice, pectinases and amylases are used to break down these insoluble polysaccharides to make soluble sugars. This process results in a clear juice that is sweetened due to the added soluble sugars. These processes are described in more detail in U.S. Pat. Nos. 5,585,128, 5,419,251, and 4,971,811; these patents are herein incorporated by reference. These enzymes can be replaced with the particles of the invention containing such enzymes to improve enzyme stability during such processing.

Active surface films are coatings that include reactive substances and/or enzymes that can react with undesired contaminants to be self-cleaning or to remove various toxins from the surface. For example, active surface films can be included in food wraps, fibers, surface layers, bandages, or filters to break down toxins or kill bacteria. For example, enzymes that degrade various toxins could be included in fibers to destroy toxins used as biological weapons. Also, these same fibers could be coated with enzymes that kill or disrupt bacteria to prevent the wearer from contracting a bacterial infection. These enzymes can be replaced with the particles of the invention containing such enzymes to improve enzyme stability in such active surface films.

Also, more than one enzyme can be immobilized to provide a multifunctional material that is able to catalyze more than one reaction. For example, a combination of the above described enzymes could be immobilized in one or more enzyme immobilization materials to provide a product that can catalyze more than one reaction.

Using the immobilized enzymes described herein, it is possible to prepare electrode inks similarly to conventional fuel cell inks. First, the enzyme is encapsulated by an immobilization material using a spray drying technique described herein. Then the stabilized enzyme coated carbon is mixed with carbon filler, 5% Nafion® solution and then painted onto an electrode support. The dried electrode is then pressed to an exchange membrane with a corresponding anode that can be run as a H₂/O₂ fuel cell.

When considering the carbon black as filler in the enzyme based catalyst inks, the conductivity, surface area, and whether if it is grafted with a polymer doping can impact the overall performance of the electrode. Several carbon blacks have been tested as filler to improve the cell performance, and Monarch 1400 has illustrated the easiest workable ink along with the best performance. However, any carbon black can be implemented as a replacement for Monarch 1400 to improve enzyme interaction with the current collector. All carbon blacks mixed with encapsulated enzyme perform better than enzyme alone, but each possesses different optimization parameters that should be taken into account.

Among the various aspects of the invention are uses of an immobilized enzyme for catalyzing a reaction wherein the enzyme is immobilized in an enzyme immobilization material. The enzyme immobilization material immobilizes and stabilizes the enzyme, is permeable to a compound smaller than the enzyme, and is a micellar hydrophobically modified polysaccharide.

Other aspects are uses of an immobilized enzyme for detecting an analyte wherein the enzyme is immobilized in an enzyme immobilization material. The enzyme immobilization material immobilizes and stabilizes the enzyme, is permeable to a compound smaller than the enzyme, and is a micellar hydrophobically modified polysaccharide.

Yet other aspects are uses of an immobilized enzyme for catalyzing a reaction wherein the enzyme is immobilized in an enzyme immobilization material. The enzyme immobilization material immobilizes and stabilizes the enzyme and is permeable to a compound smaller than the enzyme. The reaction catalyzed is selected from (a) esterification of a carboxylic acid with an alcohol; (b) liquefaction of corn or other cereals; (c) saccharification of corn or other cereals to convert starch into sugars; (d) isomerization of glucose to fructose; (e) synthesis of chiral compounds; (f) interesterification of oils; (g) degumming oil; (h) treating wastewater (reaction); (i) clarifying fruit juice; (j) producing glucose by the starch process; (k) producing glucose and galactose from lactose; (l) synthesizing compounds having peptide bonds; (m) producing 6-aminopenicillic acid from penicillin G; (n) converting sugars to alcohol; (o) removing sulfur from petroleum fractions; (p) converting acrylonitrile to acrylamide; (q) converting 3-cyanopyridine to nicotinamide; and (r) degrading stains in a laundry soil.

A further aspect is an improvement in an enzyme-catalyzed reaction selected from esterification of a carboxylic acid with an alcohol, liquefaction of corn or other cereals, saccharification of corn or other cereals to convert starch into sugars, isomerization of glucose to fructose, synthesis of chiral compounds, interesterification of oils, degumming oil, treating wastewater, clarifying fruit juice, producing glucose by the starch process, producing glucose and galactose from lactose, synthesizing compounds having peptide bonds, producing 6-aminopenicillic acid from penicillin G, converting sugars to alcohol, removing sulfur from petroleum fractions, converting acrylonitrile to acrylamide, converting 3-cyanopyridine to nicotinamide or degrading stains in a laundry soil. The improvement comprises immobilizing the enzyme in an enzyme immobilization material that immobilizes and stabilizes the enzyme and is permeable to a compound smaller than the enzyme.

Other aspects are uses of an immobilized enzyme for detecting an analyte wherein the enzyme is immobilized in an enzyme immobilization material. The enzyme immobilization material immobilizes and stabilizes the enzyme and is permeable to a compound smaller than the enzyme. The analyte detected comprises urea, uric acid, cholesterol, a pesticide, a toxin, or a microbe.

Yet other aspects are uses of an immobilized enzyme for separation or removal of a substances from a mixture wherein the enzyme is immobilized in an enzyme immobilization material. The enzyme immobilization material immobilizes and stabilizes the enzyme and is permeable to a compound smaller than the enzyme.

Further aspects are uses of an immobilized enzyme in a chemically active film surface that reacts with at least one substance contacting the film surface wherein the enzyme is immobilized in an enzyme immobilization material. The enzyme immobilization material immobilizes and stabilizes the enzyme and is permeable to a compound smaller than the enzyme.

### EXAMPLES

### Example 1

### Bioanode Performance and Fabrication

### 1. Nickel and Carbon Electrode Structure

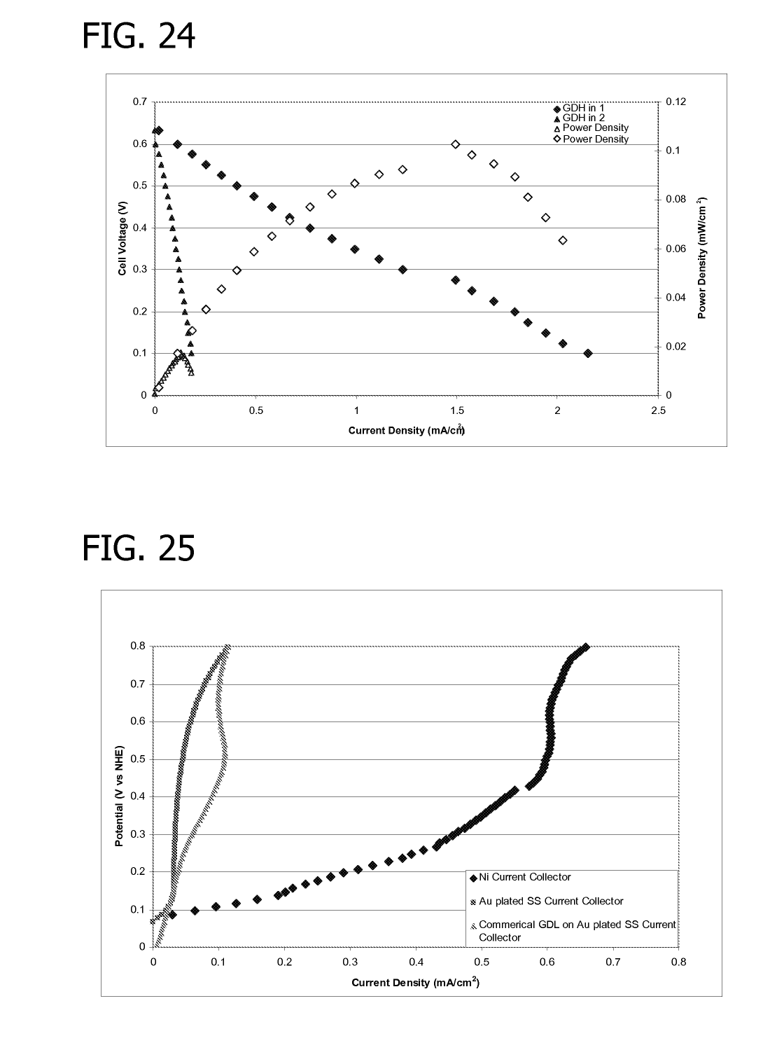

The choice of metal and materials used for bioanode fabrication plays an important role in the anode's performance. This is shown in FIG. 24, where three electrodes were prepared and evaluated using a commercial NAD-dependent ADH enzyme with methylene green as a mediator. The electrodes consisted of either a gold plated stainless steel or nickel current collectors and either a commercial GDL, double sided E-lat from Etek, or an in-house produced epoxy and carbon GDL as the catalyst support layer. The best performance was seen with the combination of nickel current collectors and in-house fabricated GDL.

This type of electrode configuration was also used with a glucose dehydrogenase enzyme for a glucose fueled biofuel cell. Performance of this cell is shown in FIG. 25. With respect to FIG. 25, the plots represented by the diamonds are the performance of a 4 cell (4.5 cm² area per cell) biofuel cell stack with a bioanode and an air-breathing platinum cathode. The plot represented by the triangles is performance of a prior best cell using a commercial GDL.

### 2. In-House Produced Gas Diffusion Layer (GDL)

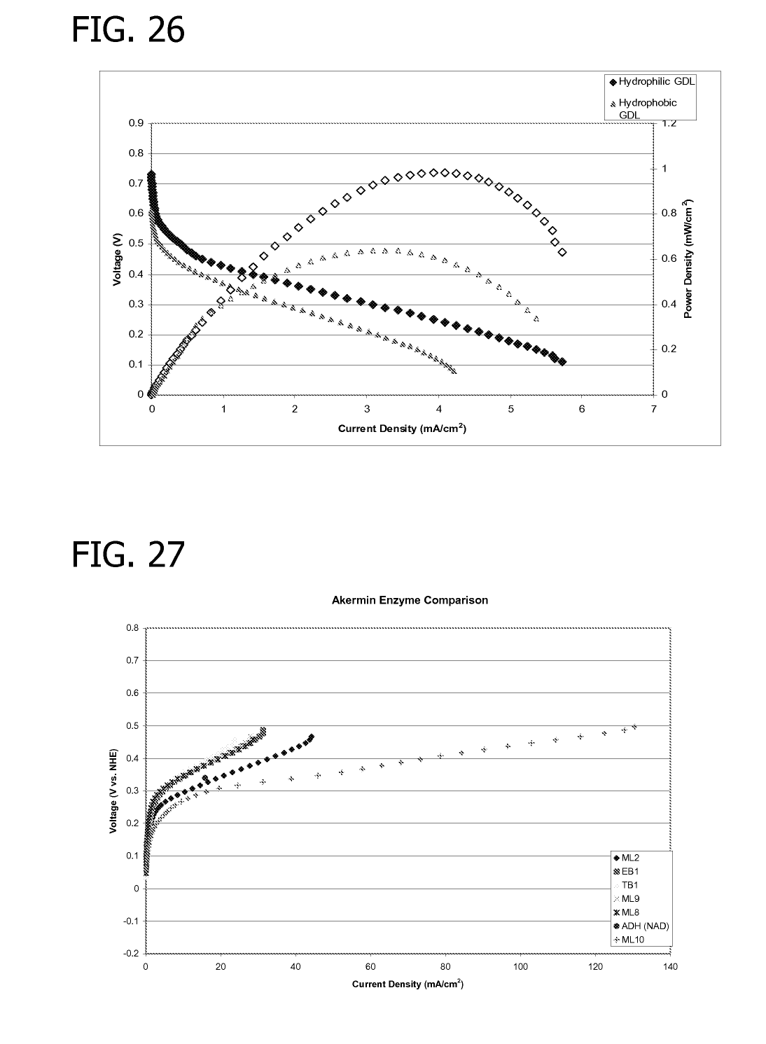

One of the main factors influencing bioanode performance is the enzyme catalyst support layer, as shown in the previous section. The best performance was from an anode with a dried carbon paste support layer. A picture of this type of cell is shown in FIG. 7. This structure acts as a catalyst support, reactant diffusion layer, and an electrical contact layer between the current collector and the catalyst layer. This layer was a mixture of carbon black, meso porous carbon, PTFE, two part epoxy and was applied as a paste to a current collector and frame as a paste made with water and acetone. This paste was allowed to dry prior to the catalyst and modified Nafion layer being applied. This type of material has many advantages as a catalyst support, in the terms of fine tuning the properties. This GDL can be made more hydrophobic or hydrophilic by adjusting the ratios of PTFE and meso porous carbon. An example of this is shown in FIG. 26. With respect to FIG. 26, the GDL material was made more hydrophilic through the inclusion of carbon sieves (represented as diamonds), resulting in improved performance over that of vulcanized carbon alone (represented as triangles). The rest of the cell consisted of stainless steel expanded metal current collectors with Au plating for the cathode, N112 as the membrane, cathode is 4 mg/cm² Pt black, and 1% ethanol as the fuel.

### 3. Enzyme for Bioanode

The purity, age, and concentration of the ADH enzyme played another role in the bioanode performance. A representative plot of 7 ADH enzymes, including 6 in-house purified PQQ-dependent and 1 commercial NAD-dependent ADH enzymes is given in FIG. 27. The worst performing enzyme is TB1, which was the oldest enzyme of the lot tested (6 weeks at 4° C.). The best was ML10, a high purity and concentration enzyme and the freshest of all enzymes when tested. The commercial NAD-dependent ADH was shown in this diagram as a point of reference. The commercial enzyme's performance was comparable to four of the in-house produced enzymes. The difference between each potential and 0 V (vs NHE) is representative of the anodic overpotential of each electrode and lower potentials at a given current density are preferred. The best performance was sample ML10, which demonstrated operation of 75 mA/cm² at a potential 400 mV vs. NHE. This level of performance was dependent on the quality and type of enzyme used and the type of metal ion activators (e.g., nickel) present in proximity to the immobilized enzyme. The best performance was seen with enzymes purified under in-house acidic operating conditions.

### 4. Bioanode Half Cell Performance

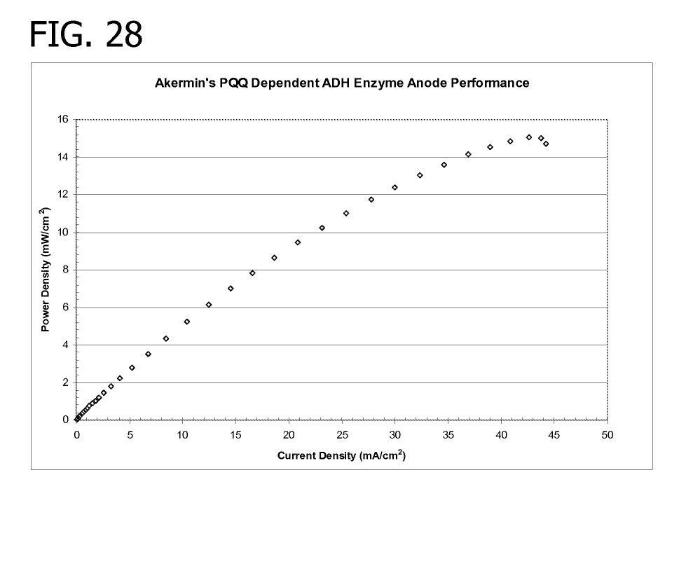

An example of the bioanode performance, power densities, in a half cell configuration is shown in FIG. 28. The anode in this figure has an area of 1 cm² and was tested in a 1 M H₂SO₄ solution with 5% ethanol. The maximum power density achieved with this cell was 15 mW/cm². This level of performance was dependent on the quality and type of enzyme used (best performance seen with enzymes purified by applicant), operating conditions (acidic), and type of metal ion activators present in proximity of the mobilized enzyme (nickel).

### Example 2

### 4 and 8 Cell Stack Performance

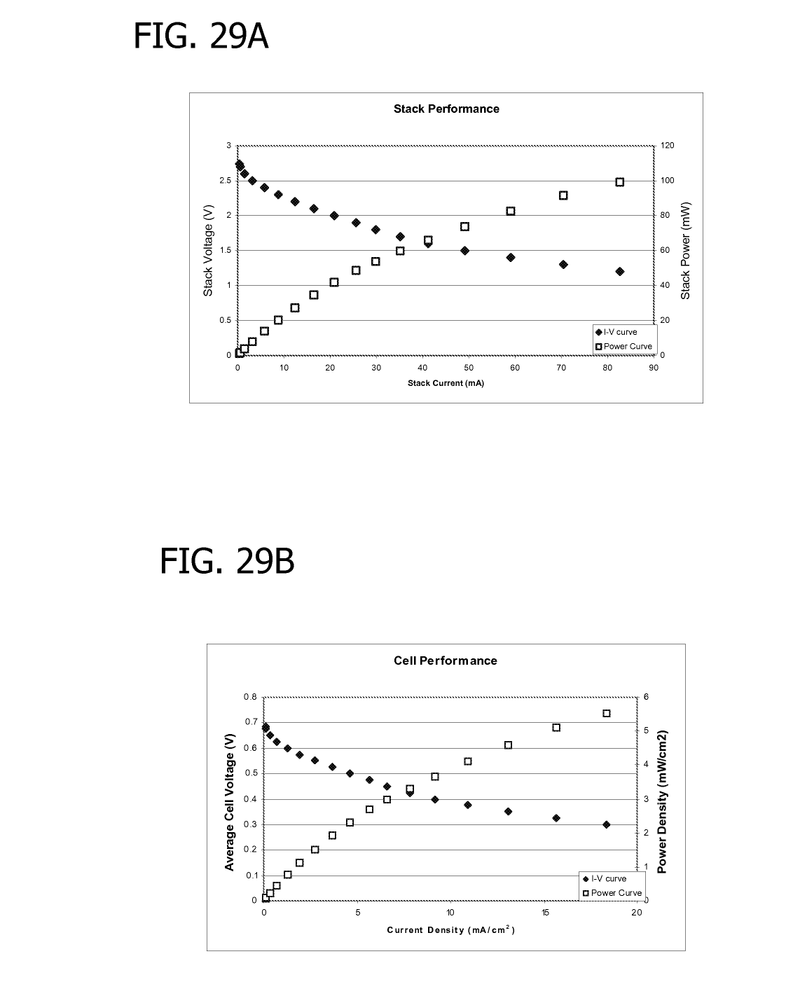

When the bioanode described in FIG. 28 was paired with a platinum-based cathode, was scaled up in size to 4.5 cm², and was connected in series (4 cells) the overall performance is reduced to 33% of that in FIG. 28. A representative current versus voltage curve and power curve for a 4 cell stack in series is shown in FIGS. 29A and 29B. The graph on the left represents the performance of a 4 cell (4.5 cm² area per cell) biofuel cell stack with a bioanode and an air-breathing platinum cathode. The graph on the right represents the average cell voltage and power density of the individual cells of this stack. The anode enzyme used in these cells was prepared and purified in-house.

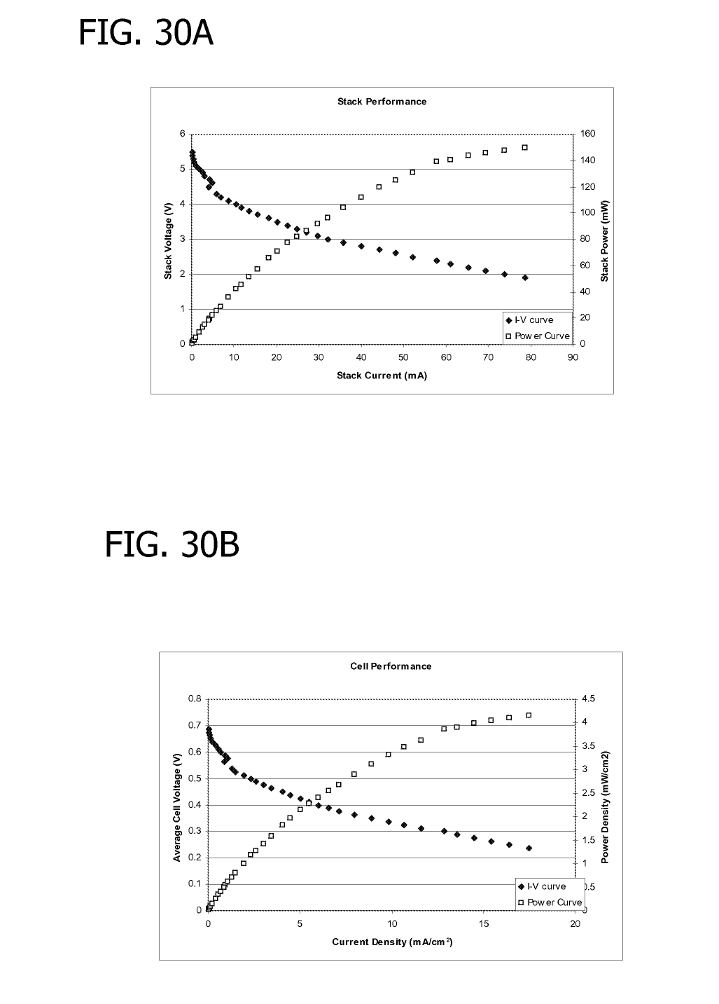

When two of these 4 cell stacks were connected in series, the performance was further decreased by half A representative current versus voltage curve and power curve for an 8 cell stack in series is shown in FIGS. 30A and 30B. This stack was the combination of 2 four cell stacks, like the one shown in the previous slide, connected in series. The graph on the left represents the performance of a 8 cell (4.5 cm² area per cell) biofuel cell stack with a bioanode and an air-breathing platinum cathode. The graph on the right represents the average cell voltage and power density of the individual cells of this stack. As the number of cells in the stack was increased, a lower individual cell performance was noticed.

### Example 3

### Anode Construction

Catalyst Support—Gas Diffusion Layer (GDL)

The catalyst support layer used for the anode electrodes was made from a mixture of carbon materials, Teflon, two-part epoxy, and solvents. By varying the ratio of these components, the properties of the structure could be fine tuned. Examples of such properties included: (1) electronic conduction, (2) hydrophobic/hydrophilic nature, (3) surface area, and (4) drying time. This mixture was made up as a paste and then pressed into a Kapton masked frame/current collector structure with excess doctor bladed off. The frame was masked on both sides with cutouts on one side to reveal the exposed current collector. Prior to complete drying and setting of this paste, the Kapton tape mask was removed and the entire structure was allowed to dry under a halogen heating lamp.

The formulation for GDL paste was prepared from dry components of 3.57 g Monarch 1400 carbon black (Cabot) and 1.43 g Chemsorb 1505 G5 porous, impregnated steam activated carbon (C*Chem). These dry components were charged in a food grinder for 60 seconds. The wet components were prepared separately and were 5.00 g Quick Set 2 part epoxy (The Original Super Glue Corp.), 4.00 g acetone, and 2.00 mL 60% PTFE dispersion in water (Sigma). The epoxy was dissolved in the acetone before adding the PTFE dispersion. The wet components were mixed with an ultra sonic homogenizer for 15 seconds. The dry and wet mixtures were combined and mixed with a putty knife until the mixture had the consistency of toothpaste.

Catalyst Layer

The enzyme catalyst layer was applied to the surface of the dried GDL structure as a cast mixture of enzyme in buffer solution and TBAB modified Nafion immobilization material. The solution was allowed to dry and cure prior to joining with a corresponding cathode structure.

Formulation for Enzyme Catalyst layer

A volume of casting solution was made to provide enough for eight cells (4.5 cm²) and from this casting solution an aliquot of 0.45 mL is cast to each electrode. The casting solution was 2.1 mL of PQQ dependent ADH (˜10 mg/mL) in PBS buffer and 2.1 mL of 5% by volume tetrabutyl ammonium bromide modified Nafion immobilization material.

Frame and Current Collector Fabrication

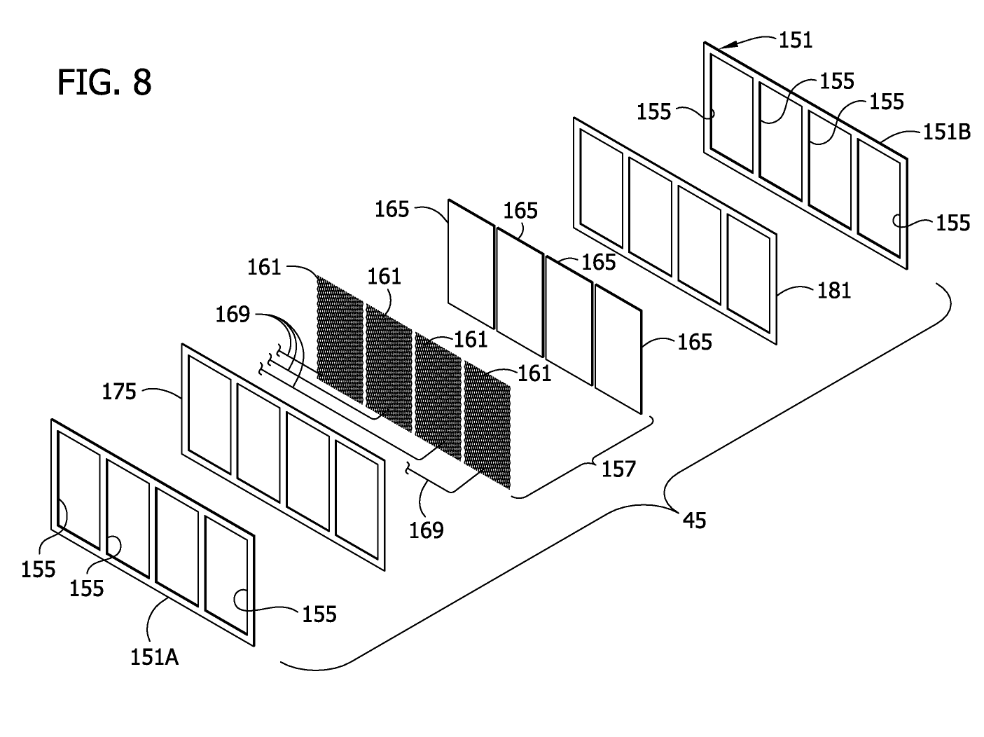

The components for the anode current collector and frame assembly are shown in FIG. 8. The construction starts by melting two pieces of urethane hot melt pieces to one side of each vinyl frame cutout. The melting was done by exposing the frame with the hot melt pieces laid out on top to 128° C. temperatures for 30 seconds. The pieces were then removed and allowed to cool until the adhesive was just tacky to touch. Expanded metal current collectors with wires woven and pressed (8 metric tons) were arranged onto one of the frame structures in a configuration shown in FIG. 8 with the wire leads fixed along the sides of the frame in the hot melt glue. The other frame was set on top of the current collector/frame/adhesive structure with the glue side towards the expanded metal current collector. This whole assembly was then pressed at minimal pressure and 128° C. temperature for 30 seconds to seal the structure.

### Example 4

### Cathode Construction

Catalyst Support—GDL and Current Collector

The catalyst support layer used for the anode electrodes was a commercially available carbon cloth GDL material. The material was designated by E-Tek as LT2500W Low Temperature Elat with a microporous layer on either side. The current collector used for this cathode was a 0.007″ thick expanded stainless steel material that was cut to size with a 28 gauge insulated wire woven and pressed along one edge to make a flag-like structure. The exposed conductive portions of this cathode flag were acid etched (5 M HCl) and gold electroplated using an Orthotherm HT RTU rack gold bath (Technic Inc.) prior to assembly of the cathode electrode.

Catalyst Layer

The cathode catalyst layer consisted of platinum black catalyst and Nafion ionomer with respective loadings of 4 mg/cm² and 8.5 weight %. The catalyst was prepared as an ink and painted onto a piece of Elat that was big enough for 8 electrodes (36 cm²) and was allowed to dry. When the catalyst layer was dry, the sheet was cut into individual electrodes with and area of 4.5 cm² (3×1.5 cm) and set aside until final assembly.

Formulation for Cathode Catalyst Layer

A volume of casting solution sufficient for preparation of eight cells (4.5 cm²) was prepare. The casting solution was made up of 158.4 mg of HiSPEC™ 1000 Platinum Black (Alfa Aesar), 380.2 mL DI water, 100.0 mL 2-propanol, and 336.7 mL of 5 wt. % Nafion ion exchange resin in lower aliphatic alcohols/water mix (Sigma Aldrich). The casting solution was mixed using an ultra sonic homogenizer for 15 seconds prior to painting.

### Cathode Fabrication

The cathode was fabricated as one piece including the current collector, GDL/catalyst layer, and Nafion immobilization material. The Nafion immobilization material, Nafion 212 (Sigma Aldrich), was cut into pieces slightly larger than the GDL layer and then wetted with DI water. The catalyst/GDL layer was positioned on top of the expanded metal current collector, painted with a thin coat of 5 wt. % Nafion solution, and wetted with DI water. A top of this assembly was placed the wetted Nafion membrane and the whole structure was placed between 2 sheets (3×3″) of Kapton, 0.010″ thick (McMaster-Carr). The Kapton film served as a press package and release film. The whole package was pressed at a pressure of 3 metric tons and 128° C. for 90 seconds and then cooled between two 1″ thick aluminum plates. The Kapton films were removed and the cathode was trimmed to size (3.75×1.7 cm) prior to placement in the frames.

Frame Fabrication and Cathode Assembly

The components for the cathode current collector and frame assemble are shown in FIG. 8. First, two pieces of urethane hot melt pieces were melted to one side of each vinyl frame cutout. The melting was done by exposing the frame with the hot melt pieces laid out on top to 128° C. temperatures for 30 seconds. The pieces were then removed and allowed to cool until the adhesive was just tacky to touch. Four prefabricated cathodes were arranged onto one of the frame structures in a configuration shown in FIG. 8 with wire leads fixed along the sides of the frame in the hot melt glue. The other frame was set on top of the current collector/frame/adhesive structure with the glue side being towards the expanded metal current collector. This whole assembly was then pressed at minimal pressure and 128° C. temperature for 30 seconds to seal the structure.

### Example 5

### Manifold and Fuel Tank

The fuel delivery manifold designed for this device offered advantages for this type of fuel cell with an electrolyte fuel solution that would short cells in a conventional liquid fuel cell (i.e., direct methanol fuel cell). Fuel was delivered to individual cell reservoirs through a series of one way check valves between each cell. The use of the check valves (Poweraire) broke any ionic communication between the cells, thus preventing shorts. And with the check valves arranged in series there was one fuel input and output to fill all of the cells. The valves were connected to the cells using ⅛″×⅛″ polypropylene barbed elbows (Small Parts) that were trimmed to size. A picture of this arrangement is shown in FIGS. 4 and 5. Fuel was delivered and removed using a syringe and 1/16″ ID Tygon tubing, a method that required additional electrical power.

The fuel reservoir system for this device was designed to eliminate fuel/electrolyte contact between cells by using individual reservoirs for each cell. Unique features of this tank was the stepped top of the reservoir, shown in FIGS. 4 and 5. This allowed for the complete filling of the stack and eliminated trapped air bubbles from coming in contact with the anodes. Fuel was brought in the lower step of the tank and exited out of the upper step where any trapped air was pushed out of electrode contact. A set of four fuel cells were attached to the reservoir with the anode side towards the fuel, using 0.005″ thick hot melt urethane adhesive melted at 128° C. at a minimal pressure.

### Example 6

### Housing

The housing for the eight-cell biofuel cell stack is shown in FIGS. 2 and 13. The final housing design was machined out of 0.600″ thick acrylic and featured support pedestals for the electrode structure in the center of the housing half, fuel manifold system cutouts on the side of the housing, and cutouts on either end for electronics and IO interface. The stack was inserted between two housing halves and the housing was bolted together with 1″ liing 8/32 hex head bolts in each of the four corners of the stack. The two halves were seal together using a 0.020″ thick PTFE gasket that surrounded the perimeter.

### Example 7

### Composite Catalysts

It was discovered that CoPcF deposited in carbon supported polypyrrole (typically, 5-60% by weight) exhibited exceptional activity for oxygen reduction once it was appropriately pyrolyzed at high temperatures. The combination of CoPcF-carbon supported polypyrrole composite and appropriate pyrolysis made the composite catalyst CoPcFPPy very unique. These catalysts were evaluated in an air-breathing half cell with 1.0 M sulfuric acid solution (with or without phosphotungstic acid (PTA) promoter), at room temperature of ca. 25° C. The catalysts were prepared according to the procedure described below. General preparation conditions of catalysts are listed in the table below.

Catalyst preparation conditions

| | | Pyrolysis | Pyrolysis |
|---|---|---|---|
| Composite | Weight ratio | Temperature | Time |
| Catalysts | (CoPcF:CPPy) | (° C.) | (hours) |
| CoPcFCPPy | 1:8~6:1 | 100~1000 | 0.5~6 |
| CoPcCPPy | 1:8~6:1 | 100~1000 | 0.5~6 |

Note:
CoPcF—cobalt hexadecafluorophthalocyanine;
CPPy—carbon supported polypyrrole;
CoPc—cobalt phthalocyanine.

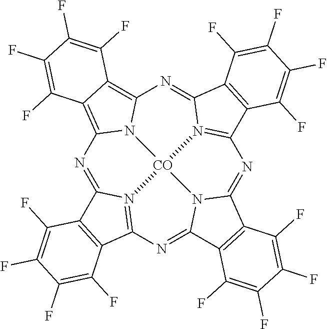

### Structure of cobalt(II) 1,2,3,4,8,9,10,11,15,16,17,18,22,23,24,25-hexadecafluoro-29H,31H-phthalocyanine (CoPcF)

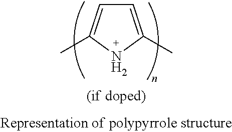

The preparation of such a composite is described below under conditions wherein the ratio of CoPcF:CPPy was 1:2, the pyrolysis temperature was 600° C., and the pyrolysis time was 1 hour. Platinum black (Johnson Matthey) was coated on Teflon treated carbon cloth (E-Tek) in a loading of 5 mg/cm² with 10% Nafion in the catalyst layer. CoPcFCPPy was coated on Teflon treated carbon cloth (E-Tek) in a loading of 10 mg/cm² with 30% Nafion in the catalyst layer with or without phosphotungstic acid (PTA) at a ratio of 1:10 (PTA:CoPcFCPPy). The scan rate was 2 mV/s. The resulting catalyst exhibited exceptional activity for oxygen reduction (maximum power density is ca. 25 mW/cm²), represented by the dotted polarization curve of FIG. 31. When phosphotungstic acid (PTA) was incorporated in the CoPcFCPPy composite catalyst (the weight ratio of PTA:CoPcFCPPy=1:50˜1:2, representative weight ratio is 1:10), a significant performance jump was observed (maximum power density of 36 mW/cm²). This performance was comparable to platinum (Pt) catalyst performance.

Preparation procedure for CoPcFCPPy with PTA and without PTA. Cobalt(II) 1,2,3,4,8,9,10,11,15,16,17,18,22,23,24,25-hexadecafluoro-29H,31H-phthalocyanine (CoPcF) (100 mg, Sigma) and 200 mg carbon-supported polypyrrole (PPy/C) (Sigma) were dispersed in 4 mL tetrahydrofuran (Sigma) in an ultrasonic bath for 10 minutes and then the solvent was evaporated in a vacuum oven at room temperature for 1 hour. The dry powder was then placed in a crucible and heat-treated in nitrogen atmosphere furnace at 600° C. for 1 hour. The resulting catalyst was designated CoPcFCPPy. CoPcFCPPy (10 mg) and 60 mg Nafion solution (5%, Sigma) were dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes. When phosphotungstic acid (PTA) was added, 1 mg PTA was dissolved and 10 mg CoPcFCPPy and 60 mg Nafion solution (5%, Sigma) were dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes.

Preparation procedure for Pt cathode. Platinum black (5 mg, Johnson Matthey HiSpec 1000) and 2 mg carbon black (Monarch 1000) were dispersed in 200 μL isopropanol in an ultrasonic bath for 5 minutes and then 33 mg Nafion solution (5%) was added followed by sonicating the mixture for another 5 minutes. The mixture was slowly coated on the active side of a 1 cm² gas diffusion layer (ELAT, A7NCV2.1) and then dried in a vacuum oven at room temperature for 30 minutes.

### Example 8

### Ethanol Tolerance of CoPcCPPy Composite Cathode Catalyst

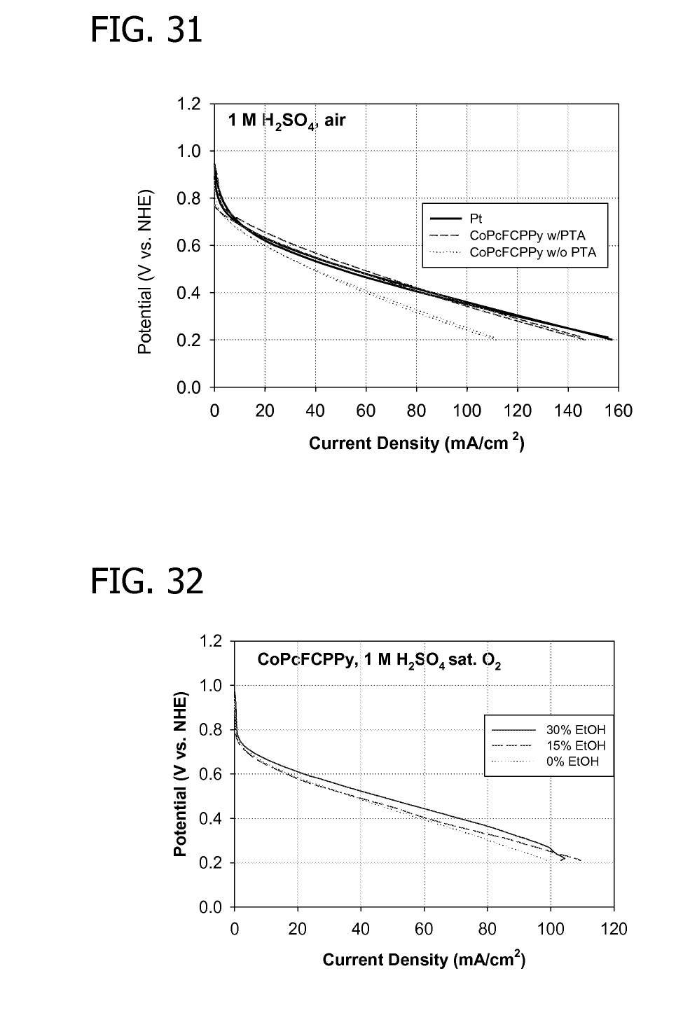

CoPcFPPy prepared as described in example 1 exhibited no activity loss (FIG. 32) when the electrolyte solution contained 15 or 30% ethanol that was saturated by oxygen. This indicated that the catalyst exhibited good alcohol tolerance. Better performance was observed in the 30% ethanol solution because oxygen has higher solubility in the solution.

### Example 9

### Heat-Curing Effect on CoPcFCPPy Air Breathing Cathodes

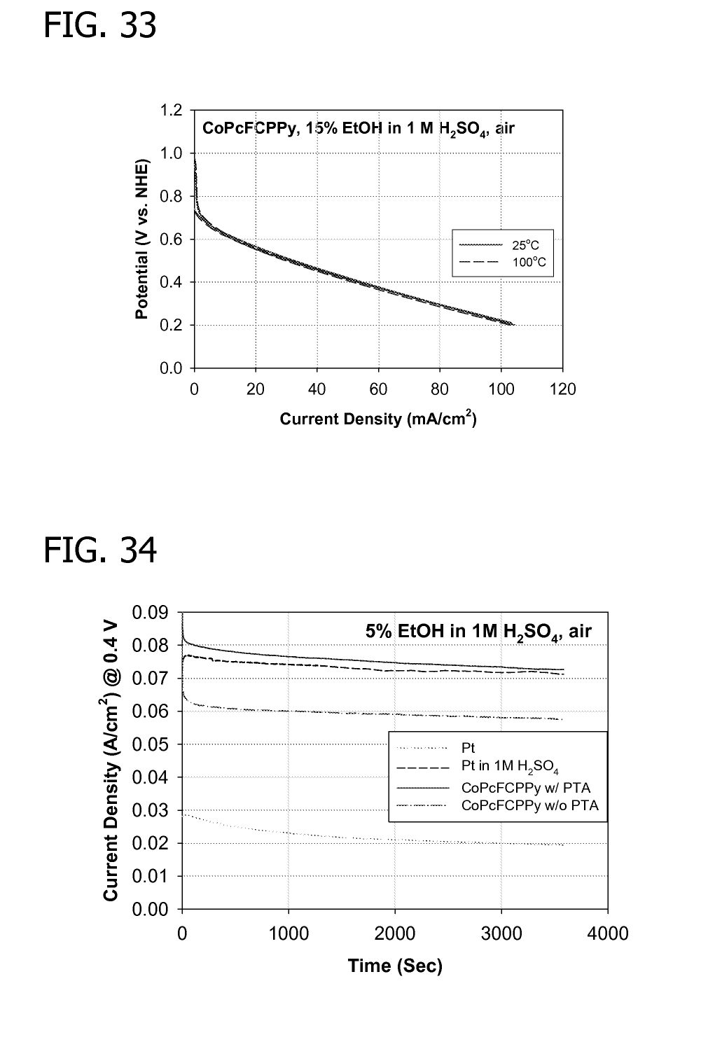

Because assembly of a fuel cell includes pressing of fuel cell components at about 100° C. and curing of recast Nafion® electrolyte polymers at about 80° C., the catalyst activity was evaluated after curing the cathode at 100° C. The results in FIG. 33 indicate that the performance is independent of electrode curing temperatures.

### Example 10

### Stability of CoPcFCPPy Air Breathing Cathodes

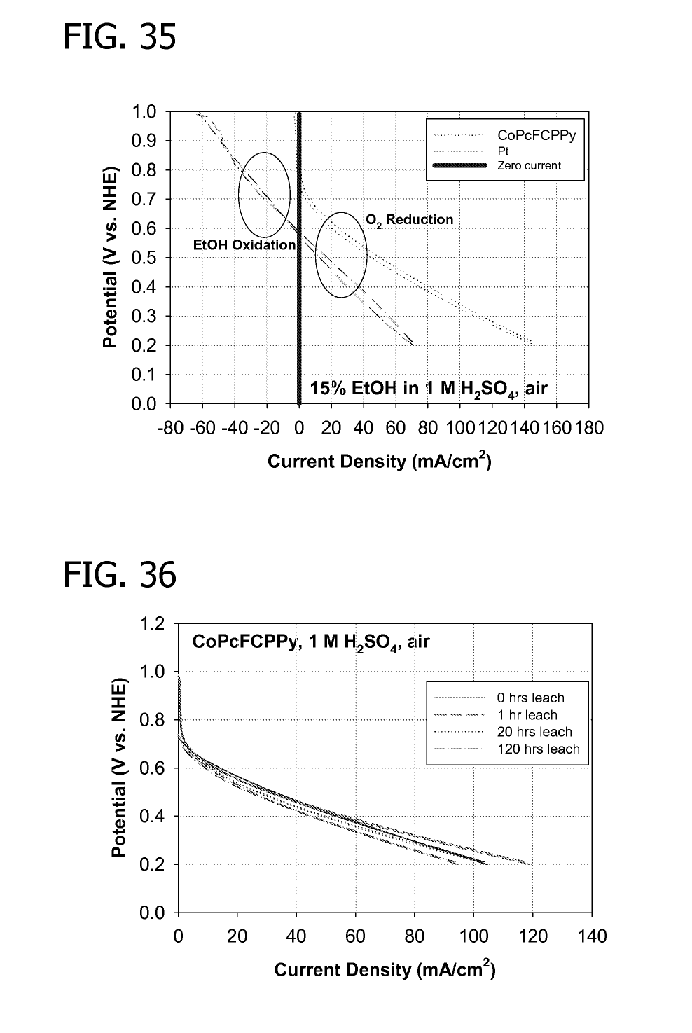

When the platinum cathode was tested in 5% ethanol in 1 M sulfuric acid solution, the current density of oxygen reduction at an electron potential of 0.4 V is below 30 mA/cm² and decays to 19 mA/cm² in an hour, as shown in FIG. 34. Platinum is a suitable catalyst for oxygen reduction, but it also catalyzes alcohol oxidation (ethanol). As shown in FIG. 35, the mixed potential in the Pt cathode is lower possibly because the intermediates of ethanol oxidation at platinum poisoned the platinum catalyst, causing its activity to decay faster. At the same potential of 0.4 V, the CoPcFCPPy cathode had a much higher current density for the oxygen reduction (see FIG. 34); it was about 65 mA/cm² initially and decayed to 58 mA/cm² in an hour. The CoPcFCPPy with PTA catalyst resulted in a cathode that had an even higher current density than that of CoPcFCPPy without PTA. The current density decayed from 82 to 73 mA/cm² in an hour. CoPcFCPPy with or without PTA did not catalyze ethanol oxidation, as shown in figures B.3 and B.7, and had high selectivity for the oxygen reduction reaction. For comparison, a platinum cathode was tested in 1 M sulfuric acid solution in the absence of ethanol. The current density of oxygen reduction at the platinum cathode was ca. 77 mA/cm² and decayed to 71 mA/cm² in an hour. This indicates that the decay for these cathodes probably is not due to catalyst poisoning or degradation. CoPcFCPPy catalysts were very stable in sulfuric acid solution containing 5% ethanol.

### Example 11

### Stability of the CoPcFCPPy Catalysts

One possible explanation for the decays observed in the hour life test (FIG. 34) is cathode flooding. FIG. 36 confirms that some degree of cathode flooding was likely since one- or twenty-hour acid leaching did not affect the activity. After 120 hour leaching, the catalyst still exhibited very good activity for oxygen reduction.

Leaching conditions. CoPcFCPPy (20 mg) was dispersed in 1 mL 1 M H₂SO₄ solution and allowed to settle. The catalyst powder was filtered and rinsed with distilled water. The catalyst powder was placed in a vacuum oven at room temperature for 2 hours. Dry catalyst (10 mg) and 60 mg Nafion solution (5%, Sigma) was dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes.

### Example 12

### Un-Pyrolyzed CoPcFCPPy Catalysts

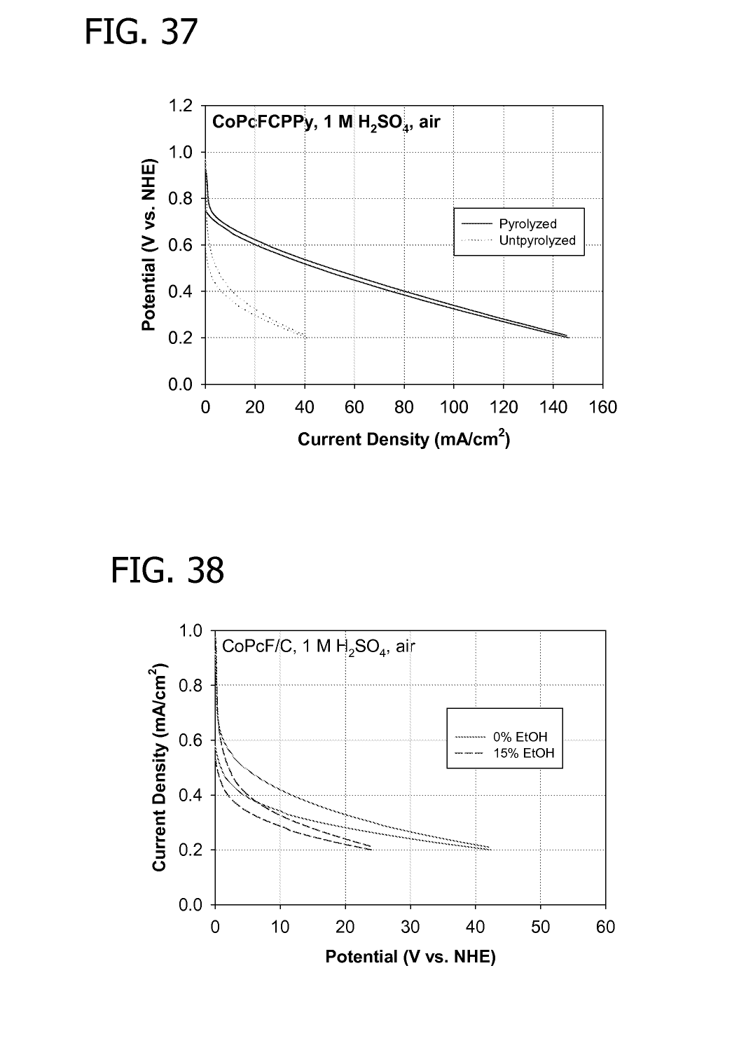

An increase in catalytic activity was observed after high-temperature heat treatment of CoPcFCPPy catalysts, as shown in FIG. 37. The carbon supported PPy provided a carrier with high electronic conductivity and high surface area for immobilizing CoPcF for enhancing electrocatalytic activity. In particular, PPy may provide nitrogen atoms to coordinate with cobalt atoms in CoPcF. Because porphyrin consists of four pyrrole units, the coordination of the Co atom in CoPcF with nitrogen atoms of the pyrrole unit in PPy may mimic catalytic function of Co porphyrin. Consequently, the CoPcFCPPy catalyst composite may integrate CoPcF function and Co Porphyrin function. Heat treatment at high temperatures may partially break down the CoPcF structure and the PPy chain, providing more opportunity for Co atoms to coordinate with nitrogen atoms of the pyrrole units.

Preparation of pyrolyzed CoPcFCPPy is described above in example B.1.

Preparation of unpyrolyzed CoPcFCPPy. CoPcF (3.3 mg, Sigma), 6.7 mg PPy/C (Sigma) and 60 mg Nafion solution (5%, Sigma) was dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes.

### Example 13

### Carbon Black Supported CoPcF Pyrolyzed at 600° C.

The CoPcF catalyst containing PPy exhibited increased oxygen reduction activity as compared to a CoPcF catalyst supported only on carbon black (Monarch 1000). The activity for the oxygen reduction reaction is lower than CoPcFCPPy (FIG. 31) even the catalyst is pyrolyzed at 600° C. (FIG. 38). Also, the catalyst without PPy does not have good ethanol tolerance.

Preparation of CoPcF/C. CoPcF (100 mg, Sigma) and 200 mg carbon black (Monarch 1000) was dispersed in 4 mL tetrahydrofuran (Sigma) in an ultrasonic bath for 10 minutes and then the solvent was evaporated in a vacuum oven at room temperature for 1 hour. The dry powder was placed in a crucible and heat treated in a nitrogen atmosphere furnace at 600° C. for 1 hour. The resulting catalyst was designated CoPcF/C. CoPcF/C (10 mg) and 60 mg Nafion solution (5%, Sigma) was dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes.

### Example 14

### CoPc-PPy-C Treated at 600° C.

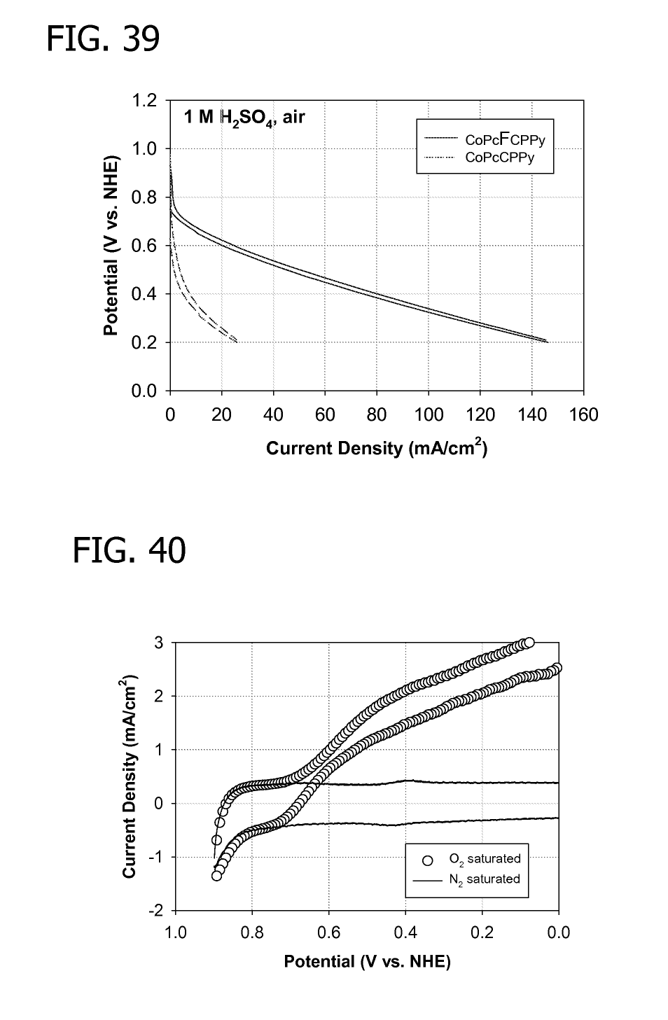

In addition to CoPcF, we also made cobalt phthalocyanine (CoPc) in PPy supported on carbon black and treated it at 600° C. Its activity for oxygen reduction was significantly lower than that for CoPcFPPy. (see FIG. 39).

Preparation of CoPcCPPy. CoPc (100 mg, Sigma) and 200 mg PPy/C (Sigma) was dispersed in 4 mL THF (Sigma) in an ultrasonic bath for 10 minutes and then the solvent was evaporated in a vacuum oven at room temperature for 1 hour. The dry powder was placed in a crucible and heat treated in a nitrogen atmosphere furnace at 600° C. for 1 hour. The resulting catalyst was designated as CoPcCPPy. CoPcCPPy (10 mg) and 60 mg Nafion solution (5%, Sigma) was dispersed in 200 μL isopropanol in an ultrasonic bath for 10 minutes and the mixture was slowly coated onto the active side of a 1 cm² gas diffusion layer (ELAT, A7NCV2.1) and then placed in a vacuum oven at room temperature for 30 minutes.

### Example 15

### Biocathodes Containing Enzymes

Preparation of biocathodes. Carbon black (or carbon nanotubes) (0.30 mg) was dispersed in 100 μL isopropanol (Sigma) in an ultrasonic bath for 2 minutes to make a carbon powder suspension. 10 μl enzyme (BOD or laccase) solution in 1 mg/ml pH 5 acetate buffer was added into the suspension followed by shaking for 1 minute. The mixture was slowly coated on to the active side of a 1 cm² gas diffusion layer (GDL) (ELAT, A7NCV2.1, or in house GDLs) and then placed in a vacuum oven at room temperature for 30 minutes. The pH 5 acetate buffer was prepared by dissolving 12.0 g acetic acid and 28.7 g sodium acetate in 1 liter D.I. water.

Direct electron transfer between bilirubin oxidase (BOD) and MWCNT/Torey carbon paper electrode was observed in nitrogen saturated acetate buffer solution, as shown in FIG. 40. The redox potential of BOD is about 0.4 V. When the buffer solution is saturated by oxygen a catalytic current of oxygen reduction reaction starts appearing at about 0.8 V and rapidly increases at the potential close to the redox potential of BOD.

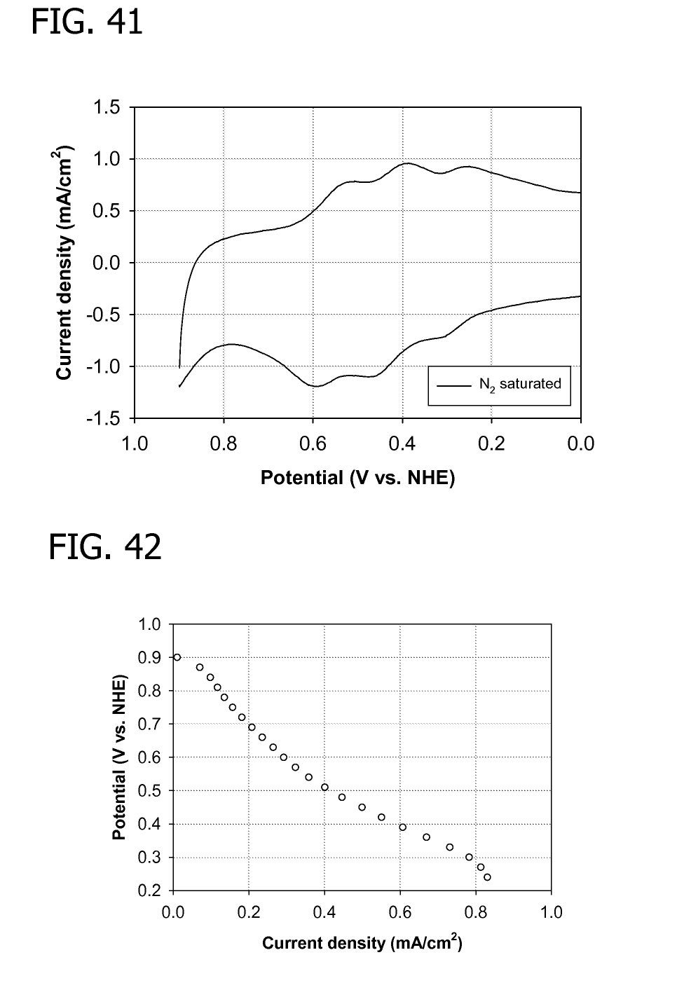

A clear direct electron transfer of laccase at multi-walled carbon nanotube (MWCNT)/Torey carbon paper electrode was also observed, as shown in FIG. 41. Interestingly, three couples of redox peaks in the cyclic voltammogram are clearly separated, which correspond to the direct electron transfer from T1, T2 and T3 types of active copper sites in laccase.

There are three groups of laccases that are classified by the redox potential of the T1 site and their primary structures, namely low, middle, and high redox potential enzymes. The values of the redox potentials of the T1 site vary between 430 and 790 mV vs. NHE. Since the direct electron transfer behaviors of the enzymes have been successfully observed, one expects that an appropriate laccase may catalyze oxygen reduction reaction at a higher potential that is good for fuel cell voltage. When laccase (Trametes spec.) is used a laccase-catalyzed ORR starts at 0.9V at hydroxyl-functionalized MWCNT electrode (air breathing), and a current density of 0.4 mA/cm² can be obtained at 0.5 V, as shown in FIG. 42.

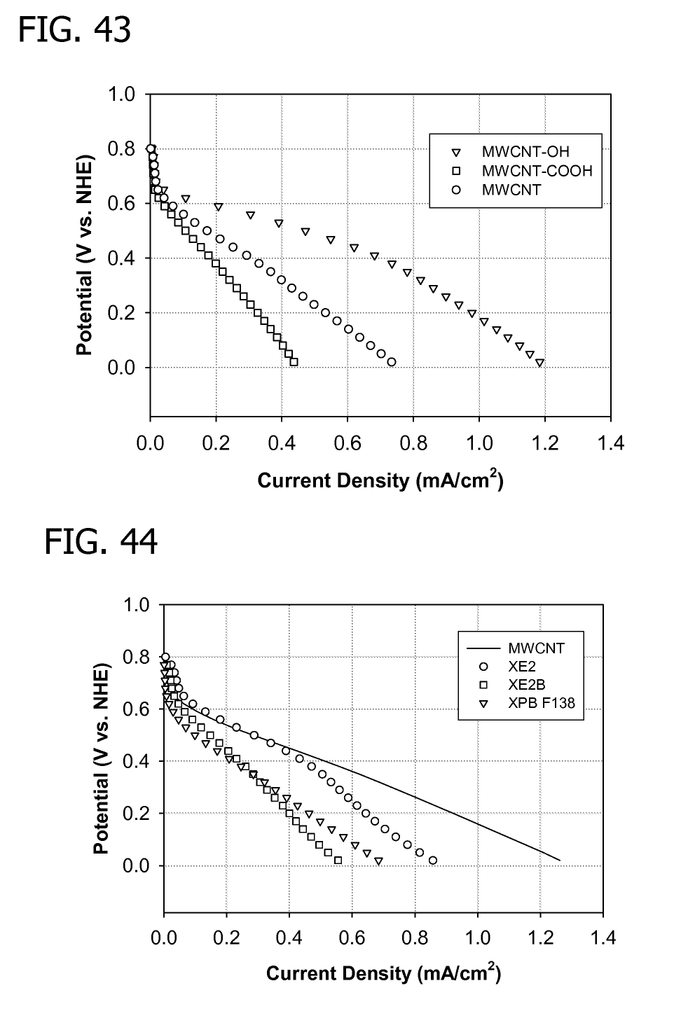

In order to obtain better direct electron transfer of enzymes, carbon nanotubes (CNTs) must be tailored for a certain enzymes. For bilirubin oxidase (BOD), MWCNTs perform better than single wall carbon nanotubes (SWCNTs). Among MWCNTs hydroxyl-functionalized MWCNTs outperform original MWCNTs and carboxyl-functionalized MWCNTs for BOD-catalyzed oxygen reduction reaction (ORR) at the air-breathing cathode, as shown in FIG. 43.

Carbon blacks (e.g. Degussa XE2, XE2B, XPB F138 et al) also facilitate direct electron transfer of enzymes. For example, BOD-catalyzed ORR at XE2-based gas diffusion electrode (GDE) is comparable with the one at MWCNT-based GDE in low current density region, and better than ones at XE2B and XPB F138-based GDEs, as shown in FIG. 44.

In an air-breathing biocathode, E-Tek carbon cloth (double sided water-proofing, DS) with water-proofing materials coated on both sides is one of the best-performing commercially available GDE materials. This GDE (E-Tek, DS) only has water-proofing treatment, which can be used in polymer electrolyte membrane (PEM) fuel cells to protect the cathode from flooding. However, in a biocathode, the cathode enzyme activity must be maintained to facilitate direct electron transfer and the GDE comes into direct contact with the electrolyte solution so there is ionic conductivity in the GDE, and concurrently allow sufficient ambient air to naturally diffuse (breath) through the GDE.

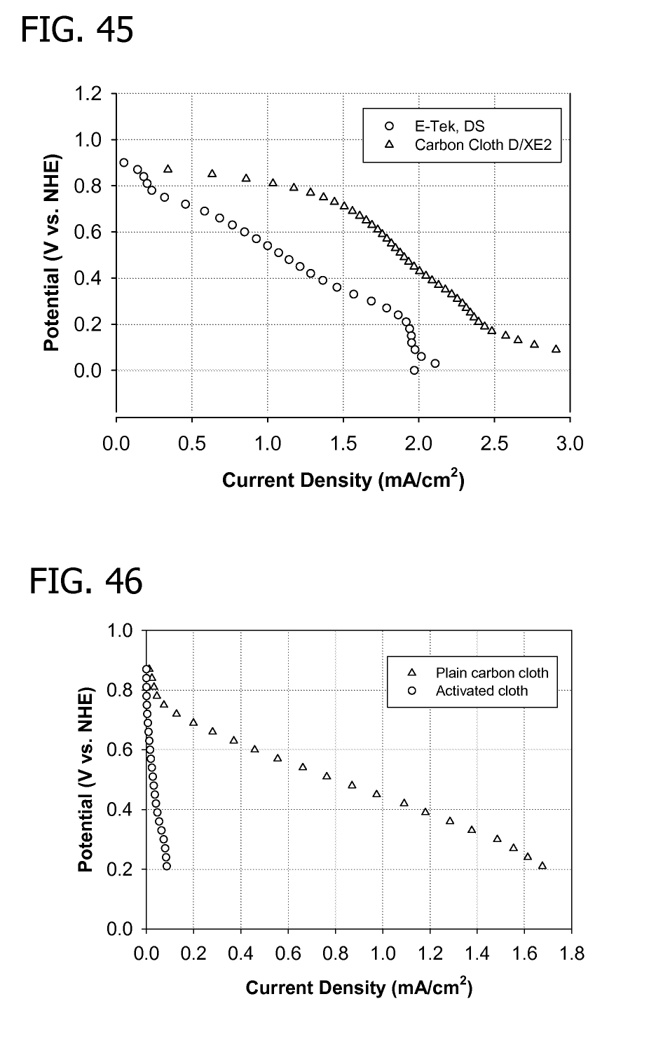

Therefore, a specific GDE must be designed for the biocathode. Using hydroxyl-functionalized MWCNT/BOD mixture that is immobilized on different GDEs, bio-cathode performances for ORR are significantly affected by these GDEs, as shown in FIG. 45. It has been demonstrated that Degussa XE2 carbon black and MWCNTs may efficiently facilitate direct electron transfer of BOD. These carbon materials and water-proofing materials (e.g. polytetraflyoroethylene (PTFE)) were utilized in preparation of in house GDEs. The dough of carbon material and PTFE were formed by mixing carbon blacks or MWCNTs with a PTFE suspension. Then the dough was coated on carbon clothes, carbon papers or porous carbon plates. The solvent in the coated film was evaporated by hot-pressing the film at a pressure of 50-10000 pounds at 50-120° C. The PTFE content in the coated film was varied from 0 wt. % to 80 wt. %. A more important step was that the pore distribution in the coated film was controlled by adding a pore-forming reagent (e.g. 0.1-20 wt. % ammonium carbonate solution) in the film and then heat-decomposing the reagent at 40-90° C. Finally, a desired GDE was obtained. The evaluation results indicate that 30% PTFE in carbon black XE2 based GDE exhibited optimum performance for BOD-catalyzed ORR, in particular, a significantly high current density was observed at high potential, e.g. 1 mA/cm² at 0.8 V, which is much higher than the E-Tek GDE (FIG. 45).

Similarly, laccase-catalyzed ORR can be obtained by immobilized laccase onto functionalized MWCNTs, which is coated on GDEs. Functional groups in carbon nanotubes include hydroxyl, carboxyl, thiol, and amino

In addition, without the presence of MWCNTs, BOD adsorbed on a plain carbon cloth does not exhibit efficient direct electron transfer and hence BOD-catalyzed ORR current at the cloth electrode is less than 0.1 mA/cm² at 0.2 V. However, the cloth can be activated by heating the cloth at temperatures between 500 and 900° C. for 1-20 minutes, then the hot cloth was dipped in cold water (0° C.) to cool down the cloth and then was dried completely in a vacuum oven at 40-100° C. Then, BOD was immobilized on the activated cloth. The BOD-activated cloth electrode exhibited a significantly high ORR current (1.7 mA/cm²) at 0.2 V (FIG. 46). The activation technique provided a useful means for facilitating direct electron transfer of enzymes.

### Example 16

### CuPCTSA-TBAB Coated poly(styrene-co-divinylbenzene)

In this example poly(styrene-co-divinylbenzene) particles were coated with a mixture of tetrabutylammonium bromide (TBAB)-modified Nafion® immobilization material and a water soluble dye that acts as an electron mediator for enzymatic reduction of oxygen to water. In order to prepare these particle, a dye solution of 0.080 g copper (II) phthalocyanine tetrasulphonic acid (CuPCTSA) in 4.00 mL TBAB modified Nafion® (5 wt %) in ethanol was combined with a particle suspension of 2.00 g poly(styrene-co-divinylbenzene) particles in 4.00 mL 0.5 M phosphate buffer, pH 7.2. The dye solution was added to the particle suspension and vortex mixed for several seconds until a substantially uniform mixture was achieved. The entire mixture was then airbrushed onto a polycarbonate shield. The mixture was allowed to dry on the shield for 20 minutes before being collected and stored dry in a scintillation vial.

The resulting coated particles were blue in color and retention of the dye was confirmed by packing the coated particles in a column and passing several hundred mL of water across them. No detectable levels of dye were found in the mobile phase eluting from the column. The thickness of the coating layer was designed to be 0.07 micron thick and the average diameter of the particles before coating was 8 microns. The surface area of the particles (pre-coated) was calculated to be 0.75 m/g². The resulting loading of the electron mediator was 4 wt %.

### Example 17

### Alcohol Dehydrogenase-TBATFB Coated Doped Polypyrrole/Carbon Black Composite

Doped polypyrrole/carbon black composite (Sigma, catalog number 530573) particles were coated with a mixture of tetrabutylammonium tetrafluoroborate (TBATFB)-modified Nafion® immobilization material and alcohol dehydrogenase enzyme. A solution of 0.080 g freeze dried alcohol dehydrogenase (ML57) and 2.00 mL 0.5 M phosphate buffer (pH 7.2) was prepared. A suspension of 4.00 mL TBATFB modified Nafion (5 wt %) in ethanol, 1.00 g doped polypyrrole/carbon black composite, and 4.00 mL 0.5 M phosphate buffer (pH 7.2) was prepared. The enzyme solution and the suspension were then vortex mixed for several seconds until a substantially uniform mixture was formed. The entire mixture was then airbrushed onto a polycarbonate shield in a process similar to Example 16. The resulting product was stored dry in a scintillation vial at 4° C.

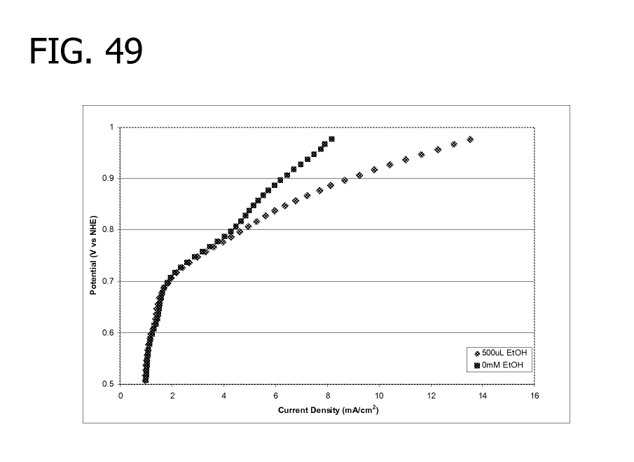

The resulting coated particles were black in color and retention of the enzyme activity was confirmed using standard spectrophotometric assay and electrochemical evaluation. The evaluation was made versus a normal hydrogen reference electrode (NHE). See FIG. 49. The resulting loading of the enzyme was 6.25 wt %.

### Example 18

### Alcohol Dehydrogenase-Ru(II)(NH₃)₆-TBATFB Coated Doped Polypyrrole/Carbon Black Composite

Doped polypyrrole/carbon black composite particles (Sigma, catalog number 530573) were coated with a mixture of TBATFB-modified Nafion®, alcohol dehydrogenase, and Ru(II)(NH₃)₆. Ru(II)(NH₃)₆ is an electron mediator for enzymatic oxidation of ethanol. A solution containing 0.080 g freeze dried alcohol dehydrogenase (ML59), 0.100 g Ru(II)(NH₃)₆, and 4.00 mL 0.5 M phosphate buffer (pH 7.2) was prepared. A suspension containing 6.00 mL 0.5 M phosphate buffer (pH 7.2), 2.00 mL TBATFB modified Nafion (5 wt %) in ethanol, and 2.00 g doped polypyrrole/carbon black composite was also prepared. The solution and suspension were combined and vortex mixed for several seconds to form a substantially uniform mixture. The entire mixture was then airbrushed onto a polycarbonate shield in a process similar to Example 16. The resulting product was stored dry in a scintillation vial at 4° C.

The resulting coated particles were black in color and retention of the enzyme activity was confirmed using standard spectrophotometric assay. The coating thickness was not calculated due to the unknown surface area of the particles. The resulting loading of the enzyme and electron mediator was 10.3 and 12.8 wt %, respectively.

### Example 19

### Starch-Consuming Amylase Enzyme Activity

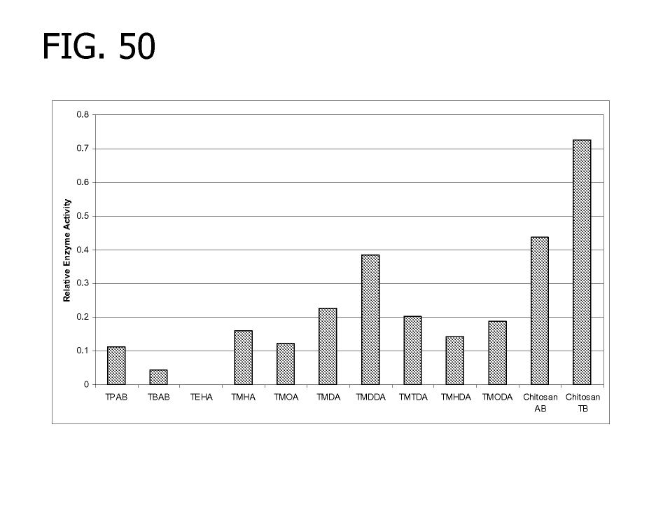

The enzymatic assay used for amyloglucosidase (EC 3.2.1.3) is published by Sigma and available at http://www.sigmaaldrich.com/img/assets/18200/Amyloglucosidase1.pdf and is based on the literature procedure described in Bergmeyer, H. U., Gawehn K., and Grassl, M. (1974) Methods of Enzymatic Analysis (Bergmeyer, H. U. ed.) Second Edition, Volume 1, 434-435. This procedure was modified slightly by immobilizing the amyloglucosidase with the desired enzyme immobilization material at the bottom of a cuvette rather than adding the amyloglucosidase to the solution. Enzyme immobilization materials tested were Nafion® modified with tetrapropropylammonium bromide (TPAB), tetrabutylammonium bromide (TBAB), triethylhexylammonium bromide (TEHA), trimethylhexylammonium (TMHA), trimethyloctylammonium (TMOA), trimethyldecylammonium (TMDA), trimethyldodecylammonium (TMDDA), trimethyltetradecylammonium (TMTDA), trimethylhexyldecylammonium (TMHDA), trimethyloctyldecylammonium (TMODA), butyl modified chitosan suspended in acetate buffer (Chitosan AB), and butyl modified chitosan suspended in t-amyl alcohol (Chitosan TB). The enzyme immobilization material that provided the greatest relative activity for the starch consuming amylase was butyl modified chitosan suspended in t-amyl alcohol (Chitosan TB). See FIG. 50.

### Example 20

### Maltose Consuming Amylase Enzyme Activity

The procedure described in Example 19 was used to determine the activity of maltose consuming amylase immobilized in various enzyme immobilization materials. The published procedure was modified as described in Example 19 and further modified by substituting maltose for starch. Enzyme immobilization materials tested were Nafion® modified with tetrapropropylammonium bromide (T3A), tetrabutylammonium bromide (TBAB), tetrapentylammonium bromide (T5A), triethylhexylammonium bromide (TEHA), trimethylhexylammonium (TMHA), trimethyloctylammonium (TMOA), trimethyltetradecylammonium (TMTDA), medium molecular weight decyl modified chitosan (Decyl M), low molecular weight butyl modified chitosan (Butyl L), low molecular weight octyl modified chitosan (Octyl L), and medium molecular weight butyl modified chitosan (Butyl M). The enzyme immobilization material that provided the greatest relative activity for the maltose consuming amylase was medium molecular weight decyl modified chitosan (Decyl M). See FIG. 51.

### Example 21

### Bioanode Catalyst Support 1

A bioanode catalyst support electrode with an expanded metal support and current collector and a polymer pore forming agent was prepared. The expanded metal support was used in preparing this formulation; the ratio of graphite fibers to conductive carbon black (1:4) and the ratio of polymeric binder to carbon solids (0.8:2.5) results in a structure that is highly conductive but is not self-supporting. Without the expanded metal, the carbon electrode could break during handling and thus, could not be considered for MEA fabrication. The materials used for this electrode are the preferred materials, but other substitutions can be made for the carbon black and binder materials (Tables 1 and 3).

The dry components of the GDL paste were 4.00 g Monarch 1400 carbon black (Cabot), 1.00 g Milled XN-100 graphite fibers, 150 micron long (Nippon Graphite Fiber), 1.60 g poly(vinylidene fluoride) powder as polymeric binder (Sigma), and 2.00 g poly(ethylene glycol) 8,000 molecular weight as the polymeric pore forming agent (Sigma). The dry components were mixed in a food processor for 1 minute. The solvent of the GDL paste was 4.00 mL ethanol and was added incrementally until the desired consistency was reached.

The dry components were combined with a spatula in a small beaker until the mixture reached the consistency of toothpaste. The paste was then pasted into the expanded metal and frame structure, described above, and sintered at 180° C. for 20 minutes. The frames were removed and the electrodes were soaked in distilled (DI) water for 30 minutes with periodic water replacements. This step was necessary to remove the pore forming inclusion, poly(ethylene glycol), within the electrode structure. The electrodes were then sintered again at 200° C. for 10 minutes. The electrodes were cooled to room temperature and were ready for use as a bioanode catalyst support and electrode. The resulting electrodes were rigid, could be cut with scissors, and soak up water and electrolyte readily. The in-plane conductivity was ˜125% relative to that of commercial GDL materials.

### Example 22

### Bioanode Catalyst Support 2

A bioanode catalyst support electrode with an expanded metal support and current collector and a polymer pore forming agent was prepared. The expanded metal support was unnecessary for this formulation due to the equal ratio of graphite fibers to conductive carbon black and the higher ratio of polymeric binder to carbon solids (1:2). This formulation resulted in a structure that is slightly less conductive than the bioanode catalyst support Example 21, but unlike that support, it was self-supporting. This electrode material can be wet but does not adsorb electrolyte like the previous example due to the lack of pore forming agents in the formulation. This type of electrode can be handled in a similar fashion as commercial GDL and can be considered for MEA fabrication. The materials used for this electrode are the preferred materials, but other substitutions can be made for the carbon black and binder as detailed in (Tables 1 and 3).

The dry components of the GDL paste were 3.00 g Monarch 1400 carbon black (Cabot), 3.00 g DKDX graphite fibers, 150 micron long (Cytec Carbon Fibers), 3.00 g poly(vinylidene fluoride) powder (Sigma). The dry components were mixed in a food processor for 1 minute. The solvent of the GDL paste was 3.00 mL n-propanol and was added incrementally until the desired consistency was reached.

The dry components were combined with a spatula in a small beaker until the mixture reached a consistency of toothpaste. The paste was then pasted into the frame structure and PTFE coated fiberglass sheet structure, described above, and sintered at 200° C. for 20 minutes. The electrodes were cooled to room temperature and were ready for use as a bioanode catalyst support and electrode. The resulting electrodes were rigid, could be cut with scissors, and water adequately wetted the GDL surface. The in-plane conductivity was ˜75% relative to that of commercial GDL materials.

### Example 23

### Bioanode Catalyst Support 3

A bioanode catalyst support electrode with a mesoporous carbon inclusion and pore forming agent was prepared to promote greater electrolyte/electrode interaction and to increase the available electrode surface area for enzyme catalyst loading. This formulation used a ratio of graphite fibers to conductive carbon black to mesoporous carbon of 2:1:1 and a ratio of polymeric binder to carbon solids of 1:3. The resulting structure that was comparable in electrical conductivity to that of bioanode catalyst support 2. This electrode material could be wetted and absorbed electrolyte and enzyme casting inks better than other examples and listed commercial GDL materials due to the pore forming agents and mesoporous carbon in the formulation. This type of electrode could be handled similarly to commercial GDL and could be used in MEA fabrication. The materials used for this electrode were the preferred materials, but other substitutions could be made for the carbon black and binder (Tables 1 and 3).

The dry components of the GDL paste were 1.50 g Monarch 1400 carbon black (Cabot), 3.00 g DKDX graphite fibers, 150 micron long (Cytec Carbon Fibers), 1.50 g Chemsorb 1505 G5 porous, impregnated steam activated carbon (C*Chem), 2.00 g poly(vinylidene fluoride) powder (Sigma), and 1.50 g poly(ethylene glycol) 8,000 molecular weight (Sigma). The activated carbon was briefly ground by hand using a ceramic mortar and pestle before its incorporation and the dry components were mixed in a food processor for 1 minute. The solvent was ˜3.00 mL n-propanol and was added incrementally until the desired consistency was reached.

The dry components were combined with a spatula in a small beaker until the mixture reached a consistency of toothpaste. The paste was then spread into the frame structure and PTFE coated fiberglass sheet structure and sintered at 200° C. for 20 minutes. The frames were removed and the electrodes were soaked in DI water for 30 minutes with periodic water replacements to remove the poly(ethylene glycol). The electrodes were then sintered again at 200° C. for 10 minutes. The electrodes were cooled to room temperature and were ready for use as a bioanode catalyst support and electrode. The resulting electrodes were rigid, could be cut with scissors, and acceptably soaked up water and electrolyte. The in-plane conductivity was ˜50% relative to that of commercial GDL materials.

### Example 24

### Bioanode Catalyst Support 4

A bioanode catalyst support electrode similar to Bioanode Catalyst Support 2 in physical properties, but differs in the use of carbon black conductivity component and the use of a pore forming agent. This bioanode catalyst support includes a doped conductive polymer that is chemically grafted onto the carbon black material and a pore forming agent that thermally decomposes during sintering. The use of the new pore forming agent reduces the process time for fabrication and eliminates the water soak and second sintering steps. This electrode material could be wetted, adsorbed electrolyte like the previous examples, and could participate in the electron transfer reaction between the enzyme and the electrode. This type of electrode could be handled similarly to a commercial GDL and could be used in MEA fabrication. The materials used for this electrode were the preferred materials, but other substitutions could be made for the carbon black and binder (Tables 1 and 3).

The dry components of the GDL paste were 3.00 g Monarch 1400 carbon black grafted with 8-hydroxypyrene trisulfonic acid doped poly(pyrrole), 3.00 g DKDX graphite fibers, 150 micron long (Cytec Carbon Fibers), 3.00 g poly(vinylidene fluoride) powder (Sigma), and 2.00 g ammonium carbonate (Sigma). These dry components were mixed in a food processor for 1 minute. The solvent in the GDL paste was ˜4.00 mL ethanol and was added incrementally until the desired consistency was reached.

The dry components were combined with a spatula in a small beaker until the mixture reached a consistency of toothpaste. The paste was then pasted into the frame structure and PTFE coated fiberglass sheet structure, described above, and sintered at 180° C. for 20 minutes. The electrodes were cooled to room temperature and were ready for use as a bioanode catalyst support and electrode. The resulting electrodes were rigid, could be cut with scissors, and the surface would wet with water. The in-plane conductivity was 75% relative to that of commercial GDL materials.

### Example 25

### Biocathode Catalyst Support 1

A biocathode catalyst support electrode using a polymer pore forming agent to increase the surface area of the electrode for enzyme interaction and to improve mass transport of products and reactants of the cathode reaction was prepared. The use of an expanded metal support was not needed for this formulation because the ratio of graphite fibers to conductive carbon black and the higher ratio of polymeric binder to carbon solids (˜1:2) resulted in a structure that is self-supporting. This structure also exhibits conductivity similar to commercial carbon cloth GDL materials. This electrode material was very hydrophobic but could be wetted by alcohol mixtures of enzyme and ionomer during enzyme deposition. A micro pore forming agent in this electrode was used to improve surface area for better enzyme electrode interaction. It was found that a cathode electrode fabricated with just PTFE as a binder was very hydrophobic, but was easily broken during handling. This problem was avoided by substituting a small percentage of the PTFE binder mass in the formulation with PVDF. This type of electrode was handled similarly to a commercial GDL and used in MEA fabrication. The materials used for this electrode were preferred materials, but other substitutions could be made for the carbon black and binder (Tables 1 and 3).

The dry components of the GDL paste were 4.00 g Monarch 1400 carbon black (Cabot), 4.00 g DKDX graphite fibers, 150 micron long (Cytec Carbon Fibers), 1.50 g poly(vinylidene fluoride) powder (Sigma), 3.00 g polytetrafluoroethylene powder (Sigma), and 2.00 g ammonium bicarbonate (Sigma). The dry components were mixed in a food processor for 1 minute. The solvent component of the GDL paste was ˜3.00 mL n-propanol and was added incrementally until the desired consistency was reached.

The dry components were combined with a spatula in a small beaker until the mixture reaches a consistency of toothpaste. The paste was then pasted into the frame structure and PTFE coated fiberglass sheet structure, described above, and sintered at 200° C. for 20 minutes. The electrodes were cooled to room temperature and were then sintered again at 300° C. for 10 minutes. The electrodes were cooled to room temperature and were ready for use as a biocathode catalyst support and electrode. The resulting electrodes were somewhat rigid, could be cut with scissors, and the surface was very hydrophobic. The in-plane conductivity was ˜50% relative to that of commercial GDL materials.

### Example 26

### Biocathode Catalyst Support 2

A biocathode catalyst support electrode that was similar in physical properties as Biocathode Catalyst Support 1 but differed in the use of carbon black conductivity component and the ratios of PVDF to PTFE. This support material incorporated a doped conductive polymer that was chemically grafted onto the carbon black material. This doped conductive polymer was carefully grafted in such a way that it formed nano-whisker structures that were useful in interacting with the metal center of the enzyme where electron transfer occurs for greatly improved direct electron transfer rates. When this modified carbon was used, the 300° C. sintering temperature step in Example 25 was removed to prevent softening or melting the polymer nanostructures and the ratio of binders were altered to increase the PVDF and decrease the PTFE because PTFE required higher sintering temperatures. This electrode material was hydrophobic with partial hydrophilicity, had a high surface area, and facilitated the direct electron transfer reaction between the enzyme and the electrode. This type of electrode was handled similarly to commercial GDL and was used in MEA fabrication. The materials used for this electrode were preferred materials, but other substitutions could be made for the carbon black, pore forming agents, and binder (Tables 1 and 3).

The dry components of the GDL paste were 4.00 g Monarch 1400 carbon black grafted with 1-(3-Sulfopropyl)pyridinium hydroxide inner salt doped poly(pyrrole) nano-whiskers, 4.00 g DKDX graphite fibers, 150 micron long (Cytec Carbon Fibers), 3.00 g poly(vinylidene fluoride) powder (Sigma), 1.00 g polytetrafluoroethylene powder (Sigma), and 2.00 g ammonium carbonate (Sigma). The dry components were mixed in a food processor for 1 minute. The solvent component used in the GDL paste was ˜4.00 mL ethanol and was added incrementally until the desired consistency was reached.

The dry components were combined with a spatula in a small beaker until the mixture reached a consistency of toothpaste. The paste was then pasted into the frame structure and PTFE coated fiberglass sheet structure, described above, and sintered only once at 200° C. for 20 minutes. The electrodes were cooled to room temperature and were ready for use as a biocathode catalyst support and electrode. The resulting electrodes were somewhat rigid, could be cut with scissors, and the surface was very hydrophobic. The in-plane conductivity was ˜50% relative to that of commercial GDL materials.

### Example 27

### Biocathode Catalyst Support 3

A bi-layer biocathode catalyst support electrode having air-breathing and enzyme sides and having an expanded metal support as a current collector was prepared. The expanded metal support was necessary for this formulation due to the combinations of electrode layers and the low ratio of polymeric binder to carbon solids (e.g., 1:10) on the enzyme side of the electrode. A preferred configuration is having a microporous and slightly hydrophilic structure on the enzyme side of the electrode to increase the interaction between the enzyme and electrolyte, but also providing a dense, air permeable, and hydrophobic structure on the air side in order to manage water and retain electrolyte in the cell. This was accomplished by using a bi-layer structured electrode. This bi-layer electrode required a multi-step fabrication and sintering process. The materials used for this electrode were the preferred materials, but other substitutions could be made for the carbon black and binder (Tables 1 and 3).

The dry components of the GDL paste for the air-breathing side of the electrode were 4.00 g Monarch 1400 carbon black (Cabot), 1.00 g Milled XN-100 graphite fibers, 150 micron long (Cytec Carbon Fibers), and 2.50 g polytetrafluoroethylene powder (Sigma). These dry components were mixed in a food processor for 1 minute. The solvent used in the GDL paste was ˜4.00 mL 1-propanol and was added incrementally until the desired consistency was reached.

The dry components of the GDL paste for the enzyme side of the electrode were 2.00 g Conductive Polymer Modified Monarch 1400 carbon black (Cabot), 0.50 g Milled XN-100 graphite fibers, 150 micron long (Cytec Carbon Fibers), 0.25 g polytetrafluoroethylene powder (Sigma), and 1.00 g ammonium carbonate (Sigma). These dry components were mixed in a food processor for 1 minute. The solvent used in the GDL paste was ˜4.00 mL 1-propanol and was added incrementally until the desired consistency was reached.

The dry components for the Air-Breathing Side Paste were combined with the solvent using a spatula in a small beaker until the mixture reached a consistency of toothpaste. The paste was then pasted into one side of the expanded metal and frame structure, described in the Bioanode Section, and sintered at 300° C. for 20 minutes. The electrodes were allowed to cool and the dry components for the Enzyme Side Paste were combined with the solvent using a spatula in a small beaker until the mixture reached a consistency of toothpaste. The paste was then pasted into opposite side of the expanded metal and frame structure as the Air Breathing Side and sintered a second time at 200° C. for 20 minutes. The electrodes were cooled to room temperature and were ready for use as a biocathode catalyst support and electrode. The resulting electrodes were hydrophobic on one side and hydrophilic on the other side where the enzyme layer was painted.

### Example 28

### Comparisons with Commercial GDL Materials

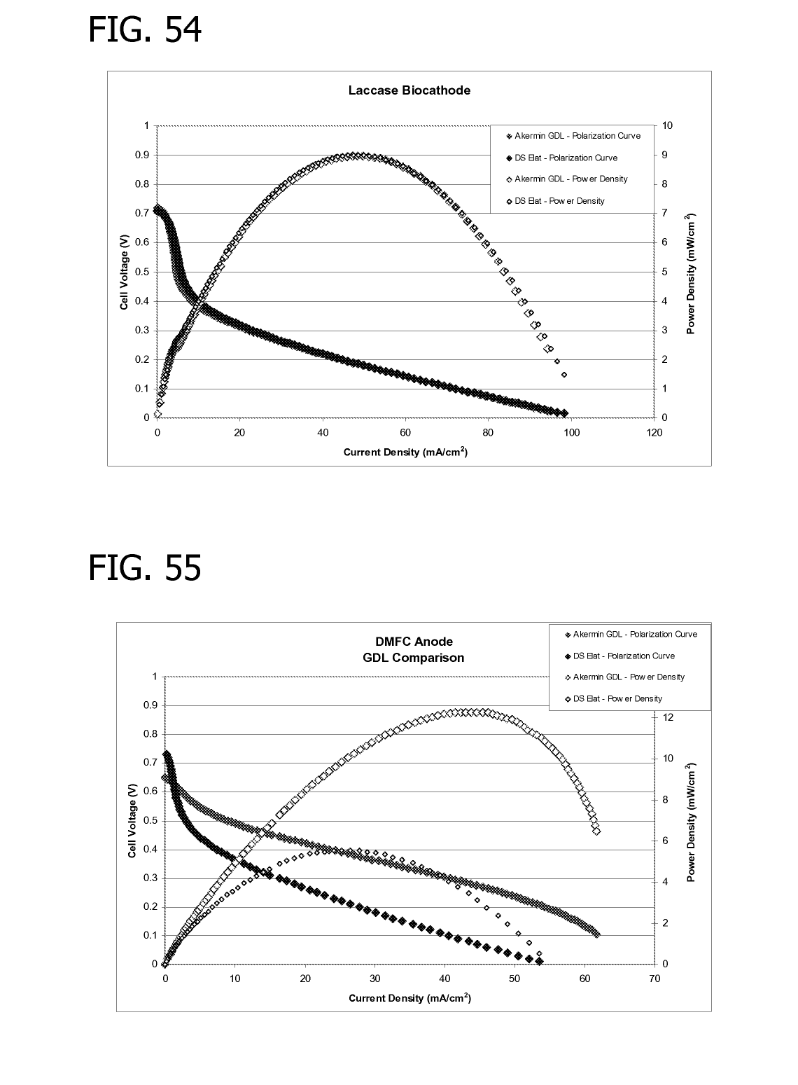

A comparison of Biocathode Catalyst Support 1 and a commercial cathode GDL of Double Sided Elat (BASF), is given in FIG. 54 for a laccase based biocathode with oxygen as the oxidant and a platinum black on Elat anode fueled with hydrogen. Nafion 115 was used as the polymer electrolyte membrane in this hot-pressed MEA. The activity of the biocathode was based on DET and there was no electron transfer mediator present in the catalyst layer. The two systems compared similarly across the polarization range. The biocathode support layer was a uniform biocathode support layer and was not optimized for mass transport of products or reactants. Further, no pore forming agents were used, which resulted in a decreased surface area.

A comparison of Bioanode Catalyst Support 3 and a commercial anode GDL of Double Sided Elat, is given in FIG. 55 for a platinum-ruthenium black anode with 5.0% methanol as the fuel and a platinum black on Elat cathode with oxygen as the oxidant. Nafion 115 was used as the polymer electrolyte membrane in this MEA. The prepared GDL outperformed the commercial material across the polarization curve with the exception of the open circuit voltage region. This may be the result of increased contact of the fuel solution to the membrane due to the hydrophilic, microporous structure of the fabricated GDL, resulting in increased depolarization of the cathode due to greater cross over of the fuel.

### Example 29

### 1-(3-Sulfopropyl)pyridinium Hydroxide Doped Polyaniline Nanowires Grafted on Carbon Black Particles

To prepare the modified carbon black particles, 300 mL deionized water was transferred into a one-liter size beaker, and placed the beaker in an ice-bath. Glacial acetic acid (10 mL, 99%, Sigma) was added into the beaker and continuously stirred for 20 minutes to lower the temperature of the liquid in the beaker, preferably close to 5° C. After the temperature of acidic solvent reached to 5° C., 40 grams of Monarch 1400 (Cabot) carbon black was added into the acidic solvent. This carbon slurry was continuously stirred for 10 minutes. Then, a mixture of 8 grams of 1-(3-Sulfopropyl)pyridinium hydroxide inner salt (Sigma) dissolved in 50 mL deionized water was added. This mixture was stirred for 20 minutes. Aniline monomer (10 mL, Sigma) was added dropwise to the above mixture and the whole mixture was stirred for another 20 minutes. To start the polymerization of aniline, a mixture of 18 grams of ammonium persulfate (Sigma) dissolved in 60 mL deionized water was added dropwise over the course of two hours. It is preferred that the reaction medium temperature not rise above 5° C. at this stage, otherwise, macroscopic fibers will be obtained instead of nanowires. Once all of the ammonium persulfate solution was added, the slurry was continuously stirred for 24 hours in the ice bath. After the first 24 hours stirring, a mixture of 8 grams of 1-(3-Sulfopropyl)pyridinium hydroxide inner salt dissolved in 50 mL deionized water was added. This mixture was stirred for 20 minutes. 10 mL of aniline monomer was added dropwise to the above mixture and the whole mixture was stirred for another 20 minutes. To start the polymerization of aniline, a mixture of 18 grams of ammonium persulfate dissolved in 60 mL deionized water was added dropwise over the course of two hours. It is preferred that the reaction medium temperature should not rise above 5° C. at this stage, otherwise, macroscopic fibers will be obtained instead of nanowires. Once all of the ammonium persulfate solution was added, the slurry was continuously stirred for 24 hours in the ice bath. At the end of the second 24 hours stirring in the ice bath, the carbon slurry was vacuum filtered and washed with copious amounts of water to remove the acid. Then, the modified carbon was dried under vacuum at 100° C. for 10 hours.

### Example 30

### 1,5-Naphthalenedisulfonic Acid Doped Polyaniline Nanowires Grafted on Carbon Black Particles

Deionized water (300 mL) was transferred into a one-liter size beaker and the beaker was placed in an ice-bath. Glacial acetic acid (10 mL, 99%) was added into the beaker and continuously stirred for 20 minutes to lower the temperature of the liquid in the beaker, preferably close to 5° C. After the temperature of acidic solvent reached to 5° C., 40 grams of Monarch 1400 (Cabot) carbon black was added into the acidic solvent. This carbon slurry was continuously stirred for 10 minutes. Then, a mixture of 8 grams of 1,5-naphthalenedisulfonic acid tetrahydrate (97%, Sigma) dissolved in 50 mL deionized water was added. This mixture was stirred for 20 minutes. Aniline monomer (10 mL) was added dropwise to the above mixture and stirred the whole mixture for another 20 minutes. To start the polymerization of aniline, a mixture of 18 grams of ammonium persulfate dissolved in 60 mL deionized water was added dropwise over the course of two hours. It is preferred that the reaction medium temperature should not rise above 5° C. at this stage, otherwise, macroscopic fibers will be obtained instead of nanowires. Once all of the ammonium persulfate solution was added, the slurry was continuously stirred for two hours in the ice bath. The carbon slurry was vacuum filtered and washed with copious amounts of water to remove the acid. Then, the modified carbon was dried under vacuum at 100° C. for 10 hours.

### Example 31

### 2-Naphthalenesulfoniuc Acid Doped Polyaniline Nanowires Grafted on Carbon Black Particles

Deionized water (300 mL) was transferred into a one-liter size beaker, and the beaker was placed in an ice-bath. Glacial acetic acid (10 mL, 99%) was added into the beaker and was continuously stirred for 20 minutes to lower the temperature of the liquid in the beaker, preferably close to 5° C. After the temperature of acidic solvent reached to 5° C., 40 grams of Monarch 1400 (Cabot) carbon black was added into the acidic solvent. This carbon slurry was continuously stirred for 10 minutes. Then, a mixture of 8 grams of 2-naphthalenesulfonic acid (70%, Sigma) dissolved in 50 mL deionized water was added. This mixture was stirred for 20 minutes. Aniline monomer (10 mL) was added dropwise to the above mixture and the whole mixture was stirred for another 20 minutes. To start the polymerization of aniline, a mixture of 18 grams of ammonium persulfate dissolved in 60 mL deionized water was added dropwise over the course of two hours. It was preferred that the reaction medium temperature not rise above 5° C. at this stage, otherwise, macroscopic fibers will be obtained instead of nanowires. Once all of the ammonium persulfate solution was added, the slurry was continuously stirred for two hours in the ice bath. The carbon slurry was vacuum filtered and washed with copious amounts of water to remove the acid. Then, the modified carbon was dried under vacuum at 100° C. for 10 hours.

### Example 32

### 1-(3-Sulfopropyl)pyridinium Hydroxide Doped Polyaniline Nanowires Grafted on Carbon Black Particles

Deionized water (300 mL) was transferred into a one-liter size beaker and the beaker was placed on a stir plate. Glacial acetic acid (10 mL, 99%) was added into the beaker and continuously stirred for 20 minutes at room temperature (approximately 24° C.). Black Pearls 2000 carbon black (20 grams, Cabot) was added into the acidic solvent. This carbon slurry was continuously stirred for 30 minutes. Then, a mixture of 8 grams of 1-(3-Sulfopropyl)pyridinium hydroxide inner salt (Sigma) dissolved in 50 mL deionized water was added. This mixture was stirred for 20 minutes and 10 mL of aniline monomer was added dropwise to the above mixture and the whole mixture was stirred for another 20 minutes. To start the polymerization of aniline, a mixture of 10 grams of ferric (III) chloride dissolved in 60 mL deionized water was added dropwise over the course of two hours. Once all of the ferric chloride solution was added, the slurry was continuously stirred for two hours at room temperature. The carbon slurry was vacuum filtered and washed with copious amounts of water to remove the acid. Then, the modified carbon was dried under vacuum at 100° C. for 10 hours.

### Example 33

### Sulfonated 1-(3-Sulfopropyl)pyridinium Hydroxide Doped Polyaniline Nanowires Grafted on Carbon Black Particles for High Power Output Biocathode

Deionized water (300 mL) was transferred into a one-liter size beaker and the beaker was placed in an ice-bath. Glacial acetic acid (10 mL, 99%, Sigma) was added into the beaker and continuously stirred for 20 minutes to lower the temperature of the liquid in the beaker, preferably close to 5° C. After the temperature of acidic solvent reached to 5° C., 40 grams of Monarch 1400 (Cabot) carbon black was added into the acidic solvent. This carbon slurry was continuously stirred for 10 minutes. Then, a mixture of 8 grams of 1-(3-Sulfopropyl)pyridinium hydroxide inner salt (Sigma) dissolved in 50 mL deionized water was added. This mixture was stirred for 20 minutes and 10 mL of aniline monomer (Sigma) was added dropwise to the above mixture and stirred the whole mixture for another 20 minutes. To start the polymerization of aniline, a mixture of 18 grams of ammonium persulfate (Sigma) dissolved in 60 mL deionized water was added dropwise over the course of two hours. It was preferred that the reaction medium temperature should not rise above 5° C. at this stage, otherwise, macroscopic fibers will be obtained instead of nanowires. Once all of the ammonium persulfate solution was added, the slurry was continuously stirred for 24 hours in the ice bath. After the first 24 hours stirring, a mixture of 6 mL concentrated sulfuric acid (97%) and 12 mL of glacial acetic acid (97%) were added dropwise while the beaker was still in the ice-bath. The slurry was stirred for one hour, and then vacuum filtered and washed with copious amounts of water. Finally, the modified carbon was dried under vacuum at 100° C. for 10 hours.

### Example 34

### Encapsulated Enzyme/Carbon Diffusion Electrode 1: ADH Immobilized Anode Half Cell

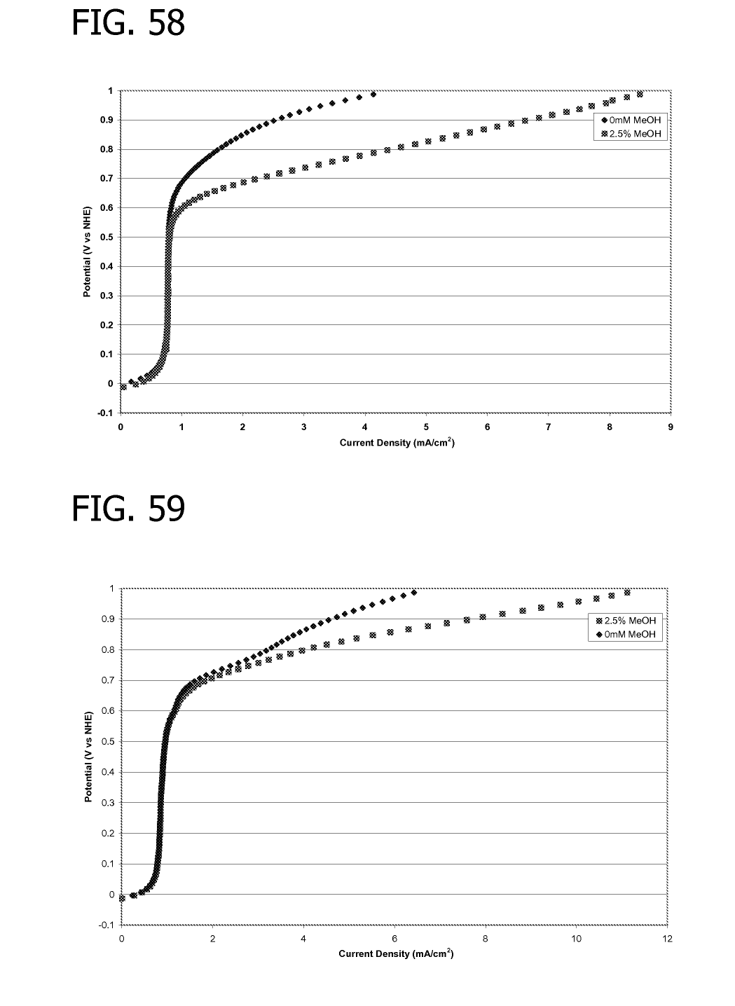

Alcohol dehydrogenase was encapsulated onto a carbon black powder, dried, and pasted into an electrode via the procedure described above. PVDF was used as binder, DKDX graphite fibers were used to give the electrode rigidity, Printex XE 2 was used as filler, and poly(ethylene)glycol was the hydrophilic agent. The paste formulation was 0.5 g ADH encapsulated carbon, 0.45 g Printex XE 2, 0.25 g DKDX, 0.25 g PVDF, and 0.5 g Poly(ethylene)glycol. Methanol was mixed into the paste in a sufficient quantity to give it a thick consistency and electrodes were made according to the procedure described in Example 21. The half cell was then tested for enzymatic response to methanol to verify enzyme activity, which showed positive response. The results are given in FIG. 58.

The half cell testing was done in 1 M phosphate buffer at pH 7.2 with and without methanol. As is shown in FIG. 58, roughly 5 mA of response was observed via direct electron transfer.

### Example 35

### Encapsulated Enzyme/Carbon Diffusion Electrode 2: Mediated ADH Immobilized Anode Half Cell

Alcohol dehydrogenase was encapsulated onto a carbon black powder, dried, and pasted into an electrode via the procedure described above. The components were the same as described for Encapsulated Enzyme/Carbon Diffusion Electrode 1 in example 34. The paste formulation was 1.09 g ADH encapsulated carbon, 0.5 g DKDX, 0.5 g PVDF, and 0.5 g Poly(ethylene)glycol. Methanol was mixed into the paste in a sufficient quantity to give it a thick consistency and electrodes were made according to the procedure described above. Without the Printex XE 2 carbon filler in the formulation, it was necessary to use a mediator to observe enzymatic response. For this example, Hexamine ruthenium(III) chloride (Sigma) was used in solution. It was also possible to encapsulate soluble mediators with the enzyme and observe a response. The results are shown in FIG. 59.

As is illustrated in FIG. 59, the electrode was able to show a catalytic response at the mediator peak around 0.65 V versus NHE.

### Example 36

### Biocathode Ink Formulation 1: Immobilized Enzyme onto an ELAT GDL Support

Electrodes were painted onto an ELAT support structure using enzyme encapsulated carbon. In one ink formulation, plain carbon black particles were used as filler material in the ink, where the other formulation simply had enzyme encapsulated carbon and Nafion solution. The carbon filler-based ink formulation included 160 mg Laccase encapsulated carbon, 320 mg Monarch 1400, and 2.0 mL of 5% Nafion solution. The ink formulation with no carbon filler included 160 mg Laccase encapsulated carbon and 0.667 mL of 5% Nafion solution.

During the ink making process first the enzyme encapsulated solution was added to a plastic vial. Next, the carbon filler was added and vortexed for approximately 30 seconds. Nafion solution was added and the slurry was stirred with a spatula until all of the particles were wet. Before painting onto the electrode support, the ink was mixed with a Fisher Scientific Sonicating Dismembrator for as little time as necessary to make an even consistency ink. The inks were painted onto double sided ELAT and they were then pressed onto Nafion 115 membrane opposing a platinum black electrode at 125° C. for 35 seconds.

The data in FIG. 60 was gathered using 24 Unit/mg laccase loaded onto the electrode at 0.500 mg/cm² loading. The electrode without any carbon filler illustrated direct electron transfer (DET) and an electron mediator was not required to obtain power, however, use of a highly conductive high surface area carbon into the ink formulation could greatly enhance the overall power density and current density provided by the cell. Advantageous carbon fillers are, for example, Monarch 1400, Black Pearls 1300, Printex XE 2, and Vulcan XC-72. Other acceptable carbon blacks are listed in FIG. 60. Using carbon blacks as filler in the catalyst ink, current densities greater than 85 mA/cm² were obtained. Key parameters impacting the performance of the cathode electrodes were amount of carbon black, operating temperature, specific activity of the immobilized laccase enzyme, thickness of encapsulating immobilization polymer layer, and the amount of 5% Nafion solution.

### Example 37

### Biocathode Ink Formulation 2: Varying the Amount of Carbon Filler in the Ink Formulation

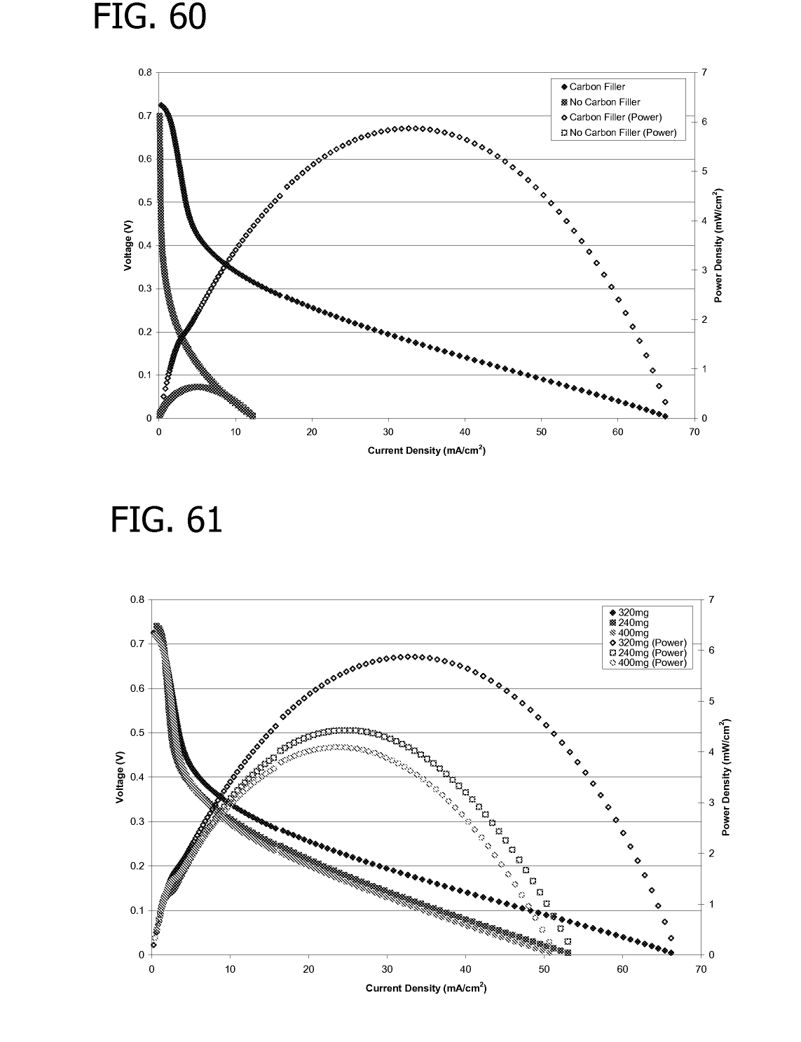

Increasing the amount of carbon black increased the performance of the electrode as shown in FIG. 61 until a critical enzyme based catalyst layer thickness was reached where the performance began to degrade due to reactant and proton transport limitations. Three electrode formulations were chosen, using 320 mg, 240 mg, and 400 mg of Monarch 1400 carbon to help support direct electron transfer to the enzyme. The 320 mg Carbon Filler Ink Formulation was prepared from 160 mg Laccase encapsulated carbon, 320 mg Monarch 1400, and 2.0 mL of 5% Nafion solution. The 240 mg Carbon Filler Ink Formulation was prepared from 160 mg Laccase encapsulated carbon, 240 mg Monarch 1400, and 2.0 mL of 5% Nafion solution. The 400 mg Carbon Filler Ink Formulation was prepared from 160 mg Laccase encapsulated carbon, 400 mg Monarch 1400, and 2.0 mL of 5% Nafion solution.

The ink formulations were prepared as described in Example 36 where the dry carbon was vortexed with the enzyme encapsulated carbon prior to adding the Nafion solution. The inks were then sonicated and painted onto ELAT. They were pressed onto Nafion 115 membrane opposing a platinum black electrode at 125° C. for 35 seconds.

When using Monarch 1400 carbon black, the critical thickness was observed at 480 mg total carbon weight. The total carbon weight necessary to reach the critical layer thickness was dependent on the carbon used for enzyme immobilization and as filler. For example, if a more dense carbon was used, the total acceptable carbon weight would be higher before performance diminished due to ink thickness. As shown in FIG. 61, when increasing the carbon black content from 240 mg to 400 mg in 80 mg increments, a peak loading occurs at 320 mg (˜13 mg/cm²). For these runs, 0.500 mg/cm² enzyme loading of 24 Unit/mg laccase was used.

### Example 38

### Biocathode Ink Formulation 3: Varying the Type of Carbon Black Used as Filler

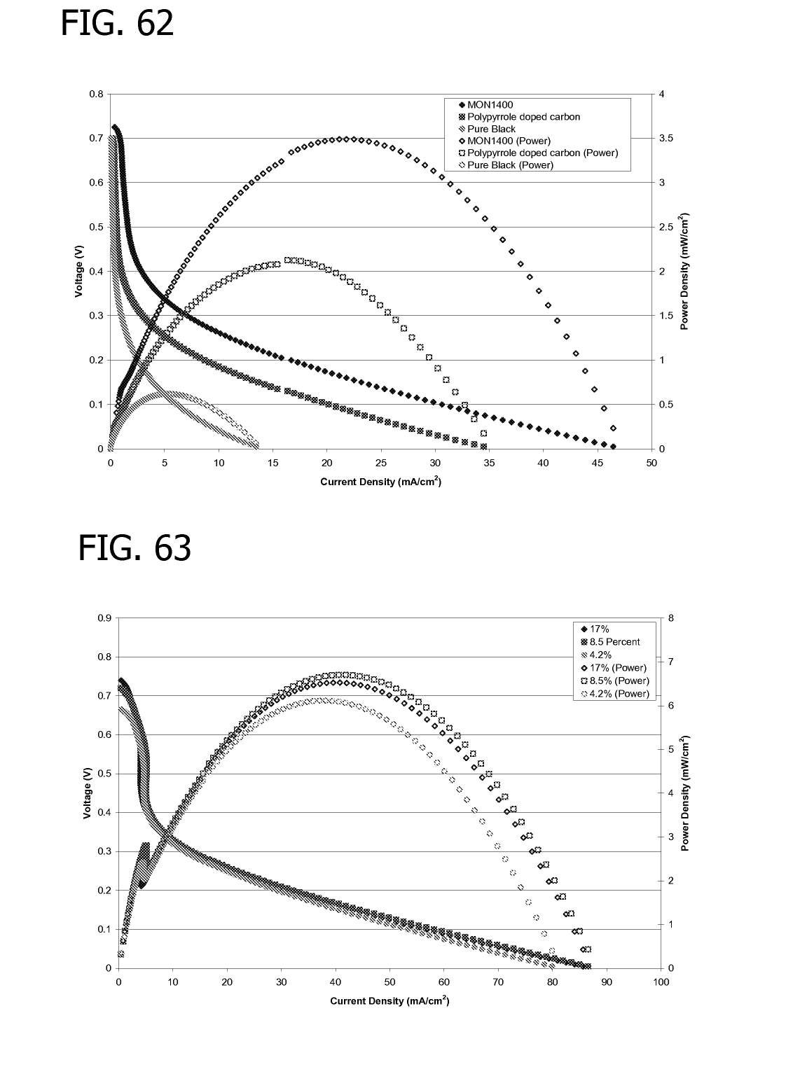

Three carbon blacks were chosen to illustrate the variation the type of carbon can have on the overall performance of the cell. Monarch 1400, Pure Black 115, and Polypyrrole doped carbon black are compared in FIG. 62. The ink formulations are given below.

The Monarch 1400 carbon filler ink formulation was prepared from 80 mg Laccase encapsulated carbon, 80 mg Monarch 1400, and 1.0 mL of 5% Nafion solution. The polypyrrole doped carbon black carbon filler ink formulation was prepared from 80 mg Laccase encapsulated carbon, 80 mg polypyrrole doped carbon black, and 1.0 mL of 5% Nafion solution. The Pure Black 115 ink formulation was prepared from 80 mg Laccase encapsulated carbon, 80 mg Pure Black 115, and 1.0 mL of 5% Nafion solution.

As previously described, where the dry carbon was vortexed with the enzyme encapsulated carbon prior to adding the Nafion solution. The inks were then sonicated and painted onto ELAT. They were then pressed onto Nafion 115 membrane opposing a platinum black electrode at 125° C. for 35 seconds.

When considering the carbon black as filler in the enzyme based catalyst inks, the conductivity, surface area, and presence of a polymer doping graft can impact the overall performance of the electrode. Several carbon blacks were tested as filler to improve the cell performance, and Monarch 1400 is preferred. However, any carbon black can be implemented as a replacement for Monarch 1400 to improve enzyme interaction with the current collector as shown in FIG. 62. All carbon blacks perform better than enzyme alone, but each possesses different optimization parameters that should be taken into account. Three types of the various carbon species tested are displayed in FIG. 62 with all the parameters equivalent except for the type of carbon used as filler. The enzyme loading for the power curves in FIG. D.11 was 0.250 mg/cm². Other carbons that were tested are given in Table 1.

### Example 39

### Biocathode Ink Formulation 4: Immobilization Layer Thickness Evaluation

To test the immobilization layer thickness effects on the direct electron transfer rates (which can also be directly related to the cell performance), the following protocol was carried out. In this protocol, the total carbon filler content was held constant at 480 mg and the immobilized enzyme/carbon amount put into the ink was increased to maintain a constant enzyme loading. The key parameter changed for this experiment was the amount of modified Nafion enzyme solution coated onto the carbon in the encapsulation step. First the enzyme solution was immobilized onto carbon with the following recipes. The 17% Immobilized Enzyme Recipe was prepared from 1 g Nanowire grafted carbon, 200 mg Laccase in 0.5 M Phosphate buffer solution at pH 7.2, and 4 mL of 5% tetrabutylammonium bromide modified Nafion. The 8.5% Immobilized Enzyme Recipe was prepared from 1 g Nanowire grafted carbon, 100 mg Laccase in 0.5M Phosphate buffer solution at pH 7.2, and 2 mL of 5% tetrabutylammonium bromide modified Nafion. The 4.2% Immobilized Enzyme Recipe was prepared from 1 g Nanowire grafted carbon, 50 mg Laccase in 0.5M Phosphate buffer solution at pH 7.2, and 1 mL of 5% tetrabutylammonium bromide modified Nafion.

Laccase enzyme was dissolved in phosphate buffer solution (pH 7.2, 0.5 M) and then mixed with 1 g nanowire grafted carbon sample (for example: Example 29, 1-(3-sulfopropyl)pyridinium hydroxide doped polyaniline grafted on carbon black particles). This enzyme/carbon slurry was vortexed for 5 minutes. Then, tetrabutylammonium bromide modified Nafion solution (5 wt % in Ethanol) in 1 mL increments was added and vortexed for 1 minute after every 1 mL addition. This mixture was spray dried at room temperature (open to ambient air). This yielded immobilized enzyme supported on nanowire grafted carbon. A separate ink formulation was created for each immobilized enzyme recipe and follows. The 17% enzyme encapsulated carbon ink formulation was prepared from 20 mg 17% immobilized enzyme recipe, 460 mg Monarch 1400, and 1.6 mL of 5% Nafion solution. The 8.5% enzyme encapsulated carbon ink formulation was prepared from 40 mg 8.5% immobilized enzyme recipe, 440 mg Monarch 1400, 1.6 mL of 5% Nafion solution. The 4.2% enzyme encapsulated carbon ink formulation was prepared from 80 mg 17% immobilized enzyme recipe, 400 mg Monarch 1400, and 1.6 mL of 5% Nafion solution.

As discussed in previous examples, the ink formulations had the immobilized enzyme carbon and carbon filler mixed by vortexing before adding the Nafion solution. Upon addition of the Nafion solution, the slurry was mixed with the spatula and then sonicated with the sonicating dismembrator prior to painting on the ELAT support material. Once the electrode was dried, it was pressed to 115 Nafion membrane and a corresponding platinum black anode at 125° C. for 35 seconds. The results are shown in FIG. 63.

When less modified Nafion was used to immobilize the enzyme/carbon, the diffusion rate of electrons through the insulating layer was faster due to the decreased thickness of the layer. FIG. 63 illustrates the trade off associated with decreasing the amount of carbon filler in order to hold enzymatic loading constant at 0.136 mg/cm². The enzyme used in the encapsulation procedure had an activity of 120 U/mg.

### Example 40

### Biocathode Ink Formulation 5: Comparison of Performance for Commercial GCL (ELAT) and in House Manufactured GDL

To compare Biocathode Catalyst Support 1 with commercial ones (in this case double sided ELAT), the following protocol was carried out using an identical ink formulation tested under equivalent conditions as a H₂/O₂ PEM biocathode fuel cell. The ink formulation used in this protocol was prepared from 40 mg enzyme encapsulated carbon, 440 mg Monarch 1400, and 1.6 mL of 5% Nafion Solution. The ELAT GDL ink formulation was prepared from 40 mg enzyme encapsulated carbon, 440 mg Monarch 1400, and 1.6 mL 5% Nafion solution.

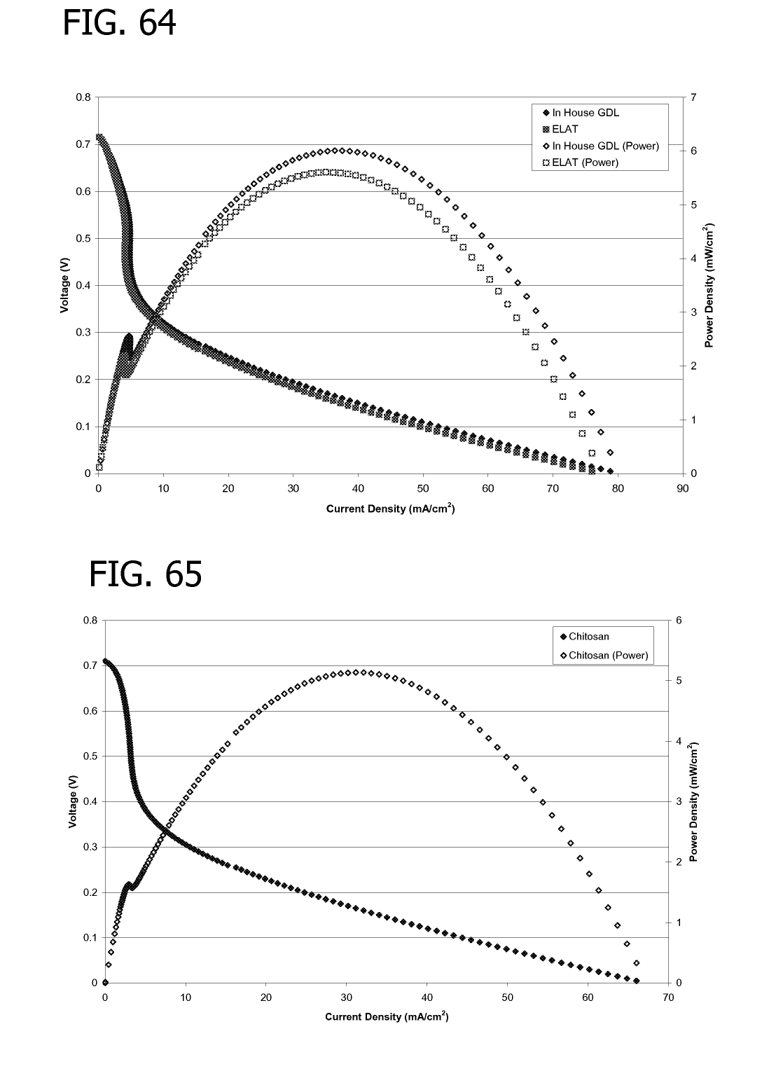

For the ink formulations, the immobilized enzyme carbon and carbon filler were mixed by vortexing before addition of the Nafion solution. Upon addition of the Nafion solution the slurry was mixed with the spatula and then sonicated with the sonicating dismembrator prior to painting on the ELAT support material. Once the electrode was dried, it was pressed to 115 Nafion membrane and a corresponding platinum black anode at 125° C. for 35 seconds. The inks were painted using the same batch of enzyme immobilized carbon and the resulting data is shown in FIG. 64.

The electrode inks were fabricated using enzyme with 120 Units/mg activity. The in house developed GDL demonstrated higher performance for equivalent conditions as compared to the ELAT GDL.

### Example 41

### Ink Formulation 6: Chitosan IMMOBILIZED LACCASE PAINTED onto ELAT

A different immobilization material was tested. Instead of tetrabutylammonium bromide modified Nafion, hydrophobically modified chitosan was used. Any immobilization material could be used in the ink formulations as long as they show adequate retention of activity and stability in the solvent environment. The modified chitosan was incorporated during the spray drying step. Once the enzyme encapsulated carbon was dry, it was incorporated into the following ink formulation. The chitosan immobilized enzyme ink formulation was prepared from 80 mg chitosan immobilized enzyme encapsulated carbon, 400 mg Monarch 1400, and 1.6 mL of 5% Nafion solution. The ink painting steps were the same as described in previous examples, however, the press step changed. Chitosan has a lower melt and decomposition temperature, therefore it is unstable at temperatures higher than 85° C. Thus, the chitosan electrode was pressed at 85° C. for 35 seconds.

Hydrophobically modified chitosan illustrated slightly lower performance as compared to the tetrabutylammonium bromide modified Nafion encapsulated Laccase. (See FIG. 65).

While the invention is susceptible to various modifications and alternative forms, specific embodiments thereof have been shown by way of example and have been described herein in detail. It should be understood, however, that it is not intended to limit the invention to the particular form disclosed, but on the contrary, the intention is to cover all modifications, equivalents and alternatives falling within the spirit and scope of the invention as defined in the appended claims.

In view of the above, it will be seen that the several objects of the invention are achieved and other advantageous results attained. As various changes could be made in the above methods without departing from the scope of the invention, it is intended that all matter contained in the above description or shown in the accompanying drawings shall be interpreted as illustrative and not in a limiting sense.

When introducing elements of the present invention or the preferred embodiments thereof, the articles “a”, “an”, “the”, and “said” are intended to mean that there are one or more of the elements. The terms “comprising”, “including,” and “having” are intended to be inclusive and mean that there may be additional elements other than the listed elements.

What is claimed is:

1-114. (canceled)

115. A biofuel cell device for generating electrical current comprising:
a fuel manifold having a face, and at least one cavity in the face defining a fuel reservoir, an inlet in fluid communication with the reservoir for flow of fuel fluid into the manifold to fill the reservoir and an outlet in fluid communication with the reservoir for flow of fuel fluid out of the manifold;
an anode assembly comprising at least one bioanode positioned for contact with fuel fluid in said fuel reservoir;
a cathode assembly comprising at least one cathode positioned for flow of fuel fluid through the bioanode to the cathode; and
a controller operatively connected to the anode assembly and the cathode assembly for controlling the output of electrical current from the biofuel cell device.

116. The biofuel cell device of claim 115 wherein said at least one cavity in the manifold has an inlet port surface and an outlet port surface, said outlet port surface being located at an elevation higher than said inlet port surface.

117. The biofuel cell device of claim 115 wherein the bioanode comprises a current collector, a gas diffusion layer, and a catalyst layer comprising an enzyme and an enzyme immobilization material; and the enzyme immobilization material comprises a micellar or inverted micellar structure.

118. The biofuel cell device of claim 115 wherein said controller comprises:
a controller for controlling an output of the fuel cell according to a defined operating mode; and
a switch circuit operatively connected between the fuel cell and the load, said switch circuit being responsive to the controller for alternately connecting the fuel cell to the load and disconnecting the fuel cell from the load according to the operating mode.

119. A biofuel cell device for supplying electrical power to a load, said device comprising:
a fuel cell;
a controller operatively connected to the fuel cell for controlling an output of the fuel cell according to a defined operating mode; and either
(i) a switch circuit situated between the fuel cell and the load, said switch circuit being responsive to the controller for alternately connecting the fuel cell to the load and disconnecting the fuel cell from the load according to the operating mode; or
(ii) a supplemental power circuit responsive to the controller for selectively connecting a supplemental power source to the output of the fuel cell thereby supplementing the electrical power supplied to the load by the biofuel cell device.

120. A biofuel cell device for supplying electrical power to a load, said device comprising:
a plurality of fuel cells electrically connected in series;
a controller operatively connected to each of the fuel cells for controlling an output of each of the fuel cells according to at least one of a plurality of defined operating modes; and
a switch circuit operatively connected between the fuel cells and the load, said switch circuit being responsive to the controller for selectively connecting at least one of the fuel cells to the load according to the operating mode.

121. The biofuel cell device of claim 120 wherein the fuel cell comprises a bioanode and a cathode; the bioanode comprises a current collector, a gas diffusion layer, and a catalyst layer comprising an enzyme and an enzyme immobilization material; and the enzyme immobilization material comprises a micellar or inverted micellar structure.

122. A particle comprising a core coated with an immobilized enzyme, the enzyme being immobilized in an immobilization material and either (i) having an activity of at least about 0.65 relative to its initial activity before immobilization and coating, or (ii) retaining at least about 75% of its initial catalytic activity for at least 3 days when the enzyme is continuously catalyzing a chemical transformation.

123. The particle of claim 122 wherein the immobilized enzyme has an activity of at least about 0.85 relative to its initial activity before immobilization and coating.

124. The particle of claim 122 wherein the coating comprises from about 0.1 wt. % to about 29 wt. % of the enzyme, about 0.1 wt. % to about 43 wt. % of the enzyme immobilization material, and up to about 29 wt. % of the electron mediator.

125. The particle of claim 122 wherein the immobilized enzyme retains at least about 75% of its initial catalytic activity for at least 30 days when the enzyme is continuously catalyzing a chemical transformation.

126. The particle of claim 122 wherein the enzyme immobilization material comprises a micellar or inverted micellar structure.

127. A process for preparing a particle coated with an immobilized enzyme or organelle, the process comprising: mixing a solution comprising an enzyme or organelle and a suspension comprising at least one core particle, an immobilization material, and a liquid medium to form a mixture; and spray-drying the mixture.

128. The process claim 127 wherein the solution comprises from about 0.1 wt. % to about 15 wt. % of the enzyme and about 85 wt. % to about 99.9 wt. % of a solvent, and the suspension comprises from about 0.1 wt. % to about 28.7 wt. % of the core particles, from about 4 wt. % to about 10 wt. % of the enzyme immobilization material, and from about 50 wt. % to about 75 wt. % of the liquid medium.

129. A self-supporting electron conductor comprising:
a monolayer comprised of a first electrically conductive material having high surface area for transferring electrons, a second electrically conductive material for supporting the electron conductor, and a binder, wherein the weight ratio of the second electrically conductive material to the first electrically conductive material is at least 0.5:1 to provide sufficient rigidity to the electron conductor for it to be self-supporting.

130. The electron conductor of claim 129 wherein an electron mediator is grafted to at least a portion of the first electrically conductive material.

131. The electron conductor of claim 129 wherein the weight ratio of the second electrically conductive material to the first electrically conductive material is at least 0.6:1.

132. The electron conductor of claim 131 wherein the weight ratio of the binder to the second electrically conductive material is at least 0.8:1.

133. The electron conductor of claim 129 wherein an enzyme layer is in contact with a surface of the monolayer, the enzyme layer comprising an enzyme immobilized in an enzyme immobilization material and in contact with a nanostructure comprised of nanowires grafted to carbon black particles.

134. The electron conductor of claim 133 wherein the enzyme immobilization material comprises a micellar or inverted micellar structure.
